(19) United States
(12) Patent Application Publication
(10) Pub. No.: US 2017/0075877 A1
(43) Pub. Date: Mar. 16, 2017

(54) Methods and systems of handling patent claims

(71) Applicant: Marie-Therese LEPELTIER, Cannes (FR)

(72) Inventor: Marie-Therese LEPELTIER, Cannes (FR)

(21) Appl. No.: 14/855,449

(22) Filed: Sep. 16, 2015

(51) Int. Cl. G06F 17/27

(52) U.S. Cl. CPC G06F 17/2705; G06F 17/2795

(57) ABSTRACT

There is disclosed a computer-implemented method of handling a text expressed in a natural language comprising creating a second text or patent claim sentence from a first text or patent claim sentence and timestamping said second text or patent claim sentence. Developments comprise the creation of a plurality of texts or patent claim sentences, the use of trusted and/or trustless timestamping, the use of grammatical texts, the use of a parser and/or of a tagger, modification operations such as addition, insertion and deletion, injection of definitions of words, the use of a thesaurus (synonym, hyponym, hyperonym, holonym, antonym of a word, etc), the use of a unique and optionally persistent web address, making the second text or patent claim available to the public (or not), the use of lexical directions such as a patent classification indication and the use of crowdsourcing techniques.

### FIELD OF THE INVENTION

The present disclosure relates generally to methods and systems of artificial or computational creativity. In particular, examples of handling patent claims are disclosed.

### BACKGROUND ART

Play with words. The name of the game is the claim. Despite these statements, patent professionals (e.g. agents, attorneys, lawyers, litigators, examiners, professors and students) and computer linguistics experts (e.g. scientists in Natural Language Processing, computational linguistics professors, semantic web experts) rarely work together.

Both fields require advanced skills. Patent applications are generally drafted by patent agents or attorneys. Computers play little role beyond word processing software and machine translation. Patent experts generally do not show immoderate interest for computer linguistics. Symmetrically, current approaches in Natural Language Processing rarely discuss patent claims. For example, available parsers and taggers are not adapted to the structures of patent claim sentences which constitute an idiosyncratic language. Few vocabulary sources like dictionaries or ontologies are specifically designed for patents.

There is a need for methods and systems to handle texts, in particular scientific texts and patent claims.

### SUMMARY

There is generally disclosed a computer-implemented method of handling a text expressed in a natural language comprising creating a second text or patent claim sentence from a first text or patent claim sentence and timestamping said second text or patent claim sentence. Developments comprise the creation of a plurality of texts or patent claim sentences, the use of trusted timestamping, the use of grammatical texts, the use of a parser and/or of a tagger, modification operations such as addition, insertion and deletion, injection of definitions of words, the use of a thesaurus (synonym, hyponym, hyperonym, holonym, antonym of a word, etc), the use of a unique and optionally persistent web address, making the second text or patent claim available to the public (or not), the use of lexical directions such as a patent classification indication and the use of crowdsourcing techniques.

There is disclosed a computer-implemented method of handling a patent claim comprising: receiving an initial patent claim; modifying said initial patent claim into a plurality of modified patent claims; timestamping said modified patent claims with a trusted timestamp; optionally publishing said modified patent claims, each modified patent claim being associated with a unique address, said address being persistent (over time). The method can comprise parsing the initial patent claim into one or more parse trees, determining one or more template slots from said one or more parse trees, a template slot comprising a word or a group of adjacent words or a group of non-adjacent words. The modifying step can comprise deleting and/or inserting and/or reordering one or more template slots and/or replacing one or more template slots by one or more new words. The new words can correspond to received keywords and/or one words extracted or retrieved from one or more indications of patent classification classes, in order to guide the creation of modified patent claims. Links to specific web pages or documents also can be received and new words be further extracted. In some embodiments, there can be received one or more selections of one or more specific portions of the initial patent claim. There can be further received a parameter value associated with said selected specific portion, said parameter indicating to what extent the portions have to be changed or are allowed to change. The new words can be extracted from the initial patent claim itself, or from the patent claim tree associated with the initial patent claim (or with another patent claim), or from a patent specification or a description associated with said initial patent claim (or with another claim set). The new words can be synonyms or hyponyms or hyperonyms or holonyms or antonyms or meronyms of words extracted from such sources. The new words also can belong to a predefined general list of words, independent from the initial patent claim. As a guide to the combinatorial creation of modified patent claims, there can be received a parameter value, said parameter value indicating a meaning creation intensity. Such a meaning creation intensity can be associated with allowed or targeted changes in vocabulary and/or grammar. In some embodiments, one or more modified patent claims are grammatical. Associated systems and computer programs are disclosed.

There is disclosed a computer-implemented method of handling a patent claim comprising receiving an initial patent claim; modifying said initial patent claim into a plurality of modified patent claims; timestamping said modified patent claims.

A modified patent claim sentence is also called a “variation” or a “variant”. In an embodiment, there is created a plurality of different (second) modified patent claim sentences derived from the first or initial patent claim sentence. In another embodiment, any intermediary patent claim sentence can serve as a basis for modifications (for example the fifth one of a series can be further modified into a sixth one). For example, a second or modified patent claim sentence can be further modified and/or the first or initial patent claim sentence can be further modified. The modifying step can be repeated. The modifying step can be looped and/or conditionally and/or recursively and/or iteratively applied. Recursion can be single or multiple. In an embodiment, the step is repeated until a desired number of variants is reached or while a condition (e.g. time limit, collision with an existing patent claim sentence, etc) is satisfied (or is not satisfied). In an embodiment, created variations or modified patent claims are unique, i.e. modified patent claim sentences are different (e.g. by design or by construction). In an embodiment, modified patent claims are tentatively unique (e.g. the computation of hash values enables a deduplication of sentences). Unique variations can be assessed as such in view of the variations or patent claim sentences derived from the given initial patent claim sentence. All patent claim sentences ever created also can be taken into account. The total number of possible variants in practice depends on non technical parameters such as use cases (defensive publishing, inspiration, high quality variations, etc) and on technical limits like processing, memory and storage limits. Depending on use cases and used technologies, up to one hundred, or one thousand, or one million, or one billion (and beyond) variations can be created.

In a development, one or more modified patent claim sentences are timestamped.

“Timestamping” can be understood as “associating a reliable date of creation to”.

Without timestamping, the indication of a date of creation and/or publication can still be presumed valid or true or exact. For some purposes, a timestamping step is not even necessary.

Advantageously in some embodiments, one or more schemes or techniques of timestamping can be used (e.g. “trusted” timestamping and/or “trustless” timestamping, as well as others). A plurality of timestamping schemes or steps or techniques can be additioned or even combined (i.e. intermingled or integrated steps, etc), advantageously reinforcing the level of proof.

In an embodiment, the date associated with one or more patent claims can be a mere declaration (e.g. declared as such by the service provider).

In an embodiment, the timestamping scheme can be performed according to the ISO 8601 standard. The associated advantage is in particular processing speed.

In a development, the timestamping step comprises a trusted timestamping step. In an embodiment, the timestamping step or scheme or mechanism or technique can be a trusted timestamping one (for example according to RFC3161). Trusted timestamping is an improved method of timestamping, which proves the date of creation with a higher level of proof. Published with diligence after creation, a reliable date of publication can be established for a (trusted) timestamped text. The scheme of the “trusted timestamping” mechanism for example can be RFC 3161 or X9.95 or ISO/IEC 18014. The main principles of trusted timestamping are now briefly discussed (Wikipedia sources). Further details are available in the scientific literature. Trusted timestamping is the process of securely keeping track of the creation and modification time of a document. No one, not even the owner of the document, should be able to change it once it has been recorded provided that the timestamper's integrity is never compromised. The administrative aspect may involve setting up a publicly available, trusted timestamp management infrastructure to collect, process and renew timestamps. According to the RFC 3161 standard, a trusted timestamp is a timestamp issued by a trusted third party (TTP) acting as a Time Stamping Authority (TSA). Multiple TSAs can be used to increase reliability and reduce vulnerability. First a hash value (or digital signature), such as a MD5 or SHA-1 signature, is calculated from the data to be timestamped. The hash value is sent to the TSA. The TSA concatenates a timestamp to the hash value and calculates the hash of this concatenation. This hash value is in turn digitally signed with the private key of the TSA. This signed data is sent back to the requester of the timestamp who stores these with the original data. Since the original data cannot be calculated from the hash (the hash function is a one-way function), the TSA never gets to see the original data, which allows the use of this method for confidential data. In order to check the correctness of a timestamp generated by a TSA, anyone can then verify that the document was not created after the date that the timestamper vouches. It can also no longer be repudiated that the requester of the timestamp was in possession of the original data at the time given by the timestamp. To prove this, the hash of the original data is calculated, the timestamp given by the TSA is appended to it and the hash of the result of this concatenation is calculated (hash A). Then the digital signature of the TSA is validated by checking that the signed hash provided by the TSA was indeed signed with their private key by digital signature verification. The hash A is compared with the hash B inside the signed TSA message to confirm they are equal, proving that the timestamp and message is unaltered and was issued by the TSA. If not, then either the timestamp was altered or the timestamp was not issued by the TSA.

The “trusted” timestamping scheme generally corresponds to an “institutional” model of trust. An independent party is involved and the entity timestamping the textual variants hardly can falsify timestamps. The social acceptance by the general public (including patent examiners) of the timestamped creations according to the invention is likely to be improved with such a trusted timestamping scheme (a fortiori if independent TSAs are multiplied, i.e. combined and/or juxtaposed). Patent offices may become TSAs for example.

In a development, the timestamping step comprises a decentralized timestamping step. In an embodiment, the timestamping step or scheme or mechanism or technique can be a “decentralized” one. It is indeed possible to securely timestamp information in a decentralized manner. Data can be hashed and placed in a “blockchain” or a crypto-ledger (or equivalent historical repository of data, for example of transactions) which serves as a proof of the time that data existed. The proof in such a system is mostly due to the significant amount of computation which is required and performed after the hash was submitted to the block chain. A “decentralized” (or “distributed”) timestamping for example can be the one used in the Bitcoin blockchain (or in an equivalent crypto ledger). Such a distributed or decentralized timestamping “distributes” trust in the network, in a way that a central authority (or special node or peer) is no longer involved or needed (i.e. there is no centralized entity in order to establish trust in dates). This scheme corresponds to a “crowd” or “trustless” model. In the network for example implemented by Bitcoin and other crypto-currencies, nodes are substantially treated equal and the network establishes a consensus or a vote to establish operations, in particular (and apparently) solving the double-spending technical problem (as well as associated timestamping technical problems). The advantage of using a “decentralized” timestamping is to bypass any central (or centralized) authority, which may become attacked and corrupted or compromised at some point. The corresponding timestamps can be stored all over the world (i.e. the number of copies can be substantially higher than with—even redundant—multiple TSAs). A decentralized timestamping is generally alleged to be harder to tamper with (i.e. to attack).

In a development, one or more timestamps can be used. Using a plurality of timestamps per se increases the robustness of the system. For example, if the TSA of a first trusted timestamp happens to be compromised, for a reason or another, then one other trusted token of a second TSA may survive. Still further, using different techniques also reinforces the global global level of proof (to associate a reliable date of creation to the one or more modified patent claims). In other words, both “trusted” and “trustless” schemes can be used. In particular, both “trusted” and “trustless” schemes or systems can be juxtaposed or even combined. Advantages of the two systems can be aggregated or combined indeed. Some flaws or weaknesses of one model (e.g. “abandoned” cryptoledger, 51% or DDoS attacks, compromised TSA, etc) can be counterbalanced or compensated by the advantages of the other model. For example, if the blockchain of a cryptocurrency (for example Bitcoin) happens to be attacked—or reveals to be compromised—then other timestamping methods (for example a trusted token) can maintain a reliable date of creation. The probability of simultaneous failures of the different systems being combined can be considered as negligible at some point.

Modified patent claims can thus be timestamped using trusted timestamping and/or decentralized (or “trustless”) timestamping (and/or according to further other timestamping techniques as well). In yet other words, a text can be associated with a trusted timestamp alone, or with a decentralized timestamp alone, or with both a trusted timestamp and a decentralized timestamp.

In an embodiment, a created text or patent claim sentence can result from the combination of a plurality of sentences. A sentence can be embedded into another one (embeddings). Combining sentences can be performed in several manners (punctuation, coordination, subordination, reduction, apposition, etc). For example a sentence (e.g. the definition of a term) can be inserted into another one.

In a development, one or more modified patent claims are made available to the public (e.g. “published”)

One or more patent claim sentences can be “rendered accessible to the public” or “made available to the public”. For example, a particular modified patent claim can be published (or not). The initial patent claim also optionally can be published. Various publishing methods are possible, e.g. paper print publishing or printing, broadcasting, on-line publishing, emailing, displaying in a public space (e.g. advertising), distributed via online screen-savers, radio or TV broadcasting, oral disclosure, etc. In a development, there is provided a practical possibility of having access, i.e. a “direct and unambiguous access” to the means of disclosure (the created text or patent claim sentence) for at least one member of the public. Referring to EPO T1553/06 decision, if before the filing or priority date of a patent or patent application, a document stored on the World Wide Web and accessible via a specific URL (1) could be found with the help of a public web search engine by using one or more keywords all related to the essence of the content of that document and (2) remained accessible at that URL for a period of time long enough for a member of the public, i.e. someone under no obligation to keep the content of the document secret, to have direct and unambiguous access to the document, then the document [is] made available to the public. In an embodiment, the step of providing access to the public to one or more modified patent claim sentences is performed by indexing via a public search engine. Patent claim sentences can be rendered accessible to the public via on-line publishing. For example, a modified patent claim can be indexed and/or retrievable with search query terms, in which case said modified patent claim is visually displayed. The modified patent claim for example can be displayed in full (e.g. no snippets) on a computer screen. The text can be restituted by any other immediate cognitive access means (text-to-speech, translation into graphical representations etc).

A second text or modified patent claim sentence (alternatively and optionally) can remain confidential. Some modified patent claim sentences for example can be kept undisclosed. For example, a “private and confidential” protected access (e.g. with login and password, under SSL sessions) can be provided to a known entity under a confidentiality agreement. User identification, preexisting confidentiality agreement and technical measures of protection can be combined to avoid public disclosure.

In a development, a modified patent claim is associated with a unique and/or permanent electronic publication address.

In particular and advantageously, a modified patent claim sentence can be associated with a unique web address (hyperlink or clickable link such as a Uniform Resource Locator URL or equivalent). For example, several created texts can share the same address (uniqueness of the address of a page comprising several created texts). A created text also can correspond to a unique address, and vice-versa, advantageously facilitating exchanges and linking for example. A bijection further facilitates de-duplication (removal of duplicate contents). If a collection of second texts or modified patent claim sentences is created, each created text or modified patent claim sentence can be associated with its own unique address. Two different texts can have two distinct addresses. One address can correspond to one created text (and one text only in certain embodiments). In an embodiment, the unique address is permanent or persistent. In some embodiments, said (optionally unique) address can be tentatively (high availability of publication servers) persistent or permanent. Access to the created text can—or not—be subject to restrictive measures (this being not detrimental to the practicality of access mentioned before). In an embodiment, all Internet users can have free access to one or more (if not all) created texts or modified patent claim sentences. In some other embodiments, some “tolls” (e.g. payment) or technical measures of protection can regulate accesses (the latter may not be detrimental to the qualification of “prior art”, if applicable). In an embodiment, the second patent claim sentence is “unprotected”: it is freely and directly accessible by anyone with the entry of the URL in the address bar of a web browser (and for example a QR code can be generated to copy and paste the URL). In another embodiment, the access to the URL is technically protected (e.g. private or confidential, restricted and controlled via credentials for example), in addition to contractual provisions (for example confidentiality agreement). In an embodiment, the address does not change or evolve over time. In another embodiment, address extensions are possible (with retro-compatibility). Hosting services for online publication are reasonably maintained over time (a temporary interruption of service does not disqualify the second text from the status of “publication” or from being “accessible to the public”).

By providing a link, a modified patent claim or created text is made available to the public (there is no need for an actual transmission of the work in most of current patent laws). In a development, the created text is searchable (e.g. indexed). In a further development, for example if required by future laws, with user consent if applicable, the proof of actual access or transmission might be further tracked or recorded or monitored or timestamped. A clickable link can be interpreted as a reference (thus the HREF coding) similar to a bibliographic reference plus the address of one or more book shops or libraries storing the relevant item. When otherwise made accessible, for example when printed and offered for access, a modified patent claim can be found thanks to an “address” or “coordinates”. A physical data warehouse comprising printed books comprising printed pages comprising printed created texts of patent claim sentences can be associated with coordinates of created texts. The index and search itself can be implemented in software for example.

In a development, the method further comprises the step of receiving one or more words and/or patent classification indications and/or website or webpage addresses and/or a text.

Some lexical indications can be optionally received to guide the creation of modified patent claim sentences: a word (“3D”, “releasable”, etc), a plurality of words such as an expression (e.g. “releasably connected to”), an IPC or a CPC class indication (e.g. G06F17), one website or web page address (considered as a repository of candidate words). Some other texts (e.g. documents, articles, scientific publication, etc) also can be analyzed and words and/or expressions can be extracted from said texts. Receiving one or more patent classification indications can be leveraged to establish bridges between words' “silos” (for example lists of words associated with respective patent classification classes).

In a development, the method further comprises the step of receiving selection of a specific portion of the initial patent claim and receiving a parameter value associated with said selected specific portion.

Such received data (e.g. IPC symbols, parameter value, etc) can orient or direct or favor or determine the creation of contents. The user can optionally indicate one or more specific parts of the first or initial patent claim, by various means (cursor selection, touch or gestures etc). Each indicated or selected part can be associated with a different fate, determined for example by a parameter value or a symbol or by default in the GUI, etc. For example, a selected part may be indicated as “to be kept unchanged”. A selected part may be indicated as to be “preferably changed” (e.g. biased allocation of efforts and/or processing for modifications). Intermediate states i.e. quantification or scoring can be indicated or provided or received. For example, on a range of [0,100], a parameter value of 20 can signify “to be slightly changed”, a parameter value of 50 can signify “to change”, a parameter value of 70 can signify “to be deeply changed”. The parameter value can be a couple of values corresponding to desired (or observed) changes in terms of (structure/vocabulary) or (grammar/lexicon) or (form/substance). For example, a parameter value (70,20) can signify “grammar deeply changed/lexicon slightly changed”.

In a development, the method further comprises the steps of parsing the initial patent claim into one or more parse trees, determining one or more template slots from said one or more parse trees, a template slot comprising a word or a group of adjacent words or a group of non adjacent words.

A template slot can also comprise a clause. Parsers and/or taggers can be used. Shared parse forests can be used. Advantageously, the parsing can be performed after the one or more selections of some specific parts of the sentence to be preferably varied.

In a development, the method further comprises the steps of deleting and/or inserting and/or reordering one or more template slots and/or replacing one or more template slots by one or more new words.

In a development, the one or more new words are words of the initial patent claim, and/or a near synonym and/or a perfect synonym and/or a hyponym and/or a hyperonym and/or a holonym and/or an antonym and/or a meronym thereof.

In a development, the one or more new words are words of a patent claim tree associated with the initial patent claim, and/or synonym, hyponym, hyperonym, holonym, antonym or meronym thereof.

In a development, the one or more new words are words of a patent specification or description associated with the initial patent claim.

The patent claim itself can be considered as a good source of vocabulary. In a development, the one or more new words are (e.g. selected) words of a (e.g. received) patent claim tree (for example associated with the initial patent claim text), or synonym, hyponym, hyperonym, holonym, antonym or meronym thereof. In particular, dependent claims comprise lexical directions to be leveraged in priority. In a development, the one or more new words are (e.g. selected) words of a received patent specification or description (for example associated with the initial patent claim). In particular, this embodiment enables unclaimed matter to be reinjected in patent claim sentences. The new words also can belong to a predefined general list of words (“releasable”, “connectable”, etc), independent from the initial patent claim. Words and/or expressions (groups of adjacent words) can be used. Words and/or expressions of citing or cited documents can also be used (graph of patents).

In a development, creating a patent claim sentence or modifying a patent claim comprises receiving one or more words (the step of modifying the initial patent claim sentence can comprise receiving one or more words). In the creation process, the one or more selections of the different slots and the corresponding replacements (or deletions) can determine the “quality” of the produced sentences. Different methods can be used to perform these selections and replacements/deletions. In an embodiment, replacements (and/or insertions and/or deletions) are performed without user intervention, i.e. using dictionaries, thesauri, general ontologies, Wikipedia, claim construction dictionaries, etc. In an embodiment, for example as a complement to the full automatic approach, one or more words are received from the user (e.g. inventor, client, attorneys, examiner, etc). The one or more words can be keywords, partial or full expressions (e.g. portions of phrases like “releasably connected to”) or complete texts. The one or more words can correspond to “intuitions”. For example, a person can have the intuition that a “releasable screen” can fit medical devices. Following, claims corresponding to medical devices can be appropriately applied said characteristic. The one or more words can correspond to lexical “directions” (directions because further dictionaries can be used afterwards, to enrich, multiply or leverage these “intuitions”). The received words can be words of (dependent or independent) claims and/or of the claim tree and/or of the patent specification and/or any other words. In one embodiment, words are selected from an automatic extraction of a received text (e.g. a scientific article or a book or a claim tree or a patent specification). For example, a person may want to mix up information technology patent claims and biological patent claims to get “synthetic biology” patent claims. A person may want to intermingle or mix or hybridize descriptions of chewing gums distributors systems with descriptions of analyte test strips systems. A person may want to try to combine an anticipation described in a science-fiction text on drones or robots with a particular other text. A person may want to simply play with words. The received text or words can be chosen by the user or chosen in a corpus according to predefined criteria (such as main theme e.g. “synthetic biology”, abnormalities in collocations e.g. “molecular springs”, patent propensity gaps, patent portfolios values, word in a list qualifying the skilled person, etc).

In a development, the method further comprises the step of associating a modified patent claim with at least one metric.

In a development, a metric comprises an edit distance between said modified patent claim and the initial patent claim and/or a distance between said modified patent claim and another modified patent claim.

In a development, the edit distance is a Levenshtein distance.

In a development, the method further comprises the step of receiving indication of a meaning creation intensity.

In a development, a patent claim is modified according to a threshold determined from said meaning creation intensity.

In a development, the method further comprises receiving a parameter value, said parameter value indicating a meaning creation intensity. In some embodiments, the meaning creation intensity determines modifications brought or changes in lexicon (e.g. vocabulary) and/or grammar (e.g. structure of sentences). In a development, the method comprises receiving an indication of a (desired or targeted) meaning creation intensity. The indication can be a value, a range, a symbol, a command, a selection, an expression, etc. The meaning creation intensity can determine brought modifications with respect to the vocabulary and/or to the structure of the patent claim sentences (two dimensions). In some embodiments, the indicator can be multi-dimensional (vocabulary, grammar, quality, depth, patent classification, etc). Such an indicator can serve as guide for the creation process. For example, the created texts or patent claim sentences can remain “focused” (closely related to the meaning of the initial first text, for example with few changes in the structure of the sentence of the text or patent claim and with careful or conservative choices for lexical variations) or to the contrary the creation can be selected as “wide” (possibly loosely related to the initial meaning, for example by creating many structural changes and/or by using very diverse vocabularies). The meaning creation also can be shown as “balanced” (in such case, the efforts of creation will be allocated to both focused and remote/far/wide creations). This “meaning creation intensity” can be in relation with “vocabulary” and “structure” cursors, i.e. options presented as choices to the human operator to guide or govern the creation process. In one embodiment, the method comprises receiving an indication of a meaning creation intensity and/or (i.e. alone or along) one or more indications associated to the substance (or structure) and the form (or vocabulary).

In a development, one or more modified patent claims are grammatical.

In some embodiments, the created texts (patent claim sentences) are grammatical. In some other embodiments, the created texts are not grammatical (they are agrammatical, e.g. incorrect according to some linguistic or social norms). Grammaticality is not a required condition for a text to constitute prior art. “Colorless green ideas sleep furiously”. This famous sentence is syntactically correct (grammatical), yet meaningless (or with a very specific meaning in a very specific context). Grammaticality is a “nice to have” feature, not a “must have” feature. An agrammatical text, if comprehensible, can be novelty destroying or serve for an inventive step objection. Yet creating grammatical texts is of advantage. Cognitive access to the intellectual content is at least facilitated. A grammatical text generally implies a better understandability and a better social acceptance. Obtaining a grammatical text can imply many manual verifications and/or processing tasks. According to some embodiments, a vast majority of created texts or modified patent claims can be grammatical, while some of them can present an incorrect grammar. The skilled person, to some extent, can “repair” grammatical errors.

In a development, a second text or modified patent claim sentence is grammatical. In an a-grammatical embodiment (“Library of Babel”), the creation model is “blind” or “brute-force”: the one or more parts of the first text or patent claim sentence are not analyzed (e.g. by a parser and/or a tagger, no lexical analysis, etc). In such a case, all words (nouns and verbs) are treated equal and further creations (recursively iterated or not) produce a vast majority of non-grammatical sentences. Pros are simplicity and (at least a quest towards) exhaustivity of brought modifications. Cons are costs in terms of processing and memory/storage resources. In one other embodiment, grammaticality is preserved (at best) by using natural language processing tools like parsers, taggers and other analysis tools. Substance and form are objectivized to a maximum extent. In one embodiment, the creation model is associated with a template-based model. In another embodiment, the first text for example can be analyzed as an (oriented) graph, for example with words being nodes and the grammatical or semantic relations between the words being the edges. In one embodiment, one or more templates (e.g. sub-graphs or “gabarits” or “templates”) are extracted from the first text. A template defines “slots”, i.e. words or phrases which can be varied. Lists of words or expressions are used for insertion or replacement. In some embodiments, the choice and/or the selection of slots and associated replacement words is performed in specific ways. In a development, the creation of a grammatical second text or modified patent claim sentence comprises (optionally tagging and) parsing the first text, defining one more templates, each template comprising one or more slots, a slot being a word, or a collection of words (contiguous or adjacent or not), or a phrase (a group of words) to be deleted or replaced by one or more other replacement words. In a development, the creation of a grammatical second text or modified patent claim sentence is performed by one or more of the operations comprising deleting one or more words of the first or initial text, replacing one or more words of the first or initial text by one or more other replacement words, inserting one or more other insertion words before one or more words of the first or initial text. Different steps can be combined: deleting, substituting, deleting or reordering one or more words of the first or initial text. The replacement or insertion words can be appropriately chosen.

In a development, the origin of the first or initial patent claim is declared or certified by a user as being of human origin (i.e. not a machine-generated content). Because of circularity aspects (e.g. a machine-generated content can be based on a machine-generated content), there can be advantageously be kept track of the human origin of a series of patent claim sentences (in some case, it may lead to a higher trust or interest in a collection of created patent claims, as a semantic or “inventive” validation has occurred). In a development, a patent claim is authenticated as being of human origin (binary assertion or according to a determined probability). Generally speaking, the “human” or the “machine” origin of a given randomly chosen text hardly can be discriminated and a fortiori proved. Statistics on large corpus can reveal some systematic bias, but the contemplation of an isolated text generally cannot determine the origin of a text with sufficient certainty. A short machine-generated text generally cannot be discriminated against a short human-created text. A long machine-generated text is more likely to contain contradictions or other indications increasing the probability of distinction of origins. Texts are generally and increasingly written using word processing software and other spell-checking, auto-completion, word suggestions, grammar checker or integrated thesaurus or translation software tools. The contributions of man and machine hardly can be distinguished.

In a development, creating or modifying a patent claim sentence can comprise a crowdsourcing step. In other words, both machines and humans can be involved in the creation or modification of patent claim sentences. Crowdsourcing can justify authorship in some cases. Crowdsourcing can comprise distributing one or more portions of a patent claim sentence to an open or predefined list of human reviewers (experts or unskilled), collecting one or more edition suggestions about said one or more portions, selecting one or more said edition suggestions and creating or generating one or more resulting sentences. As some parts or portions of a patent claim sentence can be extracted and distributed over the Internet (for example), a widely distributed audience of users can edit and/or modify and/or annotate and/or rate such parts, which after human processing can be further re-assembled in the sentence (with further modifications or not, into one or more sentences, etc).

There is disclosed a system comprising means to perform one or more steps of the method. In particular and for example, such a system can comprise a tagger and/or a parser (i.e. a tagger or a parser or both). In particular, such tangible features exclude any mental act. The system can comprise one or more of a smartphone, a tablet, a laptop, a head-mounted display, a wearable computer or another computing or peripheral device (such as a haptic device, a projector, a humanoid companion robot, etc). There is disclosed a computer program comprising instructions for carrying out one or more steps of the method when said computer program is executed on a suitable computer device. The method can be performed in the cloud, locally on a computing device or both. The software can be distributed.

There is disclosed a web page comprising a displayable element which upon triggering sends a command to perform one of more steps of the method. For example, a public search engine can present a web page presenting patent information and in particular a patent claim and a button or icon or action bar or displayable element which upon clicking or triggering will create text variants and will optionally publish them (or a selection thereof, immediately or at a later selectable date). Optionally, one or more keywords or patent classification indications or another document can be used. Alternatively, semantic beam search options can be presented (for example for a wider search by using related words, graphically augmented search, interactive question answering search systems, iterative step-by-step approach, etc).

Technical effects or advantages associated with particular embodiments or aspects of the disclosed methods and systems are now briefly discussed.

In one aspect, some embodiments can lead to a “densification” and/or an increase in the number of patent claims or inventions. An invention can possibly be defined by a patent claim (i.e. a combination of technical features), therefore a) variations around a given patent claim, and/or b) “text interpolations” or semantically intermediate forms between two given patent claims and/or c) independent creations from another text, and/or d) hybridisations of two or more patent claims e) and the like, can lead to increase the absolute number of inventions and the relative number of inventions (with respect to predefined and stable patent classification criteria).

In one aspect, some embodiments can enable an improved access to inventions. The notions of disclosure, visibility, searchability and readability are related but different notions or concepts. For example, a combination of claims in a claim tree can be considered as (formally) disclosed, but may not be visible (especially highlighted and/or readable and/or searchable). The handling of texts, in particular patent claims, according to embodiments of the invention, facilitates or improves or allows visibility and/or searchability and/or readability. In one aspect, the presentation in one unique “full text” (i.e. of all words and in context) enables a much better cognitive access to the intellectual/semantic content of the considered claim (tree). There is for example no longer the need to “jump” to different lines of the claim tree or to different sections of the same patent application, or even to interrupt the reading to get a definition in the dictionary. In the background, embodiments of the invention may have deeper impacts in the collocations of terms, on a global scale, with effects on patent searches. According to some embodiments, patent claim trees can be formally, solved and better words' collocations computations can be obtained from associated rewritings. Similar results can be obtained via a better inclusion of specifications' or dictionary contents into patent claims.

In one aspect, some embodiments can put a possible emphasis on (or a bias towards) “literal meaning” and/or a “strict” (if not maniac) way of reading, as opposed to a natural cognitive style (or way of reading), wherein the man in the street can read a text by skipping a few words (if not lines), overlooking some declinations (if not entire words), permuting and/or replacing and/or confusing and/or misreading some others. Modernized ways to “compile” claims may lead to stricter acceptance or considerations of novelty, clarity, support, etc.

In one aspect, some embodiments can enable a “search versioning” (by controlling both the creation and search space, a “replay” of patent searches becomes possible, i.e. it can be possible to know, at a chosen date in the past, what were the search results obtained in response to a given search query). This can be of value to assess inventive step.

In one aspect, since massive “silo breaking” methods can be enabled (codifying technical transpositions, formalizing reasoning by analogy, etc), scientific frontiers between disciplines may be significantly blurred. For example, “synthetic biology” inventions may partially result from the applications of information technology patterns to systems biology. As a corollary, the frontiers at the crossroads of scientific fields may now be specifically if not systematically explored. Disclosed embodiments facilitate and perform such cross-fertilisations, by providing methods and systems for large scale transpositions of technical or inventive patterns.

In one aspect, for the technical and scientific field of computer linguistics, embodiments of the present invention can lead to radically new approaches and associated methods (computations of a semantic continuum or semantic slopes for example which are unexplored fields of computational linguistics, with unforeseeable scientific ramifications).

In one aspect, for the intellectual property discipline, the very process of inventing may now be affected or at least questioned. For example, inventorship between humans and machines can be debated, so as authorship (even if in some jurisdictions an author is necessarily a human being). Humans may be considered as inventors and authors, while machines may be denied from both qualities (or maybe only from authorship if automatic inventing is recognized and accepted). According to one perspective, the primary provision of the “seed” or “base” claims together with lexical directions chosen with intuition by humans may be considered as the first and most significant effort/merit. Afterwards indeed, machines could be regarded as routinely multiplying this first starting point, crystallizing pre-intuitions of humans. In other words, it may be considerable to estimate sufficient that humans provide the initial sketch while machines would provide the mature forms. Generally speaking, the (mere) publication or disclosure of a patent claim (alone and/or with an associated list of words) may imply some forms of (social/legal) acceptance of the “immediate” and associated disclosure of their (re)combinations (i.e. with said list of words but also with common general knowledge, other ontologies, etc), because the power of the machine—executing routine and mechanical work—may be be considered as “internalized”. In this perspective, the assessment of inventive step may further require to define and specify the capabilities of the machine or to define textual/formal (standardized) “tests” to discriminate between contents “obtainable by machine operations (non-inventive)” and contents “not obtainable by machine (inventive)”. One concrete way to achieve an assessment of inventive step could (maybe or probably) be to let artificial systems to freely and concurrently evolve and to use such standardized “tests” to define “inventiveness”. The question whether there are texts not reachable by creation processes similar to the ones presently disclosed (or others) remains an open and difficult question (combinatorial explosion, grammaticality, stability of the terminology, storage space, search latency, finite duration of creation, etc). Incidentally, in a virtuous circle, mastering the creation of contents by computers (and/or humans) increasingly—and in return—enable texts to be better “read”—and then “produced”—by computers.

Some embodiments can be advantageously used for plagiarism detection, rewriting operations, fusion/merge of news articles, patent activities comprising the comparison of documents or unclaimed matter detection (not exhaustive).

More generally, embodiments can be advantageously used inventing and scientific discovery. To some extent, language can be quantified, so as inventions expressed in language and works of authorship. Even if such quantifications present inherent limitations, there are practical consequences implied by these quantifications (or attempts of quantification). At the highest level of abstraction, reality can be discretized and “paved” by “distinct” works of authorships or “ideas” or “inventions”. The optimization of such a pavement is enabled by quantification criteria (e.g. quantifying “fair use”, “risk of confusion”, “novelty”, “inventive step”, etc), said criteria being of appropriate granularity and stemming from different environments such as technical, psychological, cognitive, social and legal (socio-technical) environments.

Further advantages of the invention will become clear to the skilled person upon examination of the drawings and detailed description. It is intended that any additional advantages be incorporated therein.

### BRIEF DESCRIPTION OF THE DRAWINGS

Embodiments of the invention will now be described with reference to the following drawings, in which:

FIG. 1 shows an exemplary and general workflow of the method;

FIG. 2 illustrates an example of an analysis of an initial text;

FIG. 3 illustrates some further aspects of the analysis;

FIG. 4 shows some exemplary phrases created from an initial text;

FIG. 5 shows one possible workflow of the creation;

FIGS. 6 to 9 illustrate some examples of parameters of the creation;

FIGS. 10 to 13 illustrate some particular aspects, mostly for patents;

FIGS. 14 to 19 illustrates some of the possible creation profiles;

FIG. 20 illustrates an example of a search results page;

FIGS. 21 to 24 illustrate various user interface embodiments.

### DETAILED DESCRIPTION

While the systems and methods are illustrated with respect to patent claims' embodiments and applications, they are equally applicable to virtually any human creation or work of authorship, including for example music songs, movie clips and paintings.

In the present description, “A and/or B” means “A”, “A and B”, “B”, but also “A or B”. The expression “A and/or B and/or C” comprises all combinations with 1, 2 and 3 words. “A and/or B and/or C” thus means “A”, “B”, “C”, “A and B”, “A and C”, “B and C”, “A or B”, “A or C”, “B or C”, “A and B and C”, “A or B and C”, “A and B or C”, or “A or B or C”. The rule applies for superior orders. It can be assumed that “A or B” in a written description is not always strictly equivalent to the mention “A” alone or the mention of “B” alone, the latter mentions do not explicitly underline the absence of an alternative. Nevertheless, such expressions comprising “and/or” in the present description are intended to cover all combinatorial possibilities. For example, a “touch and/or haptic screen” means a “touch and haptic screen” (both properties), a “touch screen” (one property, silent about the other), a “haptic” screen (one property, silent about the other) and a “touch or haptic screen” (the expression can implicitly refers to a mutual exclusion of the properties, thereby conveying information).

As the present disclosure teaches, some words of the claimed subject-matter can be varied to get (slightly or radically) different meanings. In the present claimed-subject matter, in particular, the words “modify”, “publish” and “patent claim” can be varied.

In some embodiments, the verb “publish” (expression “made available to the public”) can be replaced with one or more verbs of the list comprising announce, advertise, affiche, air, blog, bring out, broadcast, buzz, communicate, circulate, circularize, diffuse, distribute, disclose, declare, divulge, disseminate, diffuse, dig out, disperse, emit, exhibit, issue, make public, make known, manifest, notify, post, propagate, proclaim, promulgate, publicize, post, print, put out, report, release, reveal, sell, speak of, spread, shout, unhide. For example, the method can comprise receiving an initial text, modifying said text into a plurality of modified texts, timestamping and advertising said texts. Advertising conveys the idea that the content is pushed, opportunistically inserted into other contents. In variants, texts can be notified, e.g. suggesting email distribution, etc.

In some embodiments, the verb “modify” can be replaced with one or more other verbs. To “modify” means to “make different” or to “change”. To “modify” a thing can mean to change some parts of a thing while not changing other parts. The scale of brought changes can vary (e.g. subtle changes, minor changes, major changes, fundamental changes). Changes or modifications can be brought to the lexicon (e.g. vocabulary) and/or to the grammar (e.g. syntax). In other words, only the lexicon can be changed, only the grammar can be changed, or both the lexicon and the grammar can be changed.

To “modify” primarily can mean (i.e. can be replaced in the present description by the following verbs): amend, change, edit, paraphrase, rephrase, rewrite, transform, vary. For example, from an initial patent claim, the method can comprise paraphrasing the initial patent claim into a plurality of patent claims, i.e. paraphrases. Paraphrasing conveys the idea that meaning is globally preserved. In variants, patent claims can be changed (neutral expression) or rewritten (possibly repairing errors), etc.

To “modify” secondarily can mean: adapt, alter, broaden, clarify, correct, disambiguate, detail, develop, distort, enrich, exacerbate, exaggerate, expand, extend, fix, focus, generalize, limit, mutate, narrow, negate, particularize, patch, perfect, rationalize, reorder, reorient, repair, restrict, restyle, revise, shorten, simplify, singularize, sophisticate, specialize, standardize, streamline, stretch, substantiate, transpose, widen. For example, the method can comprise transposing an initial patent claims into a plurality of transposed patent claims, e.g. conveying the idea of adaptations to different technical domains. In variants, patent claims can be simplified or complexified (e.g. semantic assessment) or shortened or lengthen (e.g. syntactic assessment), etc.

To “modify” also can be associated with one or more of the following verbs: abbreviate, abridge, abstract, adjust, ameliorate, arrange, attenuate, bend, bias, blur, clean, combine, commute, complement, complete, complexify, complicate, condense, convert, darken, deepen, deform, degrade, delimit, delineate, densen, densify, derive, diversify, divide, exchange, excise, expunge, filter, fluctuate, fortify, fragment, hybridize, improve, intermingle, interpolate, intricate, inverse, invert, join, lengthen, mangle, merge, minimize, mitigate, mix, model, moderate, modernize, modify, modulate, obscure, orient, optimize, permute, polish, recombine, reduce, reinforce, scramble, segment, shape, shift, shrink, soften, specify, split, strengthen, substitute, subtract, summarize, supplement, systematize, telescope, temper, test, transpose, twist, vibrate, warp. Each variant is associated with respective aspects and advantages. For example, patent claims can be interpolated, e.g. conveying the idea of a semantic continuum.

With respect to the object being manipulated (e.g. “patent claims”), the technical teachings of the disclosure can be applied to a wide range of linguistics objects. From the most generic to the more specific (the list is not exhaustive), embodiments can manipulate a “string of characters” (e.g. “abcde”), a “string of words” or a “group of words” or a “collection of words” (e.g. “a screen comprising”), a “phrase” (e.g. “which is holographic”), a “sentence” (e.g. “a mouse comprising a holographic screen”), a “patent claim” (a particular sentence, e.g. “a method of displaying data on the holographic screen of a mouse”). Other words or expressions also can be used, e.g. “clause”. In the present description, the word “text” is used. It shall be understood that this word “text” refers to these different granularity levels. For example, embodiments of the invention can apply to domain names (“abc.com”, “aba.com”, “abb.com”, “abd.com”, “adb.com”, “ad.com”, “abcd.com”, etc). Embodiments of the invention often mention “patent claims”. A patent claim is a (specific) sentence. The expressions “text”, “patent claim”, “patent claim sentence”, “claim”, and “sentence” are interchangeable (embodiments of the invention are equally applicable). A “modified patent claim sentence” is also named a “variation”.

There is generally disclosed a computer-implemented method of handling a text or string of words comprising: receiving a first text or string of words; modifying said first text or string of words into a 20 second text or string of words; timestamping said second text or string of words.

A “text” or “string of words” is an ordered set or a collection of words. A word can be any word of a natural language or of a formal language. For example, a word can be a noun or a verb. More generally, a “word” can be one or more of a/an: coordinating conjunction, cardinal number, determiner, existential (e.g. “there”), foreign word, preposition or subordinating conjunction, adjective (e.g. comparative, superlative), list item marker, modal, noun (e.g. singular, plural), predeterminer, pronoun (e.g. personal, possessive), adverb (e.g. comparative, superlative), particle, symbol, interjection, verb (e.g. base form, past tense, gerund or present participle, past participle, non-3rd person singular present, 3rd person singular present). A phrase is an expression consisting of one or more words forming a grammatical constituent of a sentence. A phrase can be of different types, comprising a noun phrase, a nominal phrase, a nominal, a predicate, a verb phrase, a prepositional phrase, a pronominal phrase, a pronominal, a response, a catchphrase. A sentence comprises one or more strings of words. A sentence starts with a capital letter and ends with the punctuation sign “.” A sentence can be grammatical, i.e. satisfying the grammatical rules of a language. A sentence can be agrammatical (ungrammatical, not grammatical), with one or more grammatical rules being not satisfied. Grammar errors can be more or less acceptable, according different criteria comprising readability, social acceptance, reading context, content understandability and others. The grammaticality of a sentence thus can be quantified (e.g. measured or scored or ranked, for example as a function of one or more such criteria). An initial or a modified sentence can be grammatical or grammatical up to a certain extent. In some embodiments, an initial sentence can be received from a user and is (or can be) considered as grammatical. A sentence can be of different types, comprising a simple sentence, a complex sentence, a compound sentence, a declarative sentence, a declaratory sentence, a run-on sentence, a topic sentence, a question, an interrogation, an interrogative, an interrogative sentence.

A particular kind of sentence is a patent claim. A patent claim is a sentence. A patent claim is generally a “long” sentence, with specific properties. For example, a patent claim sentence generally comprises present participle (gerund) verbs (e.g. “comparing” in method claims) as well as punctuation signs (such as “;”) which can facilitate the delimitation of specific parts of the patent claim sentence. There are other aspects (including technical ones) justifying the manipulation of patent claims.

Using a “patent claim” specifically as a basis for the creation of textual variants according to the described embodiments is not intuitive. Any a posteriori judgement must be carefully considered. Some embodiments of the invention advantageously use patent claims as a basis to create variations. A patent claim does indeed present technical characteristics which can be associated with technical processing advantages, effects or requirements. Using patent claims for the creation of textual variants leads in fine to particularly interesting semantic results. The human efforts incorporated in patent claims (conciseness, definitional aspect, rigour, etc) can be advantageously leveraged. Using patent claims incidentally leads to specific legal effects (which are inextricably linked to further associated technical properties, which can in turn be further leveraged).

A patent claim is made out of one single sentence (which is tentatively unique in form and/or substance for novelty). If in (legal) theory a patent claim is supposed to be “short and concise”, in practice such a sentence is usually very long, i.e. technically very difficult to parse (in particular). Social acceptance of words used in claims is usually very high. The vast majority of words present in patent claims are accepted as being sufficiently “clear” and/or “precise” and/or “technical” (for example “comparing”) by patent professionals. Some other common words to be encountered in patent claims have idiosyncratic meanings (for example “said”). Patent claims usually have more controlled vocabulary and less grammatical ambiguities (among other properties) than ordinary sentences (i.e. a randomly chosen sentence in a corpus). As a consequence of the specificities of a patent claim sentence, natural language processing techniques need to be adapted. In general, the rigour of the grammar and the preciseness of the vocabulary being used to construe a patent claim can be leveraged (for example for anaphora resolutions). For example, detected antecedences can generally be co-varied (e.g. varied at the same time with the same replacement words). Such a detection in particular depends on the use of words like “said”, “a”, “the” and/or to anaphora (e.g. “processing unit” and later use of a shortcut like “unit”). A majority of created texts can follow the antecedences as they are declared initially (but sometimes antecedences can be “broken down”, words or expressions can be joined or merged with intention). Punctuation signs (for example “;”) and/or present participles (gerund verbs such as “comparing”)—and/or even graphical text indentations encoding some structural or semantic aspects of the sentence—can advantageously be leveraged to facilitate the delimitation of specific parts or “slots” of the patent claim sentence.

Many patent claims are also readily available (a large corpus is available for analysis and improvements purposes). A patent claim is also generally associated with corresponding vocabularies and other sentences (dependent claims and sentences from the description), whose lexicon and sentence structures can be in turn advantageously leveraged. A patent claim is also associated with meta data such as IPC (International Patent Classification) data (or any other patent classification data, such as CPC, ECLA, etc). These classifications result from human judgements and are therefore highly valuable. Experimental results show that using this kind of text (i.e. a patent claim) as a basis for variations does produce a high proportion of meaningful texts, from a semantic perspective. Semantic contradictions can be reduced by appropriately managing the vocabulary used for creations of variants.

A claim is rendered in a single sentence. A patent claim sentence generally comprises a preamble, one or more transitional phrases (“comprising”, “containing”, “including”, “consisting of”, “wherein” and “characterized in that”) and a body. Patent claims present lexical idiosyncrasies (means plus function, relative words, complex terminological units, etc) and syntactic idiosyncrasies (e.g. highly complex syntactic structures). Patent claim sentences for example are composed of complex noun phrases or sequences of complex noun phrases. A noun phrase comprises a noun head combined with modifiers (pre-modifiers and post-modifiers). A modifier can be a single word, a phrase or a clause. A noun can be modified either by adjectives, other nouns, verbs, prepositions or pronouns. Adjectives are usually enumerated in the following order: number, judgements, attitudes, size, length, height, colour, origin, material and purpose. Syntactic relations between two nouns can comprise compositions or appositions. Many different constructions can be present, such as the to-infinitive constructions that modify a participle, prepositional phrases, subordinate (“so that”) and coordinate constructions (including embedded coordination). Patent claims have specific types of anaphoric references (full repetition is generally preferred to minimize ambiguity). Patent claims present specific punctuation conventions (comma for natural pause; serial comma for lists; a claim should contain a period only at its end; dashes, quotes, parentheses or abbreviations are avoided, etc). As a result, the different linguistic idiosyncrasies of patent claim sentences can be advantageously exploited or leveraged for the analysis of patent claims or patent documents, and in particular for the creation of modified patent claim sentences.

According to other embodiments, other types of texts than patent claims can be used. For example, scientific articles or patent abstracts can be used. Compared with patent claims, these categories of text present some other specific features (including “qualities”) which in turn are associated with technical, semantic and legal effects that can be further exploited. A patent abstract in practice often results from the assembly of a modified patent claim and a summary of the claim tree. In other words, a patent abstract usually remains a short text (under 150 words according to the main standard), is composed of one or several sentences, usually in a limited number. The vocabulary entropy (or density) can be advantageously taken in to account. Scientific articles also can serve as creation basis. The citations of a scientific article, provided or retrieved, can be advantageously leveraged (for example for the vocabulary). Such texts can be modified into one single sentence.

According to other embodiments, still other types of texts can be used. For example, beyond a patent claim sentence, a text can be chosen from the list comprising: abstract, address, advertisement, article, attachment, book, commercial, communication, content, contract, database, definition, description, document, domain name, file, form, formula, header, hypertext, instruction, key, keyword, language, library, license, link, list, listing, log, mark-up, meta data, model, name, notation, note, number, patent, patent claim, patent description, patent specification, patent title, blog post, script, search query, search result, sentence, slogan, SMS, software program, spreadsheet, string, table, template, tweet, web page, website, wiki, HTML, XML. In particular, the text serving as a basis for variations can be executable code, i.e. character strings or instructions executable on a computer and which when executed on a computer cause a computer to perform tasks or steps of a method.

In some other embodiments, the expression “patent claim” or “patent claim sentence” in the claimed subject-matter, or claim tree, can be substituted by one or more of the following words or expressions: image (including but not limited to image, advertisement, animation, button, face, gesture, icon, image, layout, media, model, photo, picture, pixel, presentation, score, snapshot), sound (sound, audio, media, melody, mp3, music, recording, ringtone, signal, song, sound, stream), multimedia (multimedia, advertisement, animation, e-book, commercial, content, document, game, media, movie, object, presentation, video, 2D video, 3D video, web page, website). For example, a given melody can serve as a basis for the creation of other melodies; the method further including the step of (trusted) time-stamping the created one or more melodies and optionally publishing said melodies with individual and permanent links. Any other step of the claimed method can be applied to the specific nature of the content being handled (or adapted to fit the specific content nature, if required).

In some embodiments, the initial text is short, e.g. less than 150 words. Or the duration of the music song is short (e.g. 7 seconds) or the resolution of the painting or movie clip is limited (e.g. 320×240 pixels). Experiments indicate that such lengths can lead to coherent/relevant results. But length is not an absolute parameter or criterion as such. An initial text of one thousand words also can produce interesting results. Such a text can comprise multiple co-references and further semantic contradictions can perfectly be avoided. An entire book wherein one single word is changed also can be theoretically worth it (meaningful, suggestive, useful technical teaching, etc). A bias towards longer patent claims seems to emerge over time when analyzing real patent literature corpus, probably in association with the increasing “density” of technical innovation (at least competition), but this factor probably is counterbalanced by the fact that new words and terminologies encompass broader technical realities.

The (general) number of created texts or patent claim sentences is a parameter which can be controlled (for legal and technical purposes), and which can be disclosed or kept confidential. A text can be associated with a human origin (e.g. with manual edits or formulations) and/or with a machine origin (e.g. automatic substitution of a word caused from a collocation computation, artificial assembly of sentences, etc). A text also can be associated with a “ratio human/machine”, corresponding to the respective contributions of man and machine. A percentage or ratio or indicator can thus represent the respective human and machine origins or edit commands or at least influences. Over time, the appropriate tracking becomes more difficult, if not impossible. The number of created texts or patent claim sentences can be associated with such indications of origin, and/or with some other parameters (other criteria, results, scoring, social graph, metadata, parameter of the creation model, etc). For example, a first number of created texts can be associated with a first creation or level or branch or dependencies resolution of claims or phrases (e.g. with initial claims as provided or received) and a second number associated with another level or creation or branch or dependency (e.g. from artificial dependency or after a first step of modifying, etc). A distribution of numbers (numbers associated at each recursive step) can be defined, controlled and used.

A patent claim can be associated with a (strict) literal meaning, i.e. the strict interpretation associated with the lone words composing the patent claim. The “literal meaning” maintains a consistent meaning regardless of the context, with the intended meaning being compositional in the sense that its meaning corresponds exactly to the meaning of the individual words. As a complement, for example if a term is unclear, a patent claim is also to be read in view of the description. The description, as a semantic network or graph of words, provides this context, and “echoes” the words of the considered patent claim. In this case, reading the patent claim requires the reading of the two texts, the patent claim and the description. In particular, the words to be read substantially concomitantly can be dispersed (for example, the meaning of one word of the patent claim can be specified in the middle of the specification). This implies cognitive distraction, loss of time, low searchability (e.g. collocations of terms which is not optimized) and other negative consequences. The inherently multiple interpretations of patent claims remain fuzzy, “in the air”, i.e. not objectivized. This also lead to legal uncertainty, since boundaries of protection may not be fully explicit.

The proposed approach can “linearize” patent claims, lowering the cognitive burden of the reader. For example, in one aspect, instead of having to read one word of the patent claim and sequentially (before or after) read its definition (subjectively and questionably) extracted from the specification, disclosed methods and systems objectively explicit how to proceed to the isolation of the definition and textually reinsert the definition into the patent claim, so that one full and complete reading is necessary and sufficient. Would there be another definition extractable from the specification, a second patent claim is formed and readable at once, in context. In the example, the definition can be extracted from the associated specification but can also be retrieved from a reference handbook, or a manual associated with common general knowledge, or from a patent claim dictionaries (analyses of terminologies and associated case law), etc. Recent trends and not-yet-stabilized terminologies can be likewise “injected” in patent claims. To some extent, implicit/explicit disclosure can be re-engineered. Among many advantages, the obtained texts are highly searchable (objective and new collocations of terms are defined), present an immediate cognitive access to their intellectual content, are self-contained and not requiring any sequential or parallel reading of other texts, disambiguate questionable terms. The handling of the claim tree is also significantly improved, since the operation of reading a claim tree nowadays require a cognitive effort by the reader, who needs to mentally reconstruct the full sentence resulting from the assembly of the considered dependent claim with the independent claim. The reconstruction can be sometimes quite difficult as a sub-step can described as being modified if not introduced, implying a representation effort to get the full picture. With formal and textual resolutions of claim trees, progress is made towards more immediate and effective intellectual access to the claimed subject-matter and the mathematical collocations of terms is changed in a way to better reflect the technical teaching and to enable better searches.

In some embodiments, only Claim 1 serves for the creations. In other embodiments, the entire claim tree can be used, i.e. dependent claims are taken in combinations with their respective independent claims. Patent drafters often “split” their patent claims over the first dependent claims, e.g. they prepare the psychological and factual discussions to come with patent examiners. During prosecution, one or more dependent claims are frequently inserted in the main claim. Experiments and measurements have shown that the “barycenter” of invention is located around claim 3 (position 3,4 on a corpus sample of several tens of millions of patent claims). Formal textual resolutions allow to take the corresponding text as a basis for the creations.

Regarding the use of claims of patent applications versus the use of claims of granted patents, one can observe that original claims generally are shorter but not necessarily rigorous (antecedence defects will be fixed at a later stage). Non exhaustively, granted claims are generally longer, have generally solved possible antecedence and clarity issues, and frequently have incorporated additional sentences for novelty or inventive step purposes. Such changes present pros (e.g. clarity) and cons (e.g. distortion of the initial template) for the present creation purposes. Depending on the context and objectives of the creation of phrases, either patent applications or granted patents can be used. The analysis of the differences between the claims at filing and at grant provide numerous teachings which can be leveraged. For example, brought amendments provide indications where to intensify modifications (vocabulary and structure). In one embodiment, a substantial fraction of computing resources consumed to vary the base claim is allocated for variations specifically directed around the brought amendments. In one embodiment, the differences are automatically retrieved from patent databases (or they are provided by the user during the preparation of creations).

Generally speaking, the user can select or graphically highlight or otherwise indicate one or more parts of the initial text to be specifically varied, each sub-part can have associated and own variation parameters. Additional and possibly interactive questions can be prompted to the user (indications of further targeted vocabulary directions, e.g. by the user for example during the preparation of the creation (non exhaustive): input of a list of keywords, a user graphical selection of one or more words presenting a higher importance, user feedback collection on examples of modifications to be brought for machine learning purposes, individual meaning creation intensity associated with each part, etc.

Alternatively or complimentary, a formal text resolution is not always required and a patent claim tree (i.e. several distinct phrases, not one long and unique phrase) can be handled at once. For example, one single word can be introduced in the entire claim tree (e.g. the adjective “medical” can be consistently inserted before all occurrences of the word “device” in the claim tree; patent lawyers know that medical devices are regulated and therefore a “medical device” is associated with many and different aspects than a mere “device”).

As the basis for generation (by machines alone) and/or for creation (by machines and humans, e.g. crowdsourcing), abstracts instead of patent claims can be used. Abstracts often comprise a reformulation of claim 1 and the mention of keywords corresponding to dependent claims of the claim tree (introducing vocabulary entropy, advantageously in some embodiments). An abstract can be composed of several distinct phrases (parser and tagger can be adapted or the abstract can be reduced to one single sentence).

To facilitate description, any numeral identifying an element in one figure will represent the same element in any other figure.

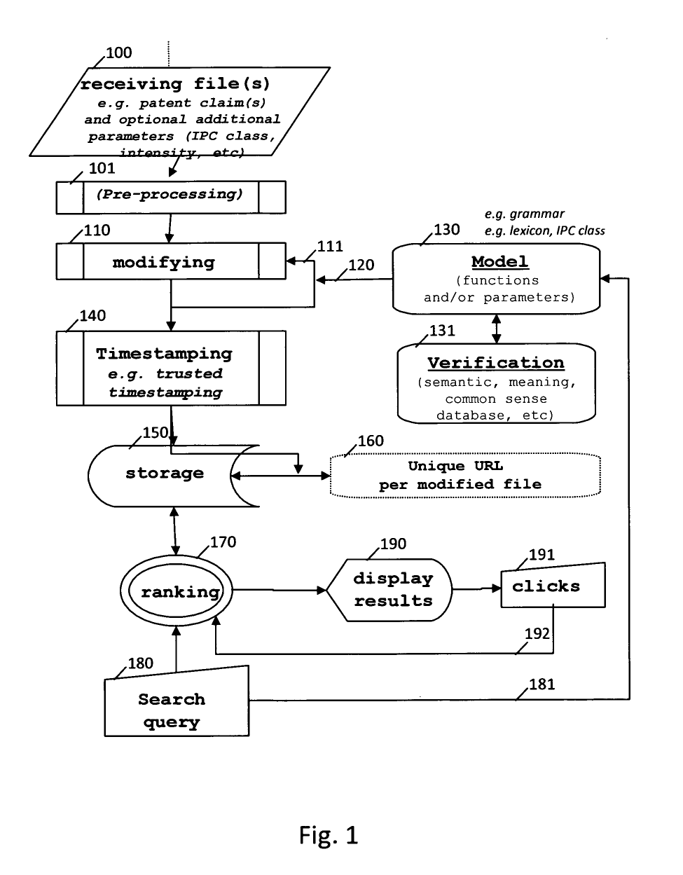

FIG. 1 shows an exemplary workflow of the method. A file comprising text (types of handled files have been defined) is received at step 100. For example, the file comprises a patent claim tree comprising one or more independent claims and one or more dependent claims. In one embodiment, the file comprises a patent claim sentence and in particular is an independent claim 1. The file or initial text can be received by copy and paste operations in a browser window, for example if the claim is not yet available to the public. The text can be retrieved automatically from a patent database with an indication of the publication number for example. The text can be preprocessed, for example to be adapted to further processing operations. In an embodiment, the claim tree is “linearized”, i.e. dependencies of claims are formally solved. Each dependency results in one sentence, with anaphora resolution (if any), correct replacements or words re-ordering (if applicable) and useless repetitions are tentatively avoided. For example, a claim tree architectured as 1-2-4, with a Claim 1 (“a bicycle”), with a dependent Claim 2 (“further comprising a wheel”) and with a Claim 4 dependent on Claim 2 (“wherein the wheel is blue”) will lead to one single sentence (“a bicycle comprising a blue wheel”). Claim language like “wherein” or “further comprising” or “wherein the step of . . . further comprises” can be leveraged to process and build entire sentences. Advantageously, in such a form, the different words are formally close from one another, leading to improved further search queries with Boolean operators like <NEAR> (such corresponding queries would have been unsuccessful with an “exploded” claim tree). Advantageously, the reduction to one unique sentence improves the downstream performances of the parser and tagger. Advantageously, large scale experiments indicate that the “barycenters” of inventions are located between Claim 2 and Claim 5: patent applications claims start usually broad and limitations through the insertion of one or more dependent claims provides the granted Claim 1. It is therefore valuable to extract from the claim tree the right combination of claim. Optionally, formal existing dependencies are solved and the “human” origin of the dependency is preserved for later optimizations. To repair or to exhaust the combinatorics, non-existing dependencies can also be solved. There may be antecedent basis issues (and in such a case, this may be returned to the user) but there may also be unseen, forgotten or not anticipated, and at least not disclosed (workable) dependencies. Optionally, the method also can handle such “artificial” combinations (in such a case the combination is tagged as “machine” origin for later uses). As a result of the preprocessing step 101 are obtained a series of unique phrases (existing phrases resulting from a formal textual resolution and new phrases), since a Claim is by design one single sentence. Different steps of parsing and tagging are performed (analysis of the phrases, then or before).

Along with the files or texts (e.g. patent claims, patent abstracts, SMS, scientific texts, ordinary text, etc), some additional parameters can be optionally received (by the same user, or from another entity or natively from the model). For example, lexical “directions” can be received (e.g. one or more keywords, one or more sentences or parts of sentence, one or more URLs/web links, one or more documents, one or more patent classification entries or indications, etc).

A step of modifying 110 each phrase or text (or patent claim sentence) is then applied. The model underlying the modification engine comprises unitary transformation algorithms. These algorithms handle the form and/or the substance of phrases or sentences, by affecting grammar and/or vocabulary. The algorithms for example comprise rules, facts and conditions to modify a sentence, to re-order words, to delete parts of a phrase, to substitute some other parts etc. In an embodiment, a created text can result of the combination of a plurality of sentences. A sentence can be embedded into another one. Combining sentences can be performed in several manners (punctuation, coordination, subordination, reduction, apposition). For example a sentence (e.g. the definition of a term) can be inserted into another one. These rules for example can be discrete and hand-coded or of statistical nature, learned on large data sets. In particular, specific algorithms dedicated to intellectual property can comprise: injection of definitions of terms; reordering, permutations and interversions of methods steps; management and reparation of antecedences; hard-coding of the claims' tree; including forgotten combinations; claims tree solving (linearization); rewriting of method claims into system claims (and vice versa); use of proprietary modifiers; use of proven claim drafting practices; implementation of the TRIZ methodology (proprietary implementation); claim category transcoding; time management in claims (“when”, “upon”, “after”, “before”, etc); handling of structural features; creation of intermediate generalizations at all abstraction levels, etc.

The step of modifying also can comprise the combinatorial use of one or more of steps of addition, deletion, insertion, replacement, permutation, inversion, negation, substitution of synonyms (e.g. “computer” and “computing device”) and/or hyponyms (e.g. “mouse” for “input device”) and/or hyperonyms (e.g. “input device” for “mouse”) and/or meronyms (e.g. “button” for “mouse”) and/or holonyms (e.g. “mouse” for “button”) and/or antonyms (e.g. “close” for “open”) and/or other similar linguistics relationships. The step of modifying also can use multiple dictionaries and ontologies. Sources of vocabulary can comprise for example Wordnet, Wikipedia, OpenCyc. They can be derived from Claim construction dictionaries, or from patent drafting books, from scientific books and articles, scientific books and articles, reference books, handbooks and encyclopedias, EPO and USPTO Examination Guidelines, Internet pages on technology pages (e.g. blogs). Incidentally the comparison of collocations of words in reference books and handbooks with the collocations in a patent of interest (or a combination thereof) can help to provide an objective and measurable basis of the “skilled person in the art” (at least aiming at a quantification of the likelihood of words' attractions).

Advantageously, lexicons (vocabulary) is appropriately managed by the knowledge and analysis of the patent classification, if available and if the file comprises patent claims. For example, indications of one or more patent classification indications (associated with the subject matter) can also be received. In one embodiment, International Patent Classification (IPC) symbols can be used (or equivalents or counterparts such as CPC or ECLA or Fl or F-term etc). In the case of the IPC, an IPC number or indication or classification symbol or classification entry or classification term or level of classification granularity (for example “A01B 1/00”) consists of symbols comprising a “section” (e.g. A), followed by a “class” (e.g. A01), followed by a “subclass” (e.g. A01B), followed by a “group” number (e.g. “1”), followed by a “subgroup” e.g. “00”. In one embodiment, the lexical directions (e.g. IPC indications) are provided by the user. In one typical scenario, a user starts from a patent claim related to information technology and provides lexical directions (IPC classes, keywords or documents) related to biology to get contents directed to “synthetic biology”. In another example, a user provides patent claims directed to chewing-gums distributor systems and provides the keyword “glucose test strip”, along with a blog article or a third document (for example comprising common words between the two worlds). In another embodiment, “bridges” between IPC classes are preprocessed and can be leveraged (or not). The IPC classification natively comprises links between IPC sections, classes, subclasses, groups and subgroups. For example, on the EPO website, A61M (devices for introducing media into or onto the body) is linked with A61D7/00, A61F13/26, A61 J1/05, A61B and A61L. The symbol G06F17/15 of the G section is linked to another section H like H03H17/00. These indications can be considered as “links” or “bridges” or “tunnels” to be further leveraged. Each symbol (level or granularity of the classification) corresponds to one or more of vocabularies “silos” or “repositories”. When mixing up, mangling, combining, selecting, hybridizing or blurring (non exhaustive) texts, these correspondences can be used or leveraged (for example by providing words replacement candidates). In one embodiment, the date of first appearance or occurrence of a word in a given IPC classification entry is identified and stored. Such an information can be used to compute and select replacement candidates (for example). In some embodiments, such patent classification indications can be predefined or preexisting (for example when selected by a patent examiner) or be determined by the user (semantic classification) or even be determined automatically (for example by the analysis of the contents of the submitted patent claims). In one embodiment, an existing indication is challenged and assessed again in view of vocabulary repositories management methods (or a combination of available IPC indications is performed).

More generally, the step of modifying can involve several diversified techniques, mostly from the field of Artificial Intelligence, and sometimes used in proprietary combinations and implementations. These techniques comprise one or more of: problem solving techniques (reasoning), cybernetic models (regulation schemes), knowledge databases (common sense rules-methods-heuristics and facts), case-based reasoning techniques, connectionist techniques (neural-like architectures), analogical techniques (proprietary analogy tables and correspondences established on-demand), semantic technologies, text mining techniques (for example co-clustering) and others (in particular Markov Chain Monte Carlo MCMC). In some embodiments, concurrent systems are used and unified methods and systems are obtained. In some embodiments, these techniques are used for creation. In some others, they are used by the validation or verification modules as well. At step 131 for example, before the timestamping step, an (optional) semantic/meaning verification module handles the semantic/meaning assessment of each of the different creations. Different particular techniques can be used for verification, comprising using proprietary artificial reasoning systems, databases of mutually incompatible words, common sense databases (facts and rules), semantic annotations, proprietary graph “disjunctors”, human ratings (statistically on samples in some cases) and various other proprietary scoring systems (sometimes in association with crowdsourcing techniques). In particular for the management of the common sense databases, efficient techniques can be used, including integration of heterogeneous databases, knowledge-enhanced retrieval of information, guided information of structured terminology, distributed artificial intelligence, retrieval from the World Wide Web and proprietary human hierarchical judgement databases on priorities and/or importance of facts/heuristics of the knowledge base.

In particular, for the creation 110/130 or the verification 131 step, diverse techniques of mathematical logic can also be used (including propositional logic, and beyond), mostly for the constitution of vocabulary repositories (or metadata associated with phrases). These operations performed on the patent literature (and scientific) corpus can lead to (considerably) enrich the dictionaries which are used in combination with the templates derived from patent claims. For example, libraries of identifying arguments (conclusion indicators such as “thus”, “so”, “then”, etc and premise indicators such as “for”, “since”, “because”, etc) can be extracted from the corpus Other corpus “filters” and similar developments comprise (in no order): the use of logical operators (such as “it is not the case that”, “if and only if”, etc), the analysis of proof strategies (atomic formula, negated formula, conjunction, disjunction, conditional, biconditional), constitution of lists of mutually excluding words (or phrases), truth tables and refutation trees algorithms (exhaustive search), categorical statements (quantifiers such as “all” “none” “some”, i.e. beyond truth-functional operators), predicate calculus (existential, negated, identity, universal quantifiers and rules, etc). In some other developments, equivalences and interderivability are taken into account (negation elimination, conditional proof, conjunction introduction and elimination, disjunction introduction and elimination, biconditional introduction and elimination), as well as derived rules such as hypothetical syllogism, absorption, constructive dilemna, repetition, contradiction, disjunctive syllogism, equivalences, semantic fallacies, ambiguity (equivocation) etc. Analogy tables in scientific fields in particular have experimentally proven to lead to remarkable effects. The use of (“dynamic”, in a proprietary implementation) libraries of “definite descriptions” (Russell) also have revealed efficient. Some particular proprietary implementations of modal logic have revealed interesting regarding induction, deduction, analogy, specialization and generalization in particular.

As an output of the verification 131 module or step, the number of created texts can be significantly reduced. Some experiments have shown that between 5% and 30% of texts can be eliminated using such methods. But this step remains entirely optional.

In one embodiment, the step of modifying the text uses crowdsourcing. Processed phrases are segmented and segmented phrases are sent for human validation (novelty is never endangered because of the fragmentation of the contents of the phrases).

The different unitary algorithms can be statically and also dynamically recombined, according to functions and parameters (for example associated with search queries or other parameters). The modifications brought to phrases or sentences can be recursive (for example phrase 1 is modified into phrase 2 which is in turn modified into phrase 3, etc), operations being generally non commutative. The path of transformations (logic chain of known and defined transformation algorithms) can be recorded and further used.

At step 140, each created sentence (eventually segments thereof having being validated by a human operator) is timestamped. In one embodiment, the timestamp is a declaration of time, on the basis of the indication of the clock of the computer(s) implementing the method. In another embodiment, the timestamping step is at least associated with a trusted timestamping step. According to the RFC 3161 standard, a trusted timestamp is a timestamp issued by a trusted third party (TTP) acting as a Time Stamping Authority (TSA). Such a timestamp is used to prove the existence of certain data before a certain point in time without the possibility to backdate the timestamp. Such a timestamp is an effort to associate a timestamped content with reliable date of creation. After the creation, the publication (if any, and in some embodiments the created phrases are not published at all), of one or more of the created phrases, can occur shortly after the creation. Technical server requirements and processes allow for a publication as soon as a few milliseconds after creation. If the publisher acts with diligence, which is a credible scenario (for example if the very existence of said publisher depends on such a diligence, or if independent entities do act for the publication of the considered phrase, there are other organisational and also technical further solutions). To date, trusted timestamping is the highest level of mathematical proof available.

At step 150, which can be anterior or posterior to other steps described herein, the created phrase is stored and associated with a unique and permanent URL (web address). In other words, there is only one address to read (i.e. get a cognitive sensible access) to a given created text or phrase and this address is persistent over time (or quite persistent, since occasional, temporary and limited interruptions of access or availability to the public do not annihilate the quality of disclosure or of publication of the created phrase). A database can be populated with the series of phrases having being created.

At step 180, a search query is received and a ranking step 170 is performed to provide results at step 180. The analysis of clicks received on results' pages can be further used to improve the ranking system, ranging from the short term (e.g. for the user formulating the query, i.e. personalization) to the long term (changing the ranking model applicable for all users), and all intermediate optimizations (“cross-impacts” on vocabularies, grammar, unitary algorithms, etc). A wide range of influencing factors and heuristics can be taken into account (search history, patent classification information, associated original claim tree, prosecution events, common general knowledge, crowd clicks, etc). A wide range of user interface modes can be implemented (2d, 3d, holographic, static, dynamic, progressive, on demand, pull, push, etc), for example by means of augmented reality head-mounted displays, virtual reality helmets, projectors, touchable interfaces, voice commands, etc.

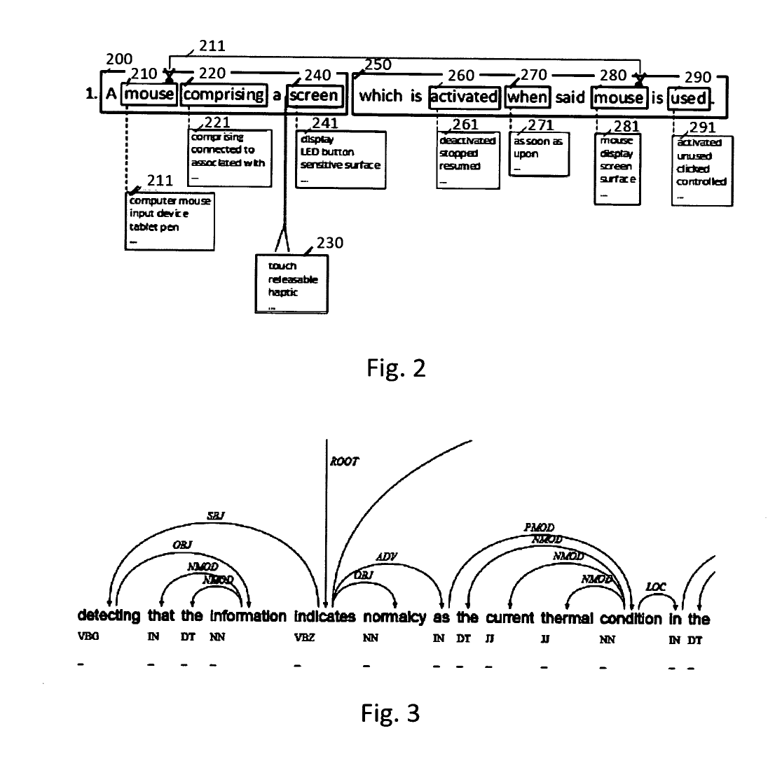

FIG. 2 shows the example of an initial text (patent claim sentence) and a couple of indications of some of the possible modifications that can be brought to the initial text. The initial text is the phrase 200 “a mouse comprising a screen which is activated when said mouse is used”. The analysis of the sentence reveals that the word “mouse” appears two times (coreferences 210, 280). Accordingly when the noun 210 is changed (for example into “computer mouse”, to disambiguate from biology), the noun 280 can be changed simultaneously. This preserves coreferences, the grammaticality, and improves the chance to avoid a semantic contradiction. Alternatively, even if defined as coreferences (for example by the parser or tagger), the two words can be considered and modified independently. This can lead to potentially useful meaning creation. Likewise the lists of words for substitution 211 and 281 may not be the same. Corresponding lists can be merged and/or kept separated and/or duplicated. The word “comprising” 220 is considered as typical for patent claim and therefore can be associated with less modifications (or “fluctuations” or “vibrations”). The word “screen” 240 for example can be associated with synonyms (“display”) or collocations (“LED button”) 241. The part of the phrase 250 (“which is . . . used”) for example can be deleted. Or this part can be changed independently from the first part 200. The verb “activated” 260 is in the passive form and can be replaced for example by other passives such as its antonym “deactivated”. The word “when” 270 signifies a time condition, therefore can be replaced by “as soon as” for example. Words replacement can be handled, but also more complex phrase modifications, implying the modification of a plurality of words (for example the introduction of the word “after” would imply to modify “is” by “has been”). The word “used” 290 likewise can be modified. Words can be inserted, pure and simple, for example the word “releasable” 230 is inserted at appropriate locations (in a variant, such a word is inserted everywhere, at the cost of semantic contradictions and nonsense).

FIG. 3 illustrates some aspects of the analysis performed by the parser and/or tagger. The figure shows the part of a phrase, with annotations associated with words composing the phrase and functional, so called “dependency” relationships between the words. The tagger assigns categories to words (ADVerb, OBJect, etc). The parser reconstructs the relationships between words. These dependency relationships are close to semantic relationships between the occurring predicates. The figure illustrates that the “intelligence” embodied or embedded or derivable from NLP tools can be further leveraged to handle targeted and/or focused and/or symbolic textual modifications (at least with some after thoughts or intentions). The modifications indicated in the case of the FIG. 2 can be performed in a combinatorial way. This routine work, i.e. pure formal textual transformation enabled by natural language processing techniques, in some embodiments are associated with objective skills of the fictitious figure of the “skilled person”.

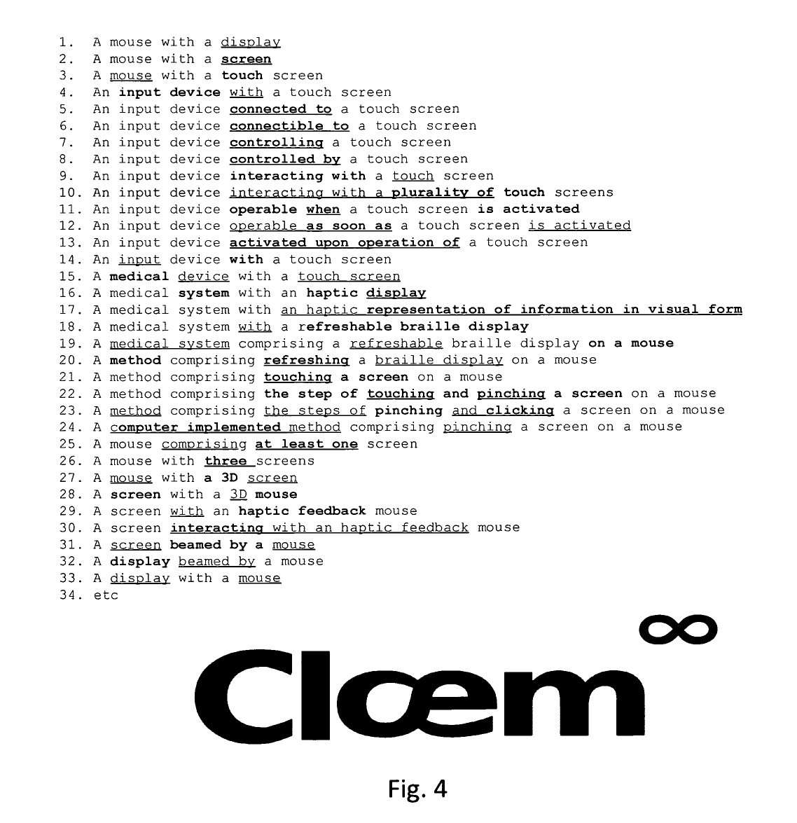

FIG. 4 shows exemplary phrases created from an initial text “a mouse with a display” according to some embodiments. The figure illustrates some of the many transformations (in vocabulary and/or in structure) which can be operated on sentences. In one embodiment, modifications can be brought recursively (i.e. a first sentence is modified into a second sentence, then the second modified sentence is further modified, etc). In other embodiments, a same initial text is used to create all variations (for example sentences numbered 2 to 33 can be derived from sentence 1). In other embodiments, a combination is used (for example some sentences are derived from sentence 1, while some other would be created from sentence 15). Trees, branches and leafs can thus be formed during the creation. Some particular intermediate sentences can form (eventually better) basis for further creations.

As a consequence, circular or not, recursive or not (or at least partially), modifications brought to texts can be combined. In some other embodiments, modifications brought lead to a non-commutative system (modification A then B is not equal to modification B then A, for example if B is a deletion operation). In one embodiment, the modifications (unitary, well defined and known transformations) and the associated order of modifications (ordered sequence or “path”) is recorded and associated with (one or more) created sentences. Among other aspects, a replay of modifications becomes possible, so as a direct access to a certain state (i.e. without a need to replay prior states). In some other embodiments, some collisions (circularity) can exist. In one embodiment, the hash value of each created sentence is computed and redundant sentences are erased.

In the example, in one variation, the synonym “screen” replaces “display” (sentence 2). As synonyms, the global meaning of the sentences remains substantially the same. But a very subtle difference in words in some cases could lead to a greater difference for the global sentences (for example, amplification of the associated meaning). In some other cases, if the sentence 1 would be considered as ambiguous by one reader, the creation of sentence 2 could be perceived as a disambiguation. For example, “screen” leaves (almost) no doubt that the mouse is a computer mouse, not a biological mouse. In another variation, the adjective “touch” is inserted before “screen” (sentence 3). This nominal modification is nowadays common in current computer technology, therefore such an insertion can be seen as routine work for the skilled person. In sentence 4, one hyperonym of “mouse” is introduced (“input device”). Patent lawyers would say that an intermediate generalization is created (specifics and generics are recombined). In phrase 5, “with” is replaced by “connected to”. This creates meaning and/or technical teaching. In phrase 6, “connected to” (a fact) becomes “connectible to”, a potentiality. Sentence 7 introduces an action by way of “controlling”, while sentence 8 inverses the causality with the passive form and use of “by”. Sentence 9 indicates a bilateral influence with “interacting with”. In patents, interpreting patent claims as words' graphs, the links between can be see as either unilateral (simple arrow or “controlling”) or bilateral (double arrow or “interacting with”). Again such a variation, in some views, can not be seen as inventive as machines can vary and rework the underlying graph. Many inventions can be interpreted in view of (feedback) control theory. Sentence 10 introduces the handling of the plurality. Sentence 11 to 13 illustrate the management of time in claims, which can be obtained by replacements (“when”, “as soon as”, etc) or which can require more modifications in the sentence (e.g. passive forms, declinations of words, etc). These variations illustrate that the resulting technical teachings can be significantly changed. In some embodiments (not shown), method steps can be permuted, interverted, inversed, reversed, etc. Sentence 14 corresponds to phrase 4 and illustrates that a same “branch” can lead to different creations. In sentence 15, the introduction of the “medical” qualification leads to specific considerations since medical devices are regulated devices. In sentences 16 and 18, the medical context leads to explore medical databases and words like “haptic” or “refreshable Braille” are introduced. In sentence 17, a possible definition of “display” is formally injected into the phrase (e.g. without the need to consult a dictionary or to read the specification). Sentence 19 introduces the fact that artificial links between features can be created ex nihilo. In the example, the “mouse” feature is existing, but another word could have been chosen. Sentence 20 illustrates a change in claim category (in the example from system to method claim). Among other aspects, this implies to introduce the word “comprising” and a verb with progressive/continuous verb tense-ing, for example “touching” in sentence 21. The expression “the step of can be introduced for example in sentence 22, so as a plurality of steps in sentence 23. The method can be further specified as a “computer implemented” in sentence 24. Sentence 25 illustrates a disambiguation between “a” and “at least one”. Sentence 26 illustrates the handling of figures and numbers (e.g. replacing “one” screen by “three” screens). Sentence 27 introduces a well known feature, “3D”. Sentence 28 permutes nouns: “screen” becomes “mouse” and vice-versa. This change leads to sentence 29, etc.

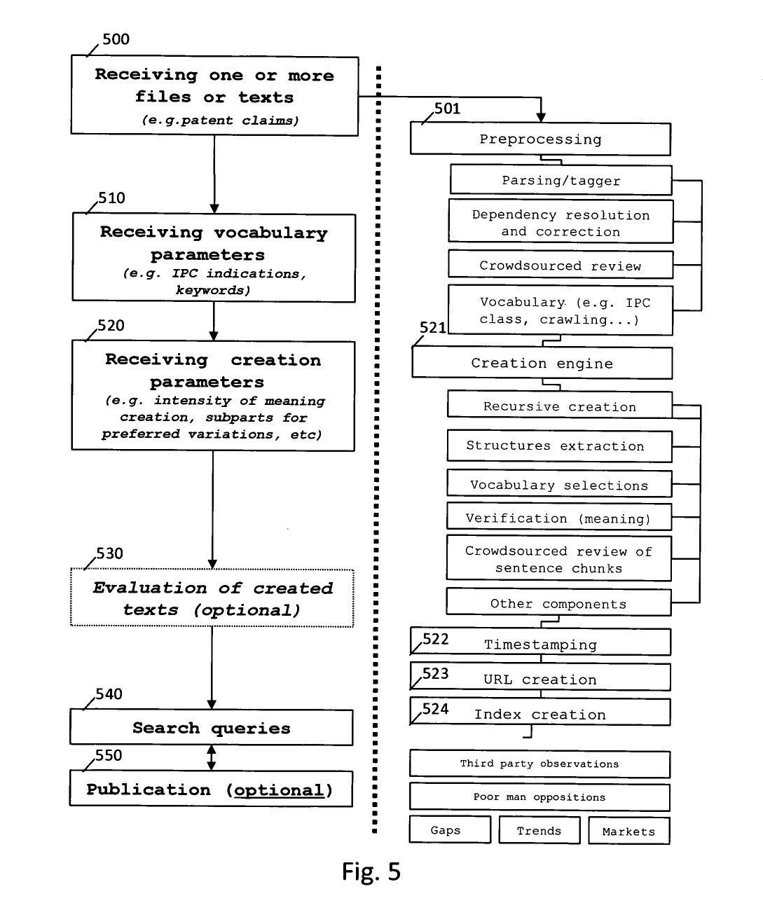

FIG. 5 shows one possible workflow of the creation process (among many others). The left part of the figure illustrates the client side while the right part illustrates what may be implemented on the server side. First, there is received one or more files or texts (for example patent claims or patent claim trees) at step 500. In one embodiment, the claims are provided by copy and paste or by email. In another embodiment, if the patent claims are published (for example in patent offices databases), the patent claims can be retrieved automatically with an appropriate indication (priority date, assignee, publication number etc). The associated patent claims can be retrieved, as well as the description/specification, the associated IPC classes, the priority date, the publication date, the assignee name, etc. For example, prosecution data also can be retrieved from patent registers (the file history can reveal where the amendments are brought in the claims, thus indicating preferred zones or slots or areas of the text to be varied). In one embodiment, if the provided patent claims are not published, steps for signing a non disclosure agreement can be proposed to the user (including hash file verifications between the customized and signed document and the data input by the user to pursue the creation process). Server-side, the received texts are processed (501), for example parsed and tagged. Claim dependencies can be analysed (e.g. multiple dependencies, “and/or”, “or”, “of any preceding claim”, “of claims x to y”, etc) and the claim tree is solved (a plurality of sentences or phrases are generated out of the claim tree). For example a Claim 4 depending of a Claim 2 depending on Claim 1 can be merged or fusioned into one one unique sentence. The dependency is followed or respected, or corrected (in case of antecedent errors) or even modified (new dependencies can be added, for example in relation to the intensity of meaning creation). Obtained phrases optionally can be checked by a patent attorney and/or the verification can be crowdsourced (segmentation and distribution). Vocabulary repositories can be accessed or be build on purpose (in one embodiment the web is crawled and searched to get new replacement words, for example to capture new trends or weak signals).

Along with the one or more texts or patent claim sentences, vocabulary 510 and creation 520 parameters can be received. Such optional parameters comprise: one or more keywords and/or expressions, one or more texts for structures and keywords extraction (automatic or interactive mode), one or more analogy—tables establishing some correspondences between a first list of words and a second list of words, one or more patent classification indications (e.g. IPC classes), a desired publication date, desired assignee name (for example to benefit from grace period provisions if applicable), one or more indications of the desired meaning creation “intensity” or profiles thereof, one or more indications of particular zones or areas or sub-parts of sentences, etc

For example, the meaning creation intensity can be indicated as “focused”, i.e. around the original submitted text, or “wide” e.g. reaching very different significations, or “balanced” i.e. both wide and focused. A profile of the meaning creation intensity can be provided. For example, a graphical form or shape as detailed in FIG. 7 can be provided (asked by the user, reflected by the model, or defined in an interactive way). In one embodiment, the user can indicate which zones or areas or sub-parts of the provided sentences (e.g. patent claims) are to be preferably varied. To the contrary, some others zones or areas or sub-parts of the provided sentences can be indicated to remain “untouched” or “unmodified” or “freezed”. The received files thus can comprise zones to be varied and zones not to be varied. More generally, portions of the provided texts can be individually associated with different levels of variation intensity. A global intensity of meaning creation can be derived thereof and displayed to the user, who interactively can define the appropriate level. Some zones or areas or sub-parts of the provided sentences also can defined automatically by default. For example the end of of Claim 1 (the characterizing part or the last two lines or the last 10 words are advantageously varied the most). In one embodiment, the indications of such zones or areas or sub-parts are graphically indicated or selected (e.g. by touching these sub-parts on a touchscreen). Along with the notion of “claims barycenter”, preferred zones can be adapted accordingly. In one embodiment, a list of analogies is received. For example a list of paired words or phrases or a table comprising two columns and a plurality of rows is received or provided or loaded or actuated. For example, the following list is received, establishing a possible correspondence between information technology and biology (“network=tissue=culture”, “computer=cell”, “module=pathway”, “gates=biochemical reactions”, “physical layer=proteins=genes”). Such a list can be processed in many ways. For example, among many others, the list can be processed to provide further replacement words or candidates thereof (e.g. one or more patent claims in G06 comprising one or more IT words can be selected and one or more appropriate words thereof can be replaced, in particular simultaneously (but this is not mandatory). Synonyms, hyperonyms, hyponyms, etc can be derived from the provided analogies (from IT and/or biological words) and lead to further enriched lists, collocations can be further calculated and replacement words lists further refined, phrases or chunks or parts of sentences can be handled or re-assembled from biological claims and IT claims, etc.

The creation engine 521, with the “seed texts/claims” or “base claims”, for example preprocessed received texts and creation parameters 510 and/or 520, proceeds to the creation of variations (steps of modifying 110, 111, 120, 130).

The techniques used for the steps of modifying are very diversified. Random choices may or may not intervene. In a development for example, the selection of one and more words or phrases in vocabulary repositories to be used used for replacements (and/or likewise of possible templates to be used) follows a random walk according to a Markov chain Monte Carlo (MCMC) method, for example according to a Metropolis-Hastings algorithm (other MCMC algorithms are possible and well suited, as multiple dimensions are involved regarding the distributions of templates and/or words). In a variant, a reversible-jump Markov chain Monte Carlo is used. Other developments include Dirichlet Chinese restaurant processes (number of mixing components is variable or automatically inferred from the data). In some of these developments, asymptotic unique stationary distributions correspond to the ones observed in existing patent claims. In some other developments, random is entirely excluded from the steps of modifying (creation 521).

Optionally, created texts can be evaluated (step 430). In one embodiment, the evaluation is statistical (for example randomly chosen, or according to some proprietary criteria, created texts are peer-reviewed (or crowdsourced). In combination, as a complement or as replacement, an (optional) semantic/meaning verification module can verify and/or “clean” (for example) meaningless results (or score the technical teaching in view of other comparable claims or specification excerpts). In particular, the verification module can comprise an “IP kernel” module which encodes specific patent rules (derived from patent manuals, comprising MPEP or EPO examination guidelines for example). Among other tasks, the final “polishing” and/or rendering of created texts is performed (claim categories, statutory subject-matter, patent profanity words lists, etc). Evaluation and bootstrapping techniques for creation and machine translation can be used in the verification of the resulting texts, including for example the deletion of texts with high entropy word combinations.

In some embodiments, cryptographic hash functions (“hash” or “digest”) can be used (for example MD5 or SHA-1). A cryptographic hash function is a hash function which takes an arbitrary block of data and returns a fixed-size bit string, the cryptographic hash value, such that any (accidental or intentional) change to the data will (with very high probability) change the hash value. Such a (ideal) function has four theoretical properties: it is easy to compute the hash value for any given message, it is infeasible to generate a message that has a given hash, it is infeasible to modify a message without changing the hash, it is infeasible to find a second message with the same hash. In one embodiment, the hash value (or an equivalent) of a second modified text is calculated just after its creation. In one embodiment, the obtained hash value can be stored. In one other embodiment, all individual hash values of all individual modified texts are calculated and a “super-hash” (hash value of hash values) is calculated. Either individual hash values or “superhash” are use with the timestamping token. In one embodiment, for (de)duplication purposes, the hash values are shared (propagated) on the network. If a hash value is already known, the corresponding content is dropped (or not stored or not indexed; but the path of transformations can be kept for analysis purposes)

In one embodiment, a declaration (simple record of date of creation) is associated with an individual created text or patent claim sentence. The clock of a computer can be used (ISO8601). In a development, there is computed the hash value of each variation (or created text). And each said hash value is timestamped at step 522, proving the existence at one point in time of said sequence of strings of characters. In other words, the hash value of each created text is hashed with a timestamping token. In another embodiment, trusted timestamping is used (for example according to RFC3161). Mechanisms such as ANSI ASC X9.95, RFC 3161, ISO/IEC 18014, BTproof (Trusted timestamping on the Bitcoin blockchain) can be used.

In one embodiment, each hash value of each created patent claim sentence is compared to each of the hash values of other created texts (to enable de-duplication), and/or to the ones of existing patent claims (to detect “collisions”, e.g. re-creations). Generally speaking, the computation of a hash value is extremely fast. The computation of large number of hash values (and associated comparisons) can be performed reasonably fast. About large numbers, a hard drive of one terabytes of capacity costs nowadays less than hundred dollars and can store one billion texts, which amount of data can be reasonably indexed and also remains searchable with acceptable latency response times.

In one embodiment, the length of each created text is recorded in its (optional) associated metadata. In a development, the search in the database of created texts can be triggered or associated with a desired “length” of (relevant) search results. The length of a patent claim can be an important indicator for a patent claim, at least it is a manipulatable parameter. For example, a user may want to find very broad generalizations of a submitted/received patent claim: a user may want to search for a short variant in the collection or series of created texts, for example with 50 words or less.

After timestamping at step 522, a unique URL is generated at step 523 and associated with each created text. The unique URL is permanent or persistent, modulo reasonable hosting efforts. The address may or may not evolve over time. If evolving over time, the address can retro-compatible (an old address can still direct to the right content). The structure of the URL address in particular can be optimized to enable fast retrieval response times. The created text is also indexed at step 524 (partly in relation with the ranking system). Additional metadata can be associated with each created text. Among others, the information whether the individual created text is “public” or “private” can be recorded (along with associated publication dates for example). As publication remains optional, a publication date can be in the past or in the future or even “forbidden” or “non-existing” or “infinite” (for example if a client desires the created text never to be published). In one embodiment, a “public” created text can be retrieved and displayed to anyone (logged or not on the website), if the associated publication date is anterior to the date of the query (if not, the created text is not retrievable). A “private” created text can be selectively accessible (for example upon provision of appropriate credentials like correct login/password pair, if the corresponding entity is under a confidentiality agreement). In one embodiment, the metadata (for example including publication dates) is refreshed on a daily basis and retrievable databases are defined for the next day. In one embodiment, one or more lists of URLs are defined (blacklists e.g. private; white lists e.g. publishable or accessible or published/public; and other lists e.g. accessed or collided or emailed, etc). Such lists can improve security (for example to avoid retrieval and display if the created text is indicated as private).

At later stages 540, search queries are received and the database comprising the collection of individual created texts is queried. Advanced parallel ranking processes can retrieve search results candidates and a final ranking among candidates can be determined. Corresponding results for example can be displayed on a web page of a web browser or in an app on tablet or smartphone.

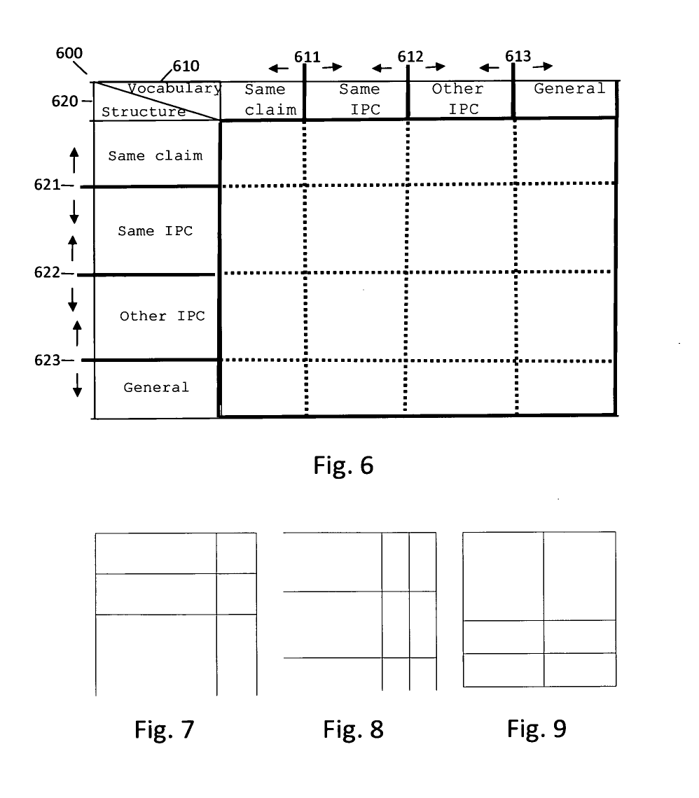

FIG. 6 illustrates one of the possible way to graphically select or parameter the intensity of meaning creation. The table or matrix 600 comprises a row or X-axis 610 for the “vocabulary axis” and a column or Y-axis 620 for the “structure axis”, as well as associated moveable cursors (611,612,613 and 621,622,623) to delimit the proportions of variants or corresponding created texts (or in terms of efforts or of computing time or of storage space or combinations thereof, Z-axis not shown).

In one embodiment, the “vocabulary axis” comprises one or more sub-categories, for example “same claim”, “same IPC”, “other IPC” (or “adjacent IPC” and “general”. The “structure axis” comprises one or more sub-categories, for example “same claim”, “same IPC”, “other IPC” (or “adjacent IPC”) and “general”. For example, the subcategory “same claim” refers to the vocabulary (list of words), respectively structure, of the received patent claim (including claim tree, i.e. the words used in dependent claims, like in “ . . . wherein the node is a head mounted display.” Using this category generally can lead to “focused” creations. The sub-category also can refer to “same specification” for example. “Same IPC” refers to the use of vocabulary used in the same patent classification level (respectively to the structures of patent claims). For example, if the IPC symbol of the received patent claims is (or is indicated or is chosen as) G06F17/15, all the claims (or a subset) of all inventions published in G06F17/15 can be selected and/or used for the creation (respectively the vocabulary). In some embodiments, not all patent claims are used (further selections may be made, and the user does not intervene), this is at least an indication. “Other IPC” can refers to all or a plurality of other IPC classes, for example immediately adjacent (e.g. with a window threshold), with a configurable number of selected neighbours (A61B5/032 would attract A61B5/031 and A61B5/033) and/or with a configurable number of bridged classification entries (for example for A61F13/26, A61B and A61F13/26 can be chosen; or A61B plus A61D7/00 plus A61F13/26 and A61J1/05). The preceding IPC symbols are only examples and other (proprietary) lists of related classes can be used and in particular the combination of repositories can rely on know-how. The use of such words and/or structures/templates increases the informational entropy (it increases the creation of meaning). “General” refers the “universal” templates related to a “top-down” approach derived from cybernetics/control theory (and others) and respectively to associated words e.g. “releasable”, “connectible to”, etc. The use of such sub-categories can introduce substantial informational entropy in the created texts. The expression “IPC” above is not limited to the International Patent Classification, but generally designates all and any kind of patent classification system.

By moving the “vocabulary/structure” cursors, a user can balance the efforts and manage the risks (e.g. self blocking defensive publishing) or opportunity levels (e.g. inventing, testing, exploring, etc) of the creation process. FIGS. 7 to 9 schematically illustrate different repartitions. In FIG. 6B-7 for example, all of the different areas are maintained substantially equal. In this mode, the user can get an equi-repartition or equiprobability of structures and vocabulary taken from all sources. This mode corresponds to a balanced mode. Extremely different structures and vocabulary can be used (“wide” mode), but a reasonable effort is maintained around the considered patent claims (“focused” mode). FIG. 8 illustrates a rather “focused” mode of creation. Few alien (quite different to very different) structures are used, so as alien vocabulary. Efforts are allocated to closely related contents. FIG. 9 illustrates the opposite selection of a “wide” mode: priority is given to different vocabulary sources and structures. In another embodiment, it is possible to reduce one or a plurality of subcategories to zero (or to add new ones). For example, “General” (structures) and “general” (vocabulary) can be reduced to zero. In another embodiment, creation “profiles” are provided (sketched by hand on a tablet for example, provided by scan and email, with the provision of curves descriptors or parameters). These curves can be associated with a matrix or table similar to the disclosed one. In one embodiment, cursors can be independently moveable. In another embodiment, cursors can be dependent, e.g. moving one cursor 613 can affect cursor 623 because of backend management.

The table or matrix can lead or guide certain aspects of the creation process. Some other aspects may not be proposed and controllable by the user. In a simplified model, the creation of meaning increasingly intensifies when different vocabulary and templates sources are used. The order schematically is: words or phrases of the dependent claims (same structure), words or phrases of the associated specification (same structure), synonyms thereof (same structure), hyponyms/hyperonyms thereof (same structure), words and phrases of adjacent or bridged patent classification entries (same structure), same considerations but with similar structures, general vocabulary with same and similar structure, same considerations with different structures, alien words hybridized with alien structures. In a simplified embodiment (2×2 matrix), a first quadrant corresponds to (close vocabulary, no or few changes to the structure of the sentence), a second quadrant corresponds to (different vocabulary, no or few changes to the structure of the sentence), a third quadrant corresponds to (close vocabulary, changes in structure) and a fourth quadrant corresponds to (different vocabulary, changes in structure). In an embodiment, the user can select one quadrant to guide the creation of modification steps.

In a development, there can be received one or more indications as to where to intensify variations and/or how (e.g. intensity of meaning creation) to perform the variations in a text or patent claim. Indications can be provided by a user, by a group of users (for example voted) or by another software. Graphical indications or interactions can be used: (freehand) sketches, selections, scores, color-coding (font and/or background, including grey-scales), transparency effects, marked-up indications (bold, underlined, strike-throughed, etc), animated effect (e.g. blinking), meta data associated to parts of the text, haptic indications, etc. For example, the user can sketch a line under a phrase, illustrating intensities by ups and downs. Some words or parts of the phrases can be circled or selected by touch gestures and associated voice commands received. Colour codes and shades can be used. All such modes can be combined. With such indications, different desired or target intensities (e.g. allocation of creation or modification efforts for example) and/or modalities of variations can be indicated or triggered (types of variations, for example “focused”, “balanced” or “wide”; or along any similar discretization (for example along a scoring between 0 (min.) and 100 (max.)) The modalities comprise, but are not limited to changes in the vocabulary and in the structure. In one example, if colour codes are associated with vocabulary modifications and mark-up indications with structures' modifications, a portion of a phrase underlined in green can mean “vocabulary and structure to be varied intensively”, while another not underlined part in green may lead to “vocabulary only intense changes”, an orange part of the sentence (“medium effort”), a red part (“minimal changes”), a grey part “do not change”, etc. Tolerance levels (dashed lines), scoring, thresholds, animations (blinking, etc) can be used. A typical example is a claim 1 when the last three lines (“the payload”) are underlined to get the majority of the variations there, while some words are greyed out (“frozen part”)

The method of modifying a patent claim can comprise a step of filtering words in a patent classification class. For example, a user can define one or more word frequency thresholds associated to a classification granularity e.g. of an IPC class. The frequency cut can be configurable. Very frequent words can be retained while rare words can be discarded or vice-versa. A distribution (a profile) can be determined (for example 5% of frequent words, 95% of extremely rare words in order to amplify the long tail). The user can sketch or draw such a distribution. Predefined distributions can be retrieved. Optimizations of distributions can be defined according to further criteria.

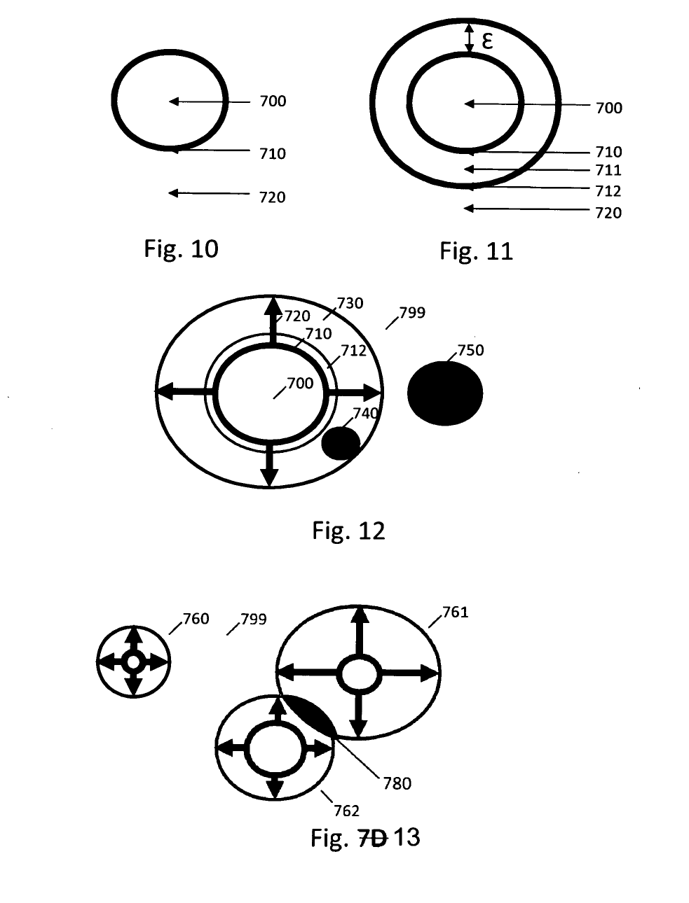

FIGS. 10 to 13 provide graphical representations (simplified illustrations) of some embodiments and aspects of the different inventions, wherein the modified files are patent claims in particular (similar representations also apply for music files). FIG. 10 illustrates a basic framework. Patent claims 710 and specification 700 are particular “areas” in the “space of ideas” 720 (comprising patentable and unpatentable matter, not shown). Patent claims define, in technical terms, the extent of the protection conferred by a patent, or the protection sought in a patent application. Patent claims correspond to boundaries. Such boundaries are represented by a circle or perimeter or barrier or claim staking or limit or delimitation, numbered 710. In Europe for example, the claims shall define the matter for which protection is sought. They shall be clear and concise and be supported by the description. In most jurisdictions, patent claims are interpreted in light of the specification of a patent (definitions if any, context, etc). This “description” (in Europe), called “specification” in the U.S. (term used hereinafter) is illustrated by the grey area numbered 700. This specification serves as a “reservoir”. It contains a “semantic network”, composed of words (nouns and verbs), according to certain relationships between said words. The relationships between words can be explicit or implicit, from a linguistic perspective (grammar and vocabulary, e.g. terminology, lexicography, thesaurus, etc) and also from a technical perspective or interpretation (logical reasoning, common sense, technical teaching, etc). A text can be interpreted as an oriented graph (nodes and relationships between nodes). Measures can be performed on these texts (frequency, lexicography, morph-syntactic parameters, semantics, etc)/graphs (topology) and/or graphs (topology, orientations, regulation, master nodes, etc). The specification is thus a reservoir from which divisionals can be filed and a basis used to interpret the claims. A specification is usually associated with one particular date in time, so as claims. FIG. 11 illustrates that the interpretation of patent claims is not exempt from ambiguities. From the words of the claims considered alone (literal meaning), or with the interpretation according to the associated specification (claim construction), there remain residual uncertainties regarding the legal boundaries (scope, extent) of the protection (sought, conferred). These are illustrated by the “vibrations” or “delta” ε. The boundaries of the patent are “located” somewhere 711 in between a first narrow interpretation 710 and a second broader 712. The different boundaries also can be interpreted in view of Article 69 EPC (“strict, literal meaning of the wording used in the claims” versus “contemplated [protection]”) Juries or attorneys or judges or patent examiners try to assess or decide of said scope. These uncertainties can come from intrinsic ambiguities inherently associated with the use of natural language. They also can derive from vocabulary inconsistencies, grammar errors or ambiguities, unclear antecedent basis in claims, multiplicity of meanings of words, ambiguous contexts, derive from multiple if not contradictory phrases contained in the specification, belong to different embodiments, belong to questionably different embodiments, etc (far from exhaustive). To some extent, these uncertainties can be quantified by current computer linguistics techniques, if and when patent attorneys and computational experts do cooperate. Beyond understanding and quantification, these ambiguities can be technically leveraged, for example “amplified” (as an example among hundreds, the “injection” of the definition of a word in a patent claim can help to delineate one understanding or interpretation of a patent claim). Instead of doing this operation during examination or litigation, this can be done from the very beginning. Such an operation is part of a much larger system and raises technical challenges in itself.

FIG. 12 illustrates, in particular, that patent claims can serve as a basis to create (as represented by arrows numbered 720, illustrating one “expansion” aspect) a plurality of other texts, said texts being graphically represented by a light grey area or zone or surface 730.

The plurality or collection of texts 730 is necessarily in a limited (discrete) number, although the graphical representation appears “continuous”. The number of created texts can be very high (a “zoom” on the surface 730 would show discrete “points” or “inventions” or “slots” or “spaces”). Unoccupied (or expired, in case of exclusive rights) slots may correspond so safe harbours or public domain (not a legal advice, the legal intrications are complex). As a corollary, proportional to the number of created texts, if a created text is searched, and for example identified as relevant for a certain purpose (for example for an inventive step objection or attack), there is a significant probability to find an even better (i.e. relevant) document. The more documents, the more chances (or risks). The number of documents created can be part of the opportunity/risk management model.

As an example, the figure shows other representations: a patent application 940, a granted patent 750 and the “space of ideas” (799, 720). Depending on filing or priority dates, the publication of created texts can prevent or slow-down or limit or impede or block or prevent the grant of the patent application 940. Any text can serve as a basis to create other texts. For example, the patent claims of granted patent 750 or patent application can serve as different basis to create texts according to embodiments of the invention. Patent claims derived thereof can also be adapted, mixed, rewritten, simplified, etc. One of the created text can be chosen and can serve as a further basis to create even further texts according to some other embodiments (multi-recursivity).

Whether these created texts are kept private (not available to the public, for example under a confidentiality agreement) or rendered public (published, printed, shared by email, broadcast on television), legal effects may be different. This in turn can influence or dictate or lead or control or determine technical challenges, general technical problems, specific technical problems, objective technical problems, technical design choices, technical architectural choices and technical solutions. With the intervention of quantitative “quants” techniques in patent laws, including but not limited to the introduction of “transposition” techniques, creations of inventions “by analogy”, the obsolescence of concepts such as technical domains, the latter patent laws may evolve or derive more towards a right of occupation (such as trademark laws) or towards a legal system wherein the literal meaning would have much greater importance.

FIG. 13 illustrates the fact that two different texts can lead to collisions, i.e. the same created texts, as indicated by the common area or zone 780. Expansion rates or creation intensity or types can be very different in case of creations labelled 761 and 762. Over time, new creations such as 760 can further occur. The “density” in the space of ideas 999 will increase. As a corollary, once a relevant text is found for a given purpose (e.g. an inventive step attack), chances are high to find an even more relevant text in databases.

To some extent, the quantity and the “quality” of created texts or patent claim sentences can be controlled. FIG. 8 illustrates some of the possible creation “profiles” or “distributions”. The figure illustrates various modes of creation/generation, in terms of efforts allocation, and/or form/substance priorities. The described profiles are only examples: intermediate forms or combinations can be handled. One or more of such profiles can advantageously be selected, depending on the objectives and context of the creation (for example focused or wide defensive publishing, private i.e. unpublished creations, etc).

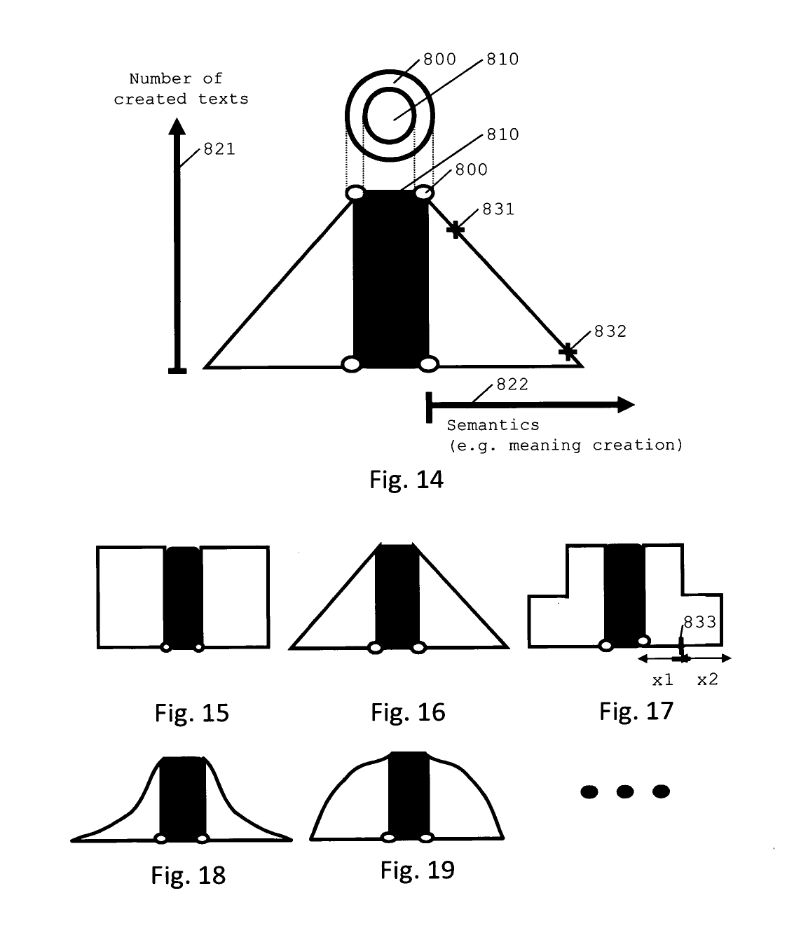

FIG. 14 represents a side-view and refers to patent claims 800. In the illustration, the x axis (qualitative axis) is associated with the “quality” of the created texts (for example an indication of the semantic meaning, or an indicia thereof, or any another synthetic indicator reducing substance/form aspects). The y axis is associated with the “quantity” of created texts (i.e. the number of texts which can be associated or assimilated to a given text quality). The “distribution” of texts (“quantity” of texts according to “quality” of texts) is thus represented. For example, point 832 illustrates a relatively low number of texts associated with a very different semantic meaning from initial patent claims 800. Point 831 to the contrary corresponds to a relatively high number of texts or patent claim sentences, said texts being close from the semantic meaning of patent claims 800. In the example of FIG. 8, the distribution (or function) follows a linear decrease. In other words, from the initial text, a lot of similar texts are created while very few texts will have a different scope.

Examples of distribution profiles are briefly discussed. FIG. 15 corresponds to a rather high intensity of meaning creation which appears substantially constant. This mode of creation for example can correspond to the needs of a technological start-up which requires a wide defensive publishing. FIG. 16 corresponds to a balanced defensive publishing strategy (the more different semantic meaning the less number of text). For example, this may correspond to the strategy of an important corporation (desiring to balance risks versus future disclosures and inventions). FIG. 17 illustrates a threshold 833, before or after which the quantity of created texts or patent claim sentences changes. A particular semantic “point” can be indeed defined (for example simultaneous presence of a lists of words and/or relationships between these words). The number of created texts can increase again after such a threshold point, decrease between a first and second thresholds, decrease again after a third one, etc (not shown). The proportions associated with the one or more thresholds can be adjusted (for example for x1 and x2 in the figure). FIG. 18 illustrates a non-linear decrease (or multiple line breaks and a plurality of thresholds or control points). This scenario for example can be chosen by a corporation or an inventor willing to maintain a focus on the initial text and to observe a rapid decline in meaning creation, while maintaining (or not excluding) a fraction of the created texts devoted to remote semantic meaning. FIG. 19 illustrates an opposite strategy, wherein preference is given to close semantic meaning and a rapid or accelerating decline with respect to the creation of alien texts.

Such distribution profiles can be the results of the creation process, for example as measured (individually for each created texts or statistically). The distribution profiles also can serve as a (initial or continuous) guidelines to lead and control the creation process. For example, during preparation of the creations, the user can select one profile as a guideline for the desired modifications (for example as a general and synthetic indicator). A plurality of profiles can also be selected, each profile being associated with a selected sub-part of the initial text for example. A distribution profile can be parametrized (or customized), for example by specification of further parameters and/or criteria (axis can be renamed or modified etc). A distribution can be a mere indication or guideline (with or without obligations or means or results) or constitute and comprise precise parameters for creation. In one embodiment, a distribution profile is defined, the profile comprising creation parameters comprising vocabulary specifications, structure specifications, or both. In another embodiment, a distribution profile is associated creation parameters. Creation parameters comprise for example one or more of: use of one or more particular vocabulary sources (specific dictionary, specific IPC class, etc), use of white lists (recommended words), use of blacklists (forbidden words), use of grey lists (contextual use or non-use, i.e. rule-based), specific rules (for example “DO operations labelled 15 and 78 WHEN simultaneous presence of two given words like “mouse” and “screen”), one or more selections of predefined text transformation rules. In one embodiment, a control panel presenting the different options is displayed to the user, who can select or deselect one or more options (for example by notching boxes).

The FIG. 14 is a representation for the sake of clarity and understanding. Profiles in reality may not be continuous (i.e. distinct phrases or para-phrases can be discretized, i.e. assimilated). A (revolution) symmetry is artificially figured, while a semantic 2D representation could be illustrated differently (for example with preferential directions or asymmetrical shapes). The figures also represent the absence of texts presenting an extremely different meaning (the quantity of text at the infinite is shown as equal to zero). This of course cannot be guaranteed, as the semantic meaning is not strictly predictable from the modifications being brought to the text. To some reasonable extent, meaning can be predicted, or more precisely risk of meaning creation can be assessed. For example the replacement of a word by its synonym can impact or affect some local properties of the phrase but is unlikely to completely reverse the meaning of the global phrase. Likewise, the use of synonyms are thought to have little impact. The use of hyperonyms and hyponyms is more significant. The combination and simultaneous use of increased and decreased levels of abstraction further increases the risk, so as time management for example. But some brutal divergence can appear at some points. For example, the mere introduction of a word like “releasable” before some nouns can lead to a radically new invention.

In some embodiments, texts can be created along a “continuum” of meaning (or “semantic continuum”). By “continuum” is meant that texts are progressively varied in a way that, given the denotational width of each sentence, a whole “area of ideas” can be covered. In some embodiments, a “density” of semantic coverage is defined, which density implies that for two given sentences or claims, the system can construct a sentence whose meaning is “intermediate” between the two given sentences (or claims). This process can be iterated up to the point where the two sentences are near-synonymous paraphrases and thus the field of meaning between the two sentences is covered (completely or sufficiently, given a predefined threshold). In some particular embodiments, the density value (and/or the similarity of information between two sentences, texts, or claims) is used to avoid the construction of identical or semantically synonymous or near-synonymous phrases or claims. Just like an intermediate rational number can be found between two given rational numbers, each lexical and structural difference can present intermediate positions. These intermediate positions may not be unique. For a given taxonomy of terms of a technical domain (said terms including single and multi-word expressions for example), the ontological configuration can be refined and completed automatically from technical definitions or by a human domain expert. This complete taxonomy allows the system to list all shortest paths between two given terms and thus to cover the semantic continuum between two sentences (or claims). In an embodiment, a method of handling patent claims comprises receiving two patent claims and iteratively modifying the first patent claim (e.g. via synonyms and similar expressions) in the direction of the second claim (e.g. as a target or a reference), for example by covering possible intermediate meanings in a way that each neighbouring modification is in near synonymy with the preceding version or iteration.

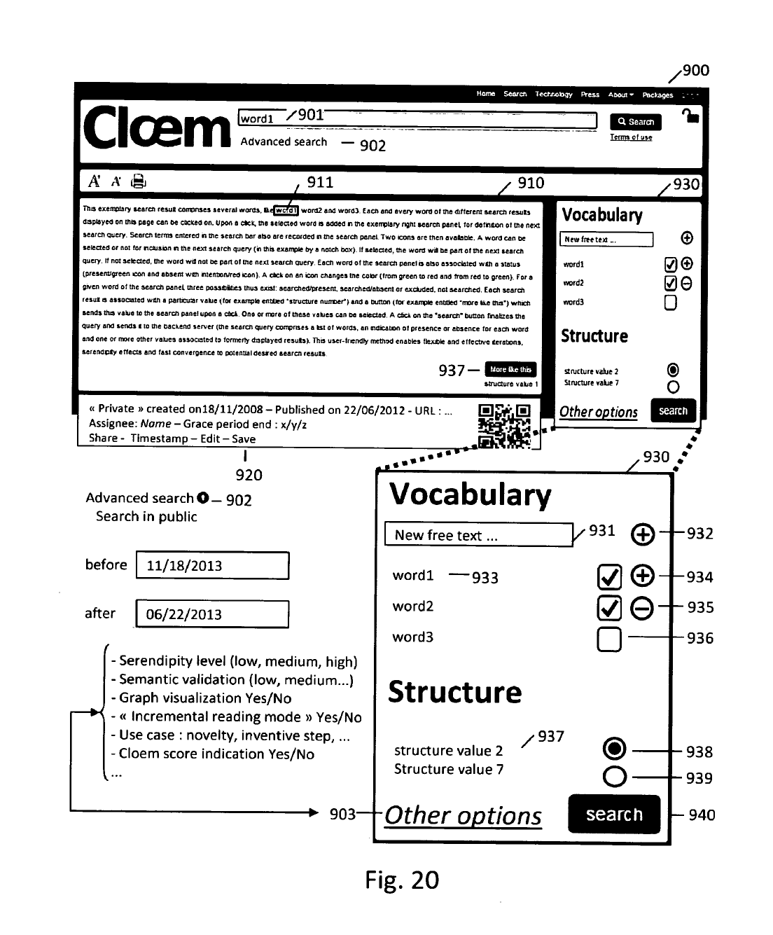

FIG. 20 illustrates one embodiment or example of a web page 900 returning search results (e.g. patent claim sentences) in response to one or more search queries (entered in the query bar 901). Advanced search options are available (search texts by publication date or intervals 902). An example 910 of search result is illustrated. Each word of each search result can be clickable and upon user click is added in a search panel 930.

A search result can be associated with a value, for example a “structure value”, which upon triggering of a button “more like this” adds the value to the search panel 930. A search result (i.e. a text, for example a created or modified text or patent claim sentence) is also associated with metadata. Said metadata can comprise creation date, publication date, status “private” or “public”, indications relative to a provision of patent law (e.g. end date of grace period), the publisher or assignee name, a permanent URL link or a QR code, other options like “save”, “edit”, “share/email”, “request timestamp”, “see graph”, etc. The exemplary search result 910 comprises several words, like “word1”, “word2” and “word3”. Each word of the different search results displayed on the page can be clicked on. Upon a click, the selected word can be added in the exemplary right search panel 930, for definition of a next search query. Search terms entered in the search bar 901 can be recorded in the search panel. Two icons are then illustrated. A word can be selected or not for inclusion in the next search query (in this example by a notch box 936). If selected, the word will be part of the next search query. If not selected, the word will not be part of the next search query. Each word of the search panel can also be associated with a status (“present” icon “+” 934 and “(explicitly) absent (with intention)” icon “−” 935). A click on an icon changes the icon from “+” to “−”. For a given word of the search panel, three possibilities thus exist: search/present, search/absent or excluded (not to be searched). Each search result like 910 is associated with a particular value 937 (for example entitled “structure number”) and a button (for example entitled “more like this”) which sends this value to the search panel upon a click. One or more of these values can be selected. In addition, optionally, the user can add one or more words to be searched via the box 931 and a button 932 to add these words to the next query. The search panel also comprises other options (not shown) to refine search (and obtain faster or different convergences), for example “serendipity level (low, medium, high), semantic validation (low, medium, high), graph visualization activation (yes/no), <<Incremental reading mode>> activation (yes/no), use case mode (novelty, inventive step, clarity, etc), score indications (yes/no), etc. A click on the “search” button 940 finalizes the query and sends it to the backend server (the search query comprises a list of words, an indication of presence or absence for each word and one or more other values associated to formerly displayed results). The search panel thus gathers search options: one or more values of desired structures, a set of keywords derived from the search results being displayed, from search history (not shown), from new words or expressions to be searched 931. When the user is satisfied with the search parameters, a click on the “search” button 940 sends said gathered parameters to the backend and further search results are displayed. In one embodiment, the order of words in the search query is not taken into account. In another embodiment, an “exact search” (preserving order for at least selected parts of text) can be enabled. In some other embodiments, other search options or modes can be implemented or activated, for example “instant search” (real-time display of results as search strings are typed), “fuzzy search” (for example taking into account hyponyms and/or hyperonyms and other thesaurus broadening to catch similar search results), “did you mean” (for example when a typo is detected), “auto-correct” mode” suggest” modes and others can be implemented. This user-friendly methods enable flexible and effective iterations, serendipity effects and fast convergence to potential desired search results.

The ranking system (to display search results candidates) can be proprietary. The ranking system used to order the display of relevant search results (i.e. comprising one or more of words of the search query) can depend on many parameters. Disclosed parameters comprise: the order of words in the search query; the weigh given to the different words composing the search query (in a query like “a method of using a computer mouse, comprising clicking on the screen of a mouse . . . ”, the words “mouse” “click” “screen” can be determined as distinctive while “method” and “comprising” can be overlooked to some extent); the browsing history (preceding selections of contents indicated by clicks of the user, said contents further modifying the ponderation of parameters taken into account to calculate the ranking of a result); the length of the search result and other displayed search results in order to display the search result; one or more thresholds to get sufficiently different texts to read in search results, etc.

In one embodiment, full text of a search result is shown, thereby providing immediate cognitive access to the text (in context and in order, without the need to read different parts of a claim tree for example). Yet in another embodiment, search results can (also, partly and optionally) be displayed using snippets. In such an embodiment, a second text or patent claim sentence can be displayed in the form of a snippet. In another embodiment, a link to the full text (i.e. rendered in full without rewriting or interruptions) can be associated with the second text in snippet form. A snippet can correspond to a reduced form of a given text (for example of a second text). One objective of a snippet is to reduce the amount of text to be read, by presenting kind of a summary of a text. For example, a snippet of the preceding sentence can be “One objective . . . is to reduce the amount of text . . . a summary of a text”. The reduction can be performed in various ways. One way to reduce a text can be performed given certain objectives or criteria, which can include a selection of particular words (nouns or phrases or verbs or relationships). The selection can indeed reflect a search query to show the corresponding mentions of the search queries. For example, the preceding snippet would be displayed if the search queries would have been “reduce text summary”. A snippet can be used to clarify or simplify a text. A snippet can minimize the use of repeated strings, that are common to other displayed search results. The reduction to a snippet can be governed by a constraint in size (for example to reach an SMS size or 140 characters limit). A snippet can be governed by intrinsic parameters (independent from co-displayed texts). A snippet also can be ruled by the consideration of other modified texts being displayed on a current page on the web browser. A snippet can act like a concordancer. A concordancer can be used in linguistics to retrieve or otherwise sort lists of linguistic data (with contextual data) for analysis purpose. For example, the contextual textual data can be displayed (configurable “windows”, for example 3 words left and 3 words right, or asymmetrical configuration). In another embodiment, one or more second text is displayed in full but with parts or portions of texts being graphically highlighted (underlined, bold, colored, blinking, etc). In another embodiment, the snippet of a second text is active (graphical effects are displayed or rendered upon triggering for example by user selection by mouse pointing, touch, gesture or voice command). In some other embodiments, full text rendering and snippet mode are used in combination (in a first example, a snippet first appears, then on mouse-over the full text is rendered, on user click the graphical highlights appears in view of the search query; in a second example, the shake of the tablet displaying results triggers a new calculation and new rendering of the snippets; in a third example, a click on a snippet triggers a new computation of the snippets in view of the other search results being currently displayed). In a development, the created texts or patent claim sentences are to be read independently from one another (no intertextuality). In another development, the created texts can de facto be read together (“incremental reading” and also versus inventive step). Some meaning can result from the assembly of distinct pages. For example, if one created text or patent claim sentence is about a watch and another created text or patent claim sentence is about a smartphone, it may appear inspiring or obvious to try to figure out a smartphone watch. In other words, it may be considered as an incentive to have a co-location of concepts in a single web page. This remark generally applies for search engines, but as the created texts can aim at being technical, such intertextuality may be, if not tracked, at least taken into account. A possible, yet optional, tracking can consist in the storage of logs indicating the simultaneous display of different texts (snapshots of search engines results associated with search queries). This embodiment may require prior user consent. In a development, the search queries received in the disclosed system are in turned queried in large and predominant “public” search engine systems and associated snapshots (i.e. links to documents) are recorded (for inventive step attacks and also for vocabulary repositories explorations).

In a development, there is provided method for incremental reading mode of search results. Typically in the case of patent claims, a web page displays between 5 and 20 search results (with of without scrolling options). These search results can comprise texts displayed in full and/or in snippets. The search results can appear very similar. In such a case, it it efficient to let the reader read the first search result in full and then to highlight the further differences of the second search result with the first text (which can comprise incremental modifications). The highlighting can be obtained by graphic effects (for example added-new text is underlined, deleted-absent text is strike-through, modified text is in bold, and the like). Instead of reading a lot a similar variants, sometimes very incremental variants, an incremental reading method can thus reduce the cognitive load of the reader. The disclosed method thus “compacts” the search display page, in a mode which is contextual to the actual page being displayed. In one embodiment, the method (e.g. associated computations) are processed on the client side or alternatively are pre-processed server side before sending the search results to the client device. The method can be optionally activated by an activable or selectable option on the search results web page (e.g. notch box on the UI or the like) and/or can further be configured with one or more thresholds (e.g. a minimal number of modifications to be graphically highlighted, for example via a graphical and movable cursor on the screen). In one embodiment, the option is automatically triggered or deactivated. For example, if more than a predefined number of differences is measured between two texts of the page (for example measured in words, e.g. exceeding 10 or 15 words of difference) then a full text reading can be required. The differences between two or more texts can be computed in various ways. For example, the comparison can occur in cascade (a text of order of display (n) can be compared to a text of order (n−1)). Alternatively, since text 1 is assumed to be read in full by design, texts (n−1) and (n) can refer back to the same first text. Some pivotal text points can be defined, wherein the comparisons can start over. A comparison between multiple texts (more than 2, e.g. 3) also can be implemented, with the objective of reducing the cognitive burden of the reader (for example in view of the display of search results and distribution of portions of text to be highlighted across the screen, for example to get a balanced graphical rendering). The reading scenario can be different if search results correspond to one or more different series (a series corresponds to the collection of variants created from a same initial text). Created texts of two very different series can be very similar, yet in the example, it is assumed that the variants of different series appear different. In the example the search results can comprise a few variants of a same first series 1 and a few variants of another second series 2. In such a case, the incremental reading mode starts over when switching to another series (text 3 is compared to text 2 which is compared to text 1 and text 6 is compared to text 5 which is compared to text 4, when texts 1,2 and 3 belong or correspond to a first series and texts 4,5 and 6 belong or correspond to a second series).

Created texts or patent claim sentences can be read independently (unique and/or permanent URLs). Created texts can also be collectively displayed (in search results): they can be read “together” in practice (“in context” or as co-texts). For patent laws, it is usually not acceptable to combine different embodiments to build an artificial novelty-destroying document (i.e. search results of a web page generally cannot be combined for novelty objections), but such a web page aggregating search results may reveal or provide (e.g. sufficient) incentives or teachings or motivations to combine different embodiments (inventive step objections). An advantage of the disclosed model and associated embodiments lies in its ability to “replay” searches, since the search queries, the search space and the search algorithms are controlled or mastered or known (this is not true—or at least significantly more difficult—for large public search engines, for which the search space constantly changes and is not necessarily mastered by the search engine). In one embodiment, <<snapshots>> of search results associated with search queries can be saved (for example images or by references, e.g. URLs). In another embodiment, search results associated with (e.g. observed or theoretical) search queries can be stored (and further retrieved) by differential methods. These search results lists optionally can be timestamped (possibly by trusted timestamping). Upon each search query, the list of associated search results (for example up to a threshold in page views) can be saved. In other words, the different created texts associated with a given search query string can be saved (for example their identification or references, in association with a given date), the corresponding searches having being performed in the reality or not. As a subset, the results having being displayed—for real—can be saved or logged. It can thus be provable that the skilled person, with a given search query, would have been facing (respectively has been facing) a defined set of search results at a certain point in time. Associated inventive step attacks or objections can then possibly be formulated. In a development, beyond “static” snapshots, “dynamic” landscapes (e.g. sequence of snapshots) can be recorded (and also possibly timestamped). The context or set of co-texts associated with an invention defined by claims (or keywords with boolean expressions) can be progressively or iteratively constructed. An associated sequence of searches (effective or potential) can be analysed and leveraged to raise inventive steps objections. In practice, in an embodiment, a given patent claim is derived into a set of regular expressions (keywords or phrases, boolean operators), which expressions are in turn associated with corresponding search results. In an embodiment, a received patent claim (or any text) automatically can be translated into a set of search queries and corresponding search operations be performed (for example in batch). Corresponding inventive steps can be quantified (by way of lists of associated words, probabilistic approach, similarity measures, etc). In one embodiment, inventive steps attacks leverage similarity measures (for example lexical proximity, etc), from the patent claim considered alone or with consideration of associated derived search results. In a development, the user is warned that his search queries can be recorded and (re)used. In a further development, responsive to received user queries, “intermediate” texts can be created (on-the-fly or later on) from displayed co-texts. For example, if a search query X returns three texts A, B and C, then new texts can be created by mixing embodiments of the respective texts A, B and C (in the example, texts “A+B”, “A+C” and “B+C”). Still further, entire series of variations and/or mixed embodiments can be created (text “A+B” would not be a unique text). Mixing embodiments of texts A and B (along other disclosed embodiments) comprises mixing (e.g. replacing, substituting, permuting, translating, deleting, etc) features of texts A and B (e.g. vocabulary and/or phrase structures), creating “intermediate” texts. The advantage of such a development is that “real” (i.e. observed) queries can be further leveraged to “pave” or “densify” a technical domain (public or private domain). The more queries, the more texts can be created. Optionally, created texts can be timestamped and/or published.

In a development, the user can select words, parts of phrases or entire sentences from the different created texts or search results being browsed (which are then available in a “cart”). Upon further selection(s), for example by means of selection of notch boxes in the cart view, the user can trigger one or more creations based on the selected items. For example, the user can progressively pick up words like “mouse”, “screen”, “haptics” and an expression like “is activated upon operation of”. The creation engine then for example can create texts like “a mouse with an haptic screen which is activated upon operation of said screen”.

Embodiments as to where to intensify textual variations and/or how to perform textual variations can be applied to search operations in databases (e.g. comprising already created texts or patent claim sentences). From the standpoint of any linguistic analysis (formal and/or syntaxic and/or semantic and/or lexical and/or phonological and/or phonetic and/or logical and/or translational, etc), two given texts can be assessed as identical, quasi or near duplicates, very similar, loosely similar, different, very different or completely different (all intermediate states being possible along a <<continuum>>). Of course, a small change in an initial text (e.g. the replacement of a single word) can lead to a completely different meaning but in terms of form (not substance), the texts can be considered as similar (with an optional similarity measure or quantification). There is disclosed a method of searching a text in a group of similar texts. The method for example comprises receiving indications or selections of one or more parts of a text (which can be any text, for example a search result or an initial submitted text), optionally receiving indications regarding changes associated with the one or more parts of the text, said indications determining accepted or allowed or authorized or desired changes and/or determining to what extent changes are accepted or allowed or authorized or desired (for example by receiving a change level value or a change quantification value associated with the one or more parts). The user for example thus can define that the introduction of a sentence (e.g. of the patent claim) is not satisfactorily (the user for example can ask for a change in claim category, if available), while the middle of the sentence is associated with the change value <<change>> or <<find others>> and the end of the sentence (for example the characterizing part) requires the minimal amount of changes. In an embodiment, search queries are handled <<flat>> (e.g. not taking into account the grammar). In another embodiment, grammar is taken into account (e.g. parsing steps are performed to analyse the one or more parts, the relation with the unselected parts of the sentence, etc.), thereby combining synergetically grammar analysis and search operations. In an embodiment, the variation constraints may not be carried out on the flat text, but directly on the syntactic or semantic analysis, for example a dependency tree or a phrase structure tree, thus revealing more easily the relations between the words and phrases of the text. Equally, the search can be done by similarity measures not performed on sets of word, but on the syntactic tree structures. (e.g. similarities in trees). One advantage of the method can be a fast search, i.e. a rapid convergence to the desired results (if any). The method is generally flexible and advantageously offers several <<control points>> to the user, who then can perform tactical choices or search queries (for example insisting on key parts, leaving some parts unchanged, etc) while global compromises can be made (e.g. weighing constraints or wishes), etc. With such a method, the user advantageously can retrieve texts fit for novelty objections, some others fit for inventive step objections (presence of a missing feature, complimentary technical effect, related technical domain, etc.), find better versions to enhance clarity, retrieve appropriate claim categories, etc. The granularity of choices ranges from one word to be (tentatively) changed (in an example, the word <<screen>> may not be optimal) to large parts of the text (comprising clauses, and beyond).

Search queries can range in length, from a few keywords to an entire patent claim sentence or even a patent claim tree. The length of the query can indicate an emphasis on vocabulary and/or structure or grammar. In some embodiments, short queries (e.g. a few keywords) are not analysed (beyond the order of words). In some embodiments, a long query is parsed (structural patterns of the query are used to perform searches, along the vocabulary). In some embodiments, the queries can be assisted. For example, the user can be invited to rank or order keywords by decreasing priority, to indicate which words or parts of the query require exact matches and which ones can get similar matches, to provide further keywords (e.g. if too many results are returned), to confirm or infirm suggestions, to use operators, to select sub-graphs of interest, etc. Corresponding graphical user interactions are provided. In some embodiments, partiCular modes can be provided. Particular modes comprise a “novelty” (destruction) mode, an “inventive step” (objection) mode and a “freedom to operate” mode. In the “novelty” mode, the closest results will be searched. In the “inventive step” mode, complimentary results can be (tentatively) retrieved. Given an objective of a text C, there will be searched two texts A and B, which when combined may lead to said text C. A number of quantitative criteria can be used to define such a combination (e.g. common parts, specific parts of each text, adjustments in length, technical domain, etc). In particular, in the “inventive step” mode, a query of a user can lead to a plurality of (non-visible) combinatorial search queries and iterative searches against the databases. In the “freedom to operate” mode (two-steps), the query itself can be varied and if confirmed by the user, each variation is checked against the databases (with standard or adapted comparisons). For example, a user can query “a mouse with a screen”. The sentence will be reasonably varied and for example fifty variations will be proposed to the user, such as “an input device with a display” or “a screen on a mouse”. The advantage of the embodiment is that the user can semantically appreciate the variations and confirm or eliminate or edit or amend some corresponding textual forms. The confirmed and/or amended variations are then used to perform searches. A search query is thus enriched (possibly incorporating contents of the target database, or independently from it).

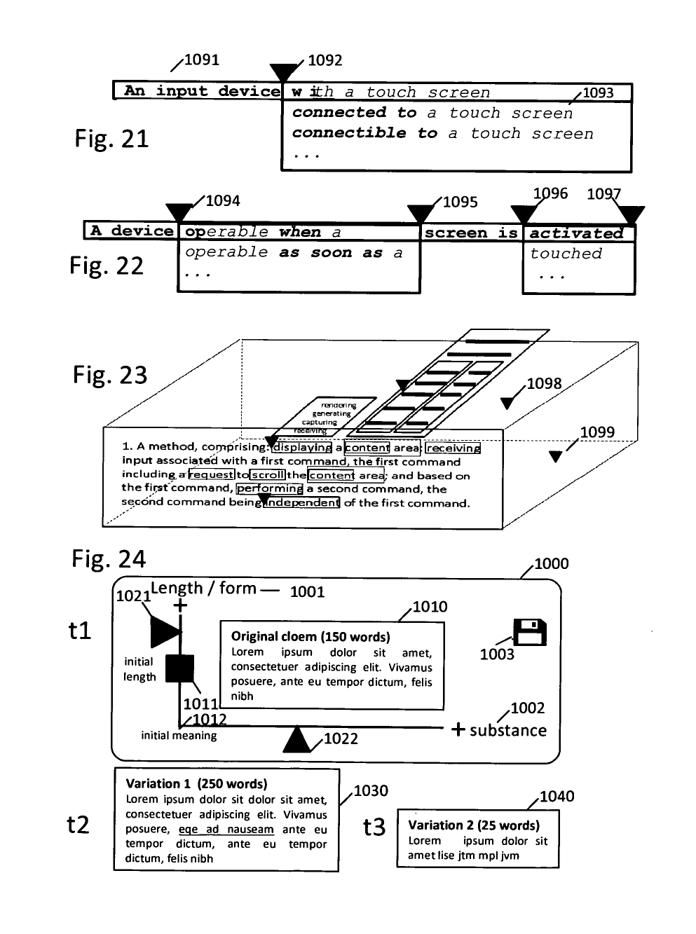

FIGS. 21 to 24 illustrate various user interface embodiments for the display of search results (or input of search queries). FIG. 21 shows an auto-completion mechanism, for example in an “instant search” mode. In one embodiment, the user can type the first text 1094 and greyed text(s) 1095 can show existing strings of characters existing in the database of created texts (for example published texts). In another embodiment, the greyed text(s) can correspond, to the opposite, to texts which have no counterparts in the database. The user can select one (or more) of the greyed texts. In this way, the drafting of the first text can find its way “into the cracks” and tentatively be novel. Options presented to the user (not shown) can enable to control parameters and thresholds to assess such recursive novelty assessments (by IPC, by confidence thresholds, etc). FIG. 22 shows a more sophisticated example, in which the user is satisfied with certain parts (which can be considered as “frozen” in some embodiments) of the text and desires to get (guided) variations for some other parts (in the example, the delimitation cursors 1095 to 1097). Such an embodiment for example advantageously enables a co-creation process which leverages both human intuitions (e.g. “where does the text require amendments?”) and machine capabilities (like instant, fast and recursive searches in databases e.g. “does this exist in databases?”). In developments, the parsing of the entire sentence (greyed parts and non-greyed parts) can be optimized etc. FIG. 23 illustrates one of the very numerous possibilities for a 3D user interface. For example with a 3D screen (or an augmented reality helmet or a head-mounted display wearable computer or a 2D screen with appropriate visualization options), the user can select one or more parts of a first text to be frozen (or positively parts to be varied). Search results may display candidate expressions and words for replacements (for example), these candidates being displayed in depth (orthogonal to the 2D text, or according to several and simultaneous angles thereof, etc). The third dimension enables to display more information, including indication of co-references (anaphoric relations) or enchassements for example. In an immersive embodiment, the user can walk around and through the text, zoom in and out, look behind, etc. The user then can visualize and select one or more words or expressions (for example the expression located at 1098 and a word located at 1099) for “materialization” of one or more variations (upon selection, one or more variants can be automatically “materialized” and post-processed if necessary). As in FIGS. 21 and 22, such interactive and immersive visualization options can be advantageous. The exploration of “gaps” in databases (novelty, inventive step, etc) becomes possible or is facilitated.

FIG. 24 shows another example of user interface 1000 and navigation in data. The figure shows a user interface with two axis: “substance” 1001 (in some embodiments “meaning” or “semantics”) and “form” 1002 (in some embodiments “length”). A text 1010 is displayed (the displayed text can change over time, it can correspond to the first text or one of its variants, e.g. second text or modified text). At time t1, the initial first text is associated with its initial length 1011 and its initial meaning 1012. A “save” option 1003 (or a control panel with options, not shown) is accessible. The user can move two cursors 1021 and 1022 on each axis. For example, at time t2 the user moves up the “length” cursor (increases length of the text 1010) and keeps the “substance” cursor unchanged. These moves send creation parameters to the backend computing variants and a longer text 1030 returned. For example, only synonyms are used and some parts of the initial text can paraphrased, appositions can be inserted, etc. At time t2 the user decides to shorten the text (and following the substance is affected too). In the example, a text 1040 is obtained. In one embodiment, the user can activate independently the two cursors, at least try to. Depending of the irreductible intermingled nature of form and substance, the two cursors may not move independently. In one embodiment, the present user interface is a navigation interface in pre-computed texts (i.e. variants have been created, are stored in a database and sorted out by length and at least probabilistic meaning).

In such an embodiment, variable text 1010 correspond to both the search result and the initial search query. In another embodiment, the user interface triggers the creation of variants in the directions desired by the user. Options (not shown) can comprise other developments described in the present document (patent classification or lexical directions, drafting styles to be mimic, scoring, etc).

Some developments around user interfaces are now discussed. Some embodiments can be implemented in touch-based user interfaces. For example, with a touch screen, a user can swipe to the right and the text is expanded; to the left and the text is reduced; to the top and the indicated word (or plurality of words or fragment of phrase or the area being designated) is modified into hyperonymy; to the bottom into hyponymy. Diagonals also optionally can be used (e.g. left-right descending for focused modification, left-right ascending for broadening vocabulary; the right-left corresponding actions affecting the structure of the phrase) and borders as well (e.g. top/auto-play, right/next, left/previous, bottom/save). Corners (interior and/or exterior) also optionally can trigger commands (e.g. open general menu; open ‘partial freeze’ mode; selecting a part of the sentence by maintaining a finger on a specific corner, which selection is applied general commands described above; email, comment, edit or share the current text, etc.)

Other embodiments are now described.

In one embodiment, the method is used to detect unclaimed matter. Such matter in a patent application is “dangerous” (or constitutes an “opportunity”) because divisionals can be filed based on such matter, for example to match the specifications of a product (launched or to be launched). To be able to detect such unclaimed matter is a challenge from the perspective of natural language processing. The methods and systems of creating variants according to embodiments of the invention precisely allow to assess such unclaimed matter. The ability to control how different versions of a same text can be created enables to have fine-grained analysis capabilities to engineer and reverse engineer a given created text in view of a given original text, for example to extract what is—and what is—not derived from the original text, or to which extent. It may be that the first and second text are indeed more or less consistent with one another (claims and associated description). It may also be that the two compared texts have nothing in common (in such a case, the results show that a very large fraction of the text can not be subtracted from one another).

In one embodiment, the method of detecting unclaimed matter comprises receiving one or more claims and receiving the description (or parts thereof), creating variants (according to one or more embodiments of the present disclosure) of the one or more patent claims, comparing said variants with the descriptions (or parts thereof). The comparison methods or steps comprise subtracting word by word, after or without lemmatization, and/or using paragraph-based rules. In one embodiment, the step of comparing is performed by either a) ignoring text sentences, i.e. grammar or order of words, or to the opposite b) by taking text structures into account, for example comparing tentatively aligned sentences or even c) according to hybrid comparison techniques, i.e. intermediate steps combining tokenisation steps and alignment steps.

The method of subtracting words, and possibly thanks or via a thesaurus (synonyms, hyperonyms, holonyms, etc), to some extent can ignore the structure of sentence, i.e. be indifferent to the order of words. Semantics can be quite hard to handle and in fine this level of understanding may not required for certain applications. In some embodiments, the method can ignore the order of words. For example, the first and second text are tokenized, words are ordered by alphabetical order and subtracted one by one, if possible. The remaining words are detected, possibly highlighted, and rules by paragraph can be applied, if possible.

Regarding paragraph-based rules, for example, if a first parameter comprising the number of words—associated with a paragraph of the description, the paragraph being detected by line return and/or by special spacement and/or by indentation—associated with one or more correspondences with the one or more patent claims, exceeds a second parameter comprising a predefined threshold, then an entire paragraph can be considered as not unclaimed). For example, if three fourth of a paragraph have some equivalents in the claims, said paragraph can be considered as claimed.

In one embodiment, variants or paraphrases comprise phrases or sentences created using one or more of replacement/substitution, insertion or deletion of one or more of a copy, synonym, hyponym, hyperonym, holonym, meronym of a word or of a phrase of an initial text (for example of first text). Variants also can affect the template, e.g. the phrases or syntax or structures of sentences.

More generally, in another embodiment, two texts of any kind can be compared (i.e. not necessarily the claims and the associated description). Possible pairs for example comprise: a priority document and a further application claiming priority; a patent application and a prior art document; an application and its closest prior art document; patent claims and an abstract; two sets of claims (unrelated or parts of the same family); two scientific articles; a scientific article and a claim tree; a book and an article, etc. Each situation is associated with respective advantages. The comparisons are enabled by the paraphrasing technology presently disclosed. There is generally provided a method of comparing two texts, comprising receiving a first text and a second text, creating one or more variants of the first text and comparing said variants with the second text, isolating parts of the second text without association with the first text, graphically highlighting said parts.

In one development, one or more comparisons are displayed. Not all comparisons need to be displayed, only a subset of comparisons can be displayed for example. The display can occur by various means, including but not limited to superimposing displayable elements on the second text, mouse-over options, strike-throughed and/or deleted, underlined and/or colored font, etc. Augmented or virtual reality user interfaces also can be used. Haptics can be used as well (shaking the text can show modified text to vibrate more than unmodified parts). 3D interfaces are also possible (e.g. a low height indicating a strong choice and a higher height indicating that the word can move away). Audible, touchable, braille feedbacks also can be used in combination with the preceding modes. In terms of graphical user interface, numerous options can be implemented. The user may handle or select individual options, for example checking independent notch boxes such as “hyponyms”, “hyperonyms”, “synonyms”, etc. Or the user may operate synthetic cursor, with or without explanations. Concurrent comparisons can also be handled automatically and a scoring system optimized results (for example, those maximizing the differences). Rules also can be used to control displayed results. For example, paragraph-based rules can define thresholds to control graphical display of differences. In one embodiment, if two thirds of the words of the first text and corresponding to those of the first text (directly via exact matching, or indirectly via thesaurus), the paragraph can be entirely greyed out. In some cases, it may be that the intention of the drafting person was not to hide specific words in the amount of the second text, and therefore in order to manage the attention and improve the readability of the results of the second text, minor changes can be neglected. To the opposite, when the assignee agressivity or the circumstances of the case does require more attention, even tony differences can be highlighted. The user thanks to GUI options can navigate and leverage the fact that the machine reads much faster than human eyes. Yet, the human being is much better at contextualizing the results and to optimize the reading strategy.

For example the first text (e.g. claims) is “a mouse with a screen” and the second text (e.g. description) is “an input device with a touch display”. In some embodiments, the displayed results will graphically grey the words “a”, “mouse” (being an hyponym of “input device”, that is “input device” is an hyperonym of “mouse”), and also “display” (synonym of “mouse”). In conclusion, the second text will be greyed to the exception of the word “touch”, which will be otherwise highlighted. This graphical result indicates that a patent applicant may use the word “touch” in a divisional (if applicable).

In one embodiment, the display of one or more comparisons is function of one or more parameters, said parameters comprising one or more predefined thresholds and/or one or more rules. The basis for comparisons can be word by word (with or without order), chunk by chunk, sentence by sentence, paragraph by paragraph (detected by line return), set of paragraphs. The associated threshold can be quantitative, e.g. 0.80 for 80%. For example if 80% of words in a paragraph of the description are identical to words of the claims, a predefined rule can specify that the entire paragraph will be graphically greyed. The associated threshold can be qualitative: as a result of a certain comparison, a ranking can be outputted (e.g. <<very different>>, <<different>>, <<loosely similar>>, <<similar>>, <<very similar>>, <<nearly identical>>, <<identical>>) and the user interface can restitute such assessments. The one or more thresholds can be both quantitative and qualitative (fuzzy logic). Graphical indications can be a function of text comparisons, for example according to identity of similarity of words or sentences, said comparisons being performed according to various granularity (word, chunk, sentence, paragraph).

The one or more rules can be predefined (e.g. previously encoded) or can be dynamically adjusted (e.g. in response to user actions, for example as a function of a profiling or search or browse history). In some embodiments, a rule can be expressed with Boolean expressions or in pseudo-language or in natural language. Thresholds alone can be used (just measurements facts), rules alone can be used (conditional to other parameters than comparisons of texts), thresholds and rules can be simultaneously used, independently or in dependency (when one or more rule apply to one or more comparison threshold).

In a development, the threshold is adjustable. The threshold can predefined, adjusted or adjustable. In a development, the user (or the system) can adjust the threshold. With an adjustable threshold in (near) real-time (i.e. the differences can be updated and displayed fast), the user or the system can adapt to a wide range of situations, for example assess the support of the claims, assess the opportunities and risks associated with claims' amendments during prosecution and/or adverse filings of divisionals, determine safe harbors, etc.

In one example, it can be desirable to detect the even tiniest differences, e.g. to detect a description comprising <<in vivo embodiments of the invention are possible>> whereas the claims comprised <<in vitro>>. The differences can be very small but the associated potential harm can be high, for example if a divisional is adversely filed. This is an extreme scenario. When less rigor is required for the analysis task, a different threshold can be chosen. Exogenous parameters like <<assignee risk>> or <<known IP agressivity>>, <<known intention to hide contents>>, <<divisional propensity>>, <<legal ability to effectively file divisionals>>, etc, can be parameters which can lead to adjust automatically the threshold. By dynamically changing the threshold, the user of the system receives information about the very nature of the text. If changing the threshold a lot does change significantly the comparisons, it may correspond to a second text loosely consistent with the first text (possibly indicating weak support, possibly indicating an increased risk of claims' amendments); to the opposite, if changing the threshold does not affect the displayed results, this may mean the second text is highly consistent with the first text (indicating strong support and low risks of adverse amendments). In one example, the second text can be a mere copy of the first text (e.g. to preserve claim language). In one other example, the second text can comprise simple variations of the first text, for example comprising synonyms of words of the first text and/or rearrangement of the order of words or sentences, indicating a mere paraphrasing of the first text, e.g. possibly without any intention to hide contents. In one other example, the second text can be a mixture of copy and paste operations from the first text, but the additional matter can be very different from the first text, and possibly this would enable an adverse party to file a dangerous divisional. The simultaneous use of hyponyms and hyperonyms usually indicate so-called <<intermediate generalizations>>, which patent attorneys strive to write down when drafting patent documents.

In a development, a graphical map is shown to the user, the map for example representing the submitted text and some specifics of the text. For example, the (thumbnail) map can show a “density” map locating the unclaimed matter (i.e. words or phrases or contents not aligned with the claims). In one embodiment, aligned words or phrases or paragraphs are greyed and “alien” content is indicated in red (or shaded colors, from cold blue to hot red colors). Optionally, the user can click on a part of the map and be redirected to the plain full text for further reading.

In a development, there is provided a method of handling a text, comprising tokenizing the text, and filtering obtained tokens. The tokens can be words, phrases or other meaningful elements. For example, tokens can be separated by whitespace characters, such as a space or line break, or by punctuation characters. Tokens can be nouns or verbs. A noun can be a single word or a phrase (e.g. “input device”). Verbs usually are selected from a proprietary list of about 200 verbs, defined by large scale analysis on available patent literature corpus. In one embodiment, the text is a patent document. In a particular embodiment, the text comprises patent claims (independent and dependent claims, for example an entire claim tree). In another embodiment, the text is a scientific text. The text is received from a user or retrieved automatically from a reference number. In a development, the one or more filters are detecting empty tokens and/or spam tokens and/or generic patent tokens and/or specific patent tokens and/or tokens associated with a variable specificity ratio. An “empty” token is not an empty string, it corresponds to a very frequent token (noun, verb, sentence, chunk, etc) in the patent literature corpus, and in patent claims corpus in particular. Such an empty token does not convey immediately useful information for the reader about the substance of the claimed-subject matter, for example “comprising” or “step of”. A “spam” token can be a redundant or un-necessary term or expression (e.g. “non-transitory readable media encoded with a computer program including instructions executable to”). In most cases, these “spam” tokens are justified by language constraints implied by case law. The added value of such “empty” or “spam” tokens is usually low for readability purposes (“bla-bla”). Of course, knowing whether an invention is a method or a system is critical, but prima facie this does not immediately matter for the reader (this can be specifically indicated, for example by a color code). A “generic” token can be assessed so in view of the International Patent Class (IPC) (or equivalents). For example, the term “computer” is not creating any cognitive surprise when considering G06 inventions. A “specific” token is determined in view of a narrower IPC classification granularity. A token “associated with a variable specificity ratio” corresponds to a token presenting enough “specificity” for a given IPC level (i.e. at class or subclass or group of subgroup level), i.e. which exceeds a predefined or calculated frequency threshold in the corpus associated to each IPC level. The threshold can be predefined (static) or can take into account the other detections of tokens for the text being analyzed (dynamic). There can be no strict delimitation between categories “(empty”, “spam”, “generic”, “specific” and “variable”): a given token can belong to several categories. In a development, the one or more filters are adapted to filter tokens obtained from a second text. In one development, the filter can be adapted to take position against another text, and the differences between the two texts will be taken into account. The ability to compare two texts in particular implies the ability to compare n (integer superior to 2) documents (for example recursively, or by comparing two by two, etc). In a development, the method further comprises the step of selectively displaying filtered tokens. The results of the filtering operations can be visually rendered (displayed, restituted, etc) to the user (synchronously or asynchronously). A selection operated on filtered tokens can mean that further criteria can be used to optimize the psycho-visual rendering to the user or reader. Ambient context can be taken into account (accelerometer data indicating motion of the user, for example corroborated with geolocation data, will induce a certain type of human-machine interface, for example according to predefined rules or dynamically adjusted). Various cognitive mode are possible, for example associated with input and output means or interactivity means available in the vicinity which can be leveraged (for example haptic feedback, tactile response, audible signals, text to speech, distributed display over several complimentary screens, virtual reality, augmented reality with head-mounted displays). The display can occur at once or be progressive over time. The display can take into account the focus of the user, i.e. the further processing and highlighting of tokens can be dependent on the view history (ranging from recent and personal history to ancient and collective reading). The display can comprise color codes, animations, contextual videos, video links (click-able portion of an image). Additional data (for example metadata, data about the data, such as the qualification as “hyperonym” associated with one word, or the definition of a word, or the observed frequency of a word) can be disclosed to the user upon actions of said same user (said actions possibly being determined by eye-tracking or nervous input or measure) or according to averaged collective behavior observed for the considered text or a variant thereof.

Some embodiments of the method allow the reader to gain faster access to the very substance of the text, i.e. it lowers the cognitive burden of having to decrypt and/or to reverse engineer and/or to de-obfuscate a text, which can be for example encumbered by legal jargon, or which can be the object of multiple repetitions (to justify of appropriate antecedence's handling for example). Among other aspects, the formal operations of handling, for example “subtracting” words when comparing texts are therefore automated. Such operations are of technical character, i.e. they raise technical, scientific and conceptual problems (formal anaphora resolutions, dependency grammar, etc) and lead to technical solutions, for example which can only be implemented by technical computerized means to meet fast response times and which also are associated with further technical effects, for example associated with the requirements of limited technical choices or compromises (choice of thresholds after upstream analysis of corpus, arbitrary choices made in the model, limitations in memory or processing resources, etc).

Numerous optimizations can be performed to improve the choices of words to be substituted in patent claims. Among these optimizations, there is disclosed a method to extract and recombine inventive features. In a development, there is provided a method of extracting tokens from a text or corpus, comprising parsing the text and extracting tokens following predefined triggering tokens. Various sources (case law, patent examination guidelines, heuristics, qualification exams, etc) can lead to establish a list of “triggering tokens”, i.e. words or expressions which introduce advantages, technical effects, inventive step indicia of all kinds. By appropriately analyzing the phrases surrounding (following) these “triggering tokens”, particular associations of words can be analyzed and recorded. Such analyzes can lead to specific (extended) “collocations”. For example, the use of the expression “image rendering” can be associated with the advantage of “secure the display of ads” and “defeat content blockers”, leading to particular relationships between the tokens composing these expressions. Such advantages are detected through the use of these “triggering tokens” which serve as parameters to handle appropriate subsets of corpus. Following, words of replacement can be advantageously taken out of these associations. Other actions can be based on such an analysis. In a development, the predefined triggering tokens are derived from one or more legal criteria. For example, the following legal criteria lead to the constitution of lists of words or expressions which serve as triggering tokens: common general knowledge, “as a whole”, analogous prior art, same technical field, closely related technical field, remote field, routine work, obvious to try, new effects, problem discovery, incentive to combine, known problem/need, teaching away, motivation to combine, inventive factors, reasonably related to same problem, TSM, teaching, suggestion, motivation, could-would approach, hindsight to avoid, unexpected technical advantage, surprising effect, long felt need, commercial success. Each of these legal criteria lead to corresponding lists of (key)words and these words are in turn used to analyze the patent corpus, to determine the different lexicons to be injected in patent claims. For example, the “surprising effect” legal criterion provides the triggering token “surprisingly”. The sentences following the triggering tokens are associated with special analysis priority. In a development, the predefined triggering tokens are extracted from the “summary” section of a patent document. In a development, the predefined triggering tokens are extracted from the first half of the “detailed description” section of a patent document. When patent attorneys draft their applications, they often argue that certain features present some particular advantages to defend the patentability of their claimed subject-matter (inventive step in particular). These statements often are to be found in the section called “summary”. These also can be found the “detailed description”. In a development, one or more tokens, words, phrases or expressions following the occurrence of one triggering token are selected. Derived and special computations on the sentences following the triggering tokens can be performed. In most cases, the relevant information is located within the next two sentences, in some occasions in the next few words, rarely a few sentences afterwards. The different phrases following the triggering tokens are parsed and tokenized. A predefined list of known technical features (e.g. a “screw”, a “virtual machine”) can be used to detect and extract so-called “technical features” or “means” and to associate these with “technical effects” (e.g. “fast”, “cheap”, etc). The association advantageously is contextualized (the IPC number is recorded). For example, in G06 the skilled person will know that the use of a virtual machine is generally useful against malware propagation. In a development, one or more words are associated with technical features. In a development, one or more combinations of technical features are associated with technical effects or advantages. In a development, one or more combinations of technical features are associated with patent classification information. Out of the words following the triggering tokens, technical features are thus defined. A wide range of further actions are then enabled. For example, particular—“local”—collocations computations can be performed. Technical features (e.g. “virtual machine”), and combinations of technical features, for example contextualized with a particular IPC class granularity level, can be associated with specific technical effects (in European documents) or with advantages A (in US documents). A significant fraction of these inventive step statements can be overstated, some may be unverified, or not workable, or not enabled, etc. By combination with other techniques (counter-verification, cross-analysis with other documents, etc), the “pollution” can be reduced. The number of technical effects or advantages mentioned in patent documents is relatively low, therefore this source of technical information is to be considered, in a systematic way. In a development, the method further comprises the step of detecting possible and/or existing and/or impossible and/or non-existing association or combination of technical features, i.e. filtered out from words. The extracted information is technical per se. It can inform about a possible and/or existing and/or impossible and/or non-existing association or combination of technical features, i.e. filtered out from words. In a development, the method further comprises the steps of creating associations of technical features having being detected to be non-existing in the corpus and providing accessibility to the public to said associations. In one embodiment, the method allows in particular a systematic (or more systematic) exploration—or disclosure—of novel and inventive combinations of features. In one development, one or more steps of the method are used to automate inventive step objections or attacks. The extracted information is also a remarkable source of information to build inventive steps objections (during examination) or attacks (during oppositions or litigation). Under European practice, the mention of a technical effect can be a sufficient incentive to consult and combine a document for alleging a lack of inventive step. In one particular embodiment, there is disclosed a method to automate the response to a completely artificial qualification examination.

In a development, there is disclosed a method of (semi-)automated patent drafting, comprising one or more of the steps of: receiving a claim tree or one or more patent claims, creating configurable variants of said received claims, and/or configurably paraphrasing said claims (e.g. receiving a desired number of pages in output or an expansion parameter) or a selection thereof (by graphical selection, or dropping text in a “variation box”), inserting said paraphrases or variants (or a selection thereof) in between one or more template sentences (e.g. invariant titles or sections or paragraphs, including personalized buffers or models), said insertion occurring at predefined places (or being calculated in real time), providing one or more controls (e.g. a control panel comprising buttons displayed in a word processing software environment) for example to “freeze” one or more portions of the text (e.g. selection and button “freeze”), to select one or more other parts and/or to (continuously e.g. “start/stop” or on-demand e.g. “next”) reiterate or create new variations of the selected portions, displaying the variants and/or paraphrases and/or one more selections thereof in context (rendering the final document). Optionally, export or rendering options are proposed. Optional verifications (e.g. support, antecedence and the like) can be proposed, as well as appropriate corrections (for example a change in the claims can be automatically reflected in the specification). For example a modification of “screen” into “releasable screen” in the claims can lead to corresponding modifications in the specification. Diverse options can be provided, for example a contextual access to one or more lists of words associated with comparable patent classification entries, a display of definitions extracted from the corpus, etc.

There is disclosed a computer-aided method of drafting patent claims (e.g. an interactive wizard for drafting patent claims). In an embodiment, interactive questionnaires can be leveraged to generate candidate patent claims (e.g. combining invention disclosures static questionnaires, TRIZ methodology and questions and others questions inspired by linguistics considerations). In an exemplary embodiment, a method of patent claim drafting can comprise receiving user answers to predefined questions prompted to said user, the answers comprising one or more words entered by the user (e.g. keywords or expressions, as responses to questions such as “a system or a method?”, “type the advantage associated with the solution you envision”; “mention the technical problem to be solved”, “type the technical solution”; another routine can lead to identify TRIZ contradictions, etc); and/or one or more text selections among displayed predefined lists of words (e.g. list of predefined technical patterns for example advantages or schemes, for example “feed-forward”) or among dynamically retrieved and displayed lists of words based on the one or more words entered by the user (for example, real time exploration of corresponding IPC classes can provide a list of candidate words or expressions; the indication of the closest prior art document can lead to compute similarities and to collect information increasing the gap with said closest document, etc); and/or one or more indications of relationships between the one or more words (for example by providing the ability to modify the graph and/or to graphically draw or add links between words or nodes on a touch screen); and/or one or more received patent classification indications (for example “A61M”). In one embodiment, the patent claim being drafted is continuously and/or interactively displayed, for example along the interactive questionnaire. The method can further comprise a step of interactively receiving one or more indications of the desired modification levels associated to one or more parts of the draft patent claim (i.e. a feedback on the current sentence being drafted). For example, an indication can be the selection of a part of the text with the instruction “to be kept unchanged”, or a contrario “to be changed”. In more details, intermediate changes can be implemented (e.g. quantification/scoring levels indicating modifications to be brought, in terms of grammar and/or lexical changes; a synthetic criterion can be used for example “39” on a scale [0,100] or multiple criteria can be used, for example along multi-dimensional oriented axis grammar/lexicon e.g. [70,20])

In one embodiment, a text is created by expansion. Said expansion can be obtained by insertion of configurable repetition of modified phrases. In one embodiment, received patent claims are paraphrased a configurable number of times, each paraphrases being different. A paraphrase can be a variation of the initial phrase, wherein one or more words or phrases are replaced or changed or inserted by one or more of synonyms, hyperonyms, hyponyms or otherwise associated words or syntagms. In one embodiment, a claim tree is received and each independent and dependent claim is doubled or tripled, using paraphrases. In one embodiment, the user can select the number of paraphrases to be inserted (configurable “expansion factor”, in associated to a selected part of a text for example). From a patent claim tree, a patent attorney can get a twenty-pages document for example, comprising multiple variations around the same theme. In one embodiment, parts of the document can be articulated by optional expressions like<<in other words,>>, <<it is observed that>>, <<in a development,>>, <<in an embodiment,>>, etc.

There is disclosed a method for supervised and unsupervised induction of patent text development. In one embodiment, specific for a given technical domain (e.g. covering one or more patent classification classes), there is disclosed a (semi-) automatic construction of a semantically dense taxonomy of technical expressions. Starting from general purpose term taxonomies and on the basis of techniques of synonym detection (for example from large amounts of textual data), there is disclosed a method of using co-occurrence clustering of terms—in comparable syntactic and semantic contexts—to compute synonyms, quasi-synonyms and, more generally, “meaning similarity measures” between the content words of the given technical domain. In one particular embodiment, the results can be interactively bootstrapped through the intervention of a domain specialist. In some embodiments, the synonym and distance computation can be computed on variable and different levels: for example on the content words, phrases, sentences, paragraphs, and/or the whole texts. The result can be a large network or lattice of interconnected meanings that are used in selectable different versions of the creation process, ranging from the human-based computer-aided text creation process all the way to the completely unsupervised machine-based text creation process, covering all intermediate states of supervised machine learning.

In a development, there is provided a method for automated patent clearance (freedom to operate), comprising receiving one or more patent claims describing a product (or process) to be launched on the market, or an aspect thereof, creating variations of said one or more patent claims and comparing said variations against a patent literature corpus. For example, the corpus can correspond to exclusive rights in force or potentially in force. In one embodiment, the corpus comprises non-expired granted patents and pending patent applications. In one embodiment, the comparisons are performed word-by-word and by exact match. In another embodiment, “fuzzy” comparisons are performed, on the basis of variants of the patent claims (“fuzzy” refers to the comparisons performed in the case of unclaimed matter detection). In a development, results of the application of the method are performed continuously, for example in batch, and relevant results (e.g. patent documents in force) are communicated to a user. For example, if a patent claim is “a watch with a screen”, variants can comprise “a watch with a touch screen”, “a watch with a projector”, “a watch with a 3D screen”, etc. These phrases can checked against the appropriate corpus (claims and/or specifications, for unclaimed matter). Results can be ranked according to different criteria (e.g. in claims, in specification of applications, in unclaimed matter of granted patents, in association with “aggressive assignees”, for such and such patent classification symbols, etc), said criteria reflecting associated risks levels.

Further developments comprise for example the coupling of certain disclosed embodiments with electronic submissions of “third party observations” to patent offices. For example, the pending claims of newly published patent applications can be analyzed, searched and one or more relevant created texts can be communicated (“pushed”) to patent offices (e.g. “third party observations” for patent applications) along with the associated publication dates. Similar operations can be automatically triggered for post-grant proceedings or oppositions for example. Relevant created texts can (also) be communicated to patent applicants as well (“poor man opposition”, along with a friendly reminder of the duty of candor), with patent offices in copy (or not), etc. Other developments comprise analysis (and associated further operational actions) of invention gaps, portfolio management and analysis, trends detection, amplification of weak signals, market scoring, etc. In a particular development, there is provided a method of monitoring the publication of a patent application (or in a variant, monitoring the notice of allowance of a patent application); upon publication (or notice of allowance), searching the claims of said patent in the database of created texts associated with a prior date of publication; communicating one or more relevant created texts to the one or more attorneys representing the applicant with a reminder of the duty of candor and retaining evidence of the associated submission; monitoring PAIR to ensure that the examiner has received the indication of the one or more created texts; if necessary, providing follow-up and reports. In a variant, there is monitored a notice of allowance of a patent, and, upon detection, database is searched immediately send any relevant results to the patent applicant and perform the preceding steps. In a variant, anonymous (e)mail can be used.

In a development, there is provided a monitoring system, comprising receiving one or more patent claims, receiving indication of a list of websites or patent classification entries, creating variants of said one or more patent claims according to the presently disclosed embodiments, and comparing one or more said variants with the published contents of said websites or newly/recently published patent applications in said patent classification entries. In a development, the monitoring is continuously performed and alarms can be triggered if relevant matches are detected (e.g. product descriptions on websites matching patent claims, or emergence of related exclusive rights).

In a development, there is provided a method for automated patent opposition of a patent i. The method comprises receiving a list of n documents, creating m variants of said n documents—according to the presently disclosed embodiments of creations of sentences—, and iteratively reassembling parts of said m variants to reconstitute the claims of patent i. In particular Claim 1 thereof. The method for example comprises a step of minimizing the number of documents selected from the n documents to recreate the patent i. The method can include the step of combining a first document k1 with a second document k2, measure a first difference with Claim 1, iterate with all possible pairs in the n documents; repeat the preceding with one or more variations of a document k′1 combined with an unmodified document k2, for all possible pairs and measure the second difference with Claim 1; if the second difference is inferior to the first difference, repeat the preceding with combinations three by three; display “best” combinations (those minimizing the differences with claim 1)

In a development, one or more variants (created according to the present technical teachings for the creation of sentences) are printed on paper in very small characters, yet readable by the average man in the street, and placed in a public space, offered to anyone for review. In a development, a selection of variants is printed out. For example, representative samples can be selected. Criteria used to assess representation can include quantitative parameters or indicators such as diversity of words, lengths of variants, simultaneous presence of two given words and other analytics.

In a development, publication can be defined as the operation of making something available to the public. In fact many subtleties can be associated with this concept of publication (hidden publication, ephemeral publication, persistent publication, publication with steganographic data, publication with embedded watermarking, etc). Patent laws require a certain type of publication, but details can vary depending on jurisdiction. A possible definition for patent laws could be that the published content shall be accessible to the public in an immediately understandable form. For example, a text presented as a puzzle in no order may not be considered published. A reader cognitive access should be straightforward. In the very details, a claim tree is considered as a disclosure even if the combination of claim 21 with claim 4 and claim 1 is not exactly immediate. The disclosed methods and associated systems can use a diversity of publication modes. In one embodiment, one or more created texts are optionally published. In another embodiment, the publication is not optional. In another embodiment, the publication is mandatory. For example, as soon as a given text is created, it is published online (for example according to the present disclosed embodiments, with a unique URL). In another embodiment, the publication cannot be avoided (the creation and publication for example can be intermingled). For example a piece of evidence of the publication of a first part of a created text can be required to pursue the creation of a second part or of the rest of the text under modification (many parts, even not a very high number of parts can be involved, for example at the granularity of a word). A piece of evidence can comprise, on the publication server, generating a rendering or display of the first part of text, capturing an image of said rendering, computing a hash value of said image and comparing with equivalent steps performed independently on a verifying entity server. In one other embodiment, the publication can be ephemeral. Ephemeral publishing prevents the access to “expired” content. Such ephemeral publishing can be implemented thanks to cryptographic mechanisms using Domain Name System (DNS) and its native limitation over time. In another embodiment, the publication can the opposite of an ephemeral publication, i.e. it can be a persistent publication. For example, one or more caching mechanism can be used. A created text can be copied and distributed across different channels (broadcast, SMS, email, print, etc), for example to randomly selected and also optionally to independent entities. In such a development, numerous copies tend to be created. The publication also can comprise steganographic data and/or mechanisms to hide data (for example to enable further tracking, of either origin and/or circulation of the created text). Steganography mechanisms (compromises between perceptual transparency, capacity, and robustness for example by copy and paste operayions) can use ASCII or markup or Unicode data. The order or word for plain text also can be used (in such a case, the creation step and the steganography can be intermingled or linked). A watermark (visible or as pixel bug) can be implemented in search results.

There is disclosed a high-frequency publication embodiment. In a development, there is provided a content generation platform. Inputs are received from humans (with collaborative and/or crowdsourcing embodiments) and machines (for example by way of sensors which signals can trigger specific content generation actions). The web (including real-time web, machine-to-machine exchanges, deep web, etc) is permanently crawled and analyzed, possibly in real-time or near real-time, and weak signals are amplified by way of corresponding textual transformations. New technical patterns, upon detection and formalization, when expressible by natural language means, are “propagated” in corpus at earliest date after first disclosure. Contents are cross-translated, as soon as possible, leading to numerous other variants of the initial texts. Bots and other processing methods intensively and constantly analyze corpus and human production, identify gaps and fill-in said identified gaps. The number of contents thereby explodes. In some embodiments, novelty can become a race wherein opportunities remain just a couple of seconds, by analogy with high-frequency trading. New players emerge, like “public domain operators” (for example endorsed or supported by public authorities) or content creation providers for niche and specialized markets, new players equivalents to market operators or hedge-funds identify, package, quantify and price the contents (derivative markets are built on top of the legal rights associated with the contents), new regulators emerge (edition of normative rules for creation, storage, retrieval, etc). Patent jobs are entirely redefined, the comparison of texts being automatized to a maximal extent and the residual part remaining devoted to human judgment. Human crowds focus on dreaming and on the formalization of their intuitions, while the latter are leveraged, amplified, verified, cross-checked and embodied by machines. On the legal side, the densification of patent claims (number of patent claims by classification category) leads to so numerous inventive step attacks that this legal provision is abandoned (as well as oppositions, nullity proceedings, etc). Only remains the legal requirement of novelty, and its corollary of literal meaning (i.e. a strict interpretation of the meaning of the words). Infringement detection is thereby simplified. Imperfect, costly and in fine arbitrary, litigation systems are replaced by quantitative scoring systems, i.e. markets.

In a development, search queries can be used to create texts. Search queries can be associated with a patent document (i) or not (ii). Regarding (i), the search queries formulated or provided by patent examiners can be leveraged to create further variations. Search queries are generally (semantic or conceptual) “interpretations” of a claimed subject matter, in view of the considered patent claims and of the associated description. For example, synonyms or hyponyms/hyperonyms are often provided, as well as a human selection of the most important words of the sentence. The provision of boolean operators also are of value, since those indicate alternatives or particular combinations of features. These valuable inputs may advantageously be part of further creation or extension processes. For example, a search query (a sequence of words with or without boolean operators) can be used to enrich the vocabulary repositories to be injected for the creation of variants of the considered patent claims. In one particular embodiment, search queries of patent examiners can be rendered public by Patent Offices and said search queries can be further used to create variations. The search queries of the patent examiners may be published along the publication of the application at 18 months: further extensions of the patent claims may result not only from the claim but also from the quasi-public work performed by patent examiners. There are no real valid reasons to censor (i.e. not to write down and publish) these interpretations which exist, at least during one moment in the mind of the patent examiner. If the intellectual productions of patent examiners are not automatically used for extensions or creation activities, it is at least conceivable to require that search queries are at least systematically published (i.e. rendered accessible to the public), as such. Regarding (ii), in the absence of an associated patent document, for example for exploration or inventing purposes, a search query can also constitute the very “skeleton” of an idea, e.g. an act providing the very basis of human creativity or intuition. With the agreement of the user formulating said search queries, such data can be further leveraged. The search results (e.g. patent claims) associated with the search queries can serve as a basis for further recombinations. In such a case, a plurality of patent claims can serve as the “base” claims to create variants (according to the disclosed techniques).

During the patent drafting process, patent professionals generally use a word processing software and the numerous drafts or versions of the patent claims are lost or forgotten, intentionally or not. Some other versions are saved but not published. There can be quite a lot of such different versions and those can comprise valuable but ephemeral materials. Because patent attorneys and agents delete words, add some other ones, reorder words and the like, it sometimes happens that meaningful creations do exist during a brief moment and then disappear, generally leaving no traces. In a development, there are made “snapshots” of the versions of the text being written, for example patent claims being drafted in a word processing software. These “snapshots” can be made at regular (configurable) time intervals (for example every minute), or by typing thresholds (for example every 20 characters) and/or when grammaticality is obtained (in one embodiment, the text can be continuously analysed and when the text is detected as being grammatical, e.g. comprising no missing verb or incomplete word, a snapshot can be stored) and/or triggered manually by the human operator drafting the text (or a combination thereof). The collection of texts thus gathered then serves for one or more of the disclosed techniques of text creation (for example trusted timestamping, optional indexation and publication, optional crowdsourcing, etc) and variants are created on the basis of one or more of these primary draft versions. In some embodiments, the disclosed methods can thus be implemented as a word processing software plug-in (or the like), which captures some of the different pre-versions of the “final” patent claims and creates texts or variants thereof, along the disclosed embodiments (e.g. with the indication of lexical directions, patent classification classes, etc). Generally speaking, any human interpretation of a text may be reused for further creation purposes. Some “reading analytics”, be they obtained by active user selections or by passive eye-tracking techniques for example may lead to an “occupation” or “reservation” in the “space of ideas”.

In one embodiment, multiple “intermediate generalisations” are created from one given first text. Such intermediate generalizations can be obtained for example by extracting a specific feature in isolation from an originally disclosed combination of features. Another way to obtain such intermediate generalisations from a given text is to delete, replace, permute, or otherwise change one or more words (or phrases) of the given text in some other words (or phrases), and in particular to use hyperonyms (H, more generic) and/or hyponyms (h, more specific). In particular, moving up some words while some other are moved down can lead to interesting results. For example, “an input device (H) with a screen (h)” can lead to “a mouse (h) with a display (H)”. A feature (a word or phrase) disclosed in combination can be deleted. For example “A computer mouse with a haptic sensor which also serves as a screen” can lead to “a mouse with a haptic screen”. Such intermediate generalisations are often of value for patent matters.

In a development, there is provided a method of hybridizing or mixing to patent claims sets. The ability to combine two claims lead to the possibility of combining virtually an unlimited number of claims. The ability to reduce a claim tree to a series of unique sentences or claims leads to the possibility of mixing, or combining or hybridizing a claim tree with an individual patent claim.

In a development, there is provided a method of trans-coding categories of patent claim. A method claim can be transformed into a product claim and vice-versa. Sub-categories like product-by-process also can be transcoded. Trans-coding steps (from method claims to system claims or vice-versa) can comprise the use of expressions like “means for”, the substantivation of verbs, the elusion or deletion of words belonging to the category of systems (e.g. “server” or “device”) to get “pure” method claims, or the introduction or insertion of such words to trancode a method claim into a system claim (for example, the association with system elements can be decided statistically, or from elements analyzed in the description), the insertion of “off-the-shelf” expressions (like “computer instructions which when executed on a processor cause said processor to . . . ”), said expressions being statistically extracted from available corpus, etc.

There is disclosed a method for lexical domain transfer. In some embodiments, for a given set of domain texts (e.g. one or more IPC or a technical field recognized by a scientific community), there can be recognized one or more domain specific roles of single- and multi-word terms and different domains and thus proposed one or more expressions and/or one or more sentences that can transfer the inventive step of a given invention to a new domain, thus realizing a computer-aided computation (cross-domain creativity). In one embodiment, the one or more texts representing the various technical domains can be provided by the user. In another embodiment, said texts can be spidered automatically from the Web using a list of provided key-words, and/or, possibly, some human guidance in the Web-crawling process.

There is disclosed a computer-implemented method of establishing analogies between a source and a target domain. In an embodiment, the method can transform or modify or change or adapt a text from a domain A (for example hydraulics) into a text in a (or of) a domain B (for example electricity). Textual transformations can correspond to problems like (abc→abd; iijjkk→?, wherein a letter can a word or an expression or a representation of an object or a rule or a program). In an embodiment, the method comprises handling or receiving lists of corresponding words and/or expressions between domains (e.g. patent classification classes). For example, a list can comprise two columns (domains) and rows can comprise the correspondences. The lists can be provided by users and/or can be computed or extracted from text corpora. In an embodiment, these lists are computed by statistical co-occurrence measures on aligned text corpora. Lexical correspondences but also syntax rules can be handled (e.g. a specific structure of a sentence, like a feed-forward scheme or pattern in electricity can be transposed in hydraulics). Analogies can be represented by graphs, e.g. can be expressed by corresponding texts. The method thus can comprise handling associated graphs, identifying a missing sub-graph (either in the source or target graph, i.e. directional or bidirectional analysis), performing completion of said missing sub-graph (adding a clause of a sentence or a word or an expression in the appropriate graph). The missing sub-graph and/or the destination graph can be further adapted. In particular, optimization and/or adaptation techniques can be implemented, for example by similarity measures. The similarity measure in particular can comprise one or more algorithmic complexity measurements (“algorithmic complexity” of Kolmogorov, Chaitin and Solomonoff or the “logical depth” of Bennett), in particular using M.D.L. techniques (Minimum description length, e.g. shortest codelength). Optimizations of the establishment of analogies (“quality of analogies”, e.g. iijjkk→iijjkl or iijjll, the former illustrating an “economy principle”) can comprise the minimization of information to derive the target from the source (object or graph), for example by associating a prime of representations (e.g. a text transformation rule) with a length of description (in bits). Said length of description L in particular can correspond to −log 2(P), where P is the probability a priori of the said length. Optimizations for establishing correspondences between graphs can be performed.

In a development, there is provided a method of providing the date of first occurrence of a given word in a patent classification entry, the method comprising detecting the first occurrence of said word or phrase in a corpus corresponding to one or more patent classification entries, storing associated dates (e.g. priority date, publication date), receiving one or more queries for a given word and one or more patent classification entries, displaying matching results. For example the word “3D” in IPC classes related to a television apparatus dates back to 1999. In a development, lists of words and their associated dates are used to create variants of texts. In a development, the weigh for creation purposes is different whether the word was detected in claims or in specification. In a development, the “earliest dates” associated with words or phrases can used for automated opposition proceedings (with optional presentation of context like sentence excerpts reproduction, indication of IPC classes involved, mention of priority and publication dates, etc).

In a development, there is provided a method of propagation or amplification of scientific or technical weak signals, said weak signals for example comprising emerging combinations of words (e.g. “3D printing”, “holographic display”, etc). The method for example can comprise the step of detecting one or more weak signals, selecting one or more patent claims (if not all existing patent claims available in patent offices databases) and creating variants with said patent claims and weak signals, according to the different methods presently described. Optionally, variants are published (made available to the public). In one embodiment, a selected list of websites is under particular scrutiny (crawled and indexed or a daily basis).

There is disclosed a method of trend detection, for example in technical or scientific documents (articles, patent documents, books, etc). In one embodiment, in sufficiently large amount of domain specific texts, the method comprises a step of detecting one or more “rising” stars in the terminology, which words (or expressions) can be particularly prone to play an important role in (near-) future inventions, based on the generalization of specific techniques or materials and/or via domain transfer. Such “rising” stars can be words or sentences or expressions, but also technical patterns i.e. a collection of phrases or textual structures (for example including a “feed-forward scheme” or any other cybernetic-like pattern). In one embodiment, these terms and collocations can be given an “emergence” value that can allow or lead to their prominent usage in the described computer-aided (just as in the unsupervised text creation) systems. The “amplification”, e.g. the use of such “rising” stars in the creation of texts, can be automatic (based on thresholds) and/or triggered by a human operator. The detection step can comprise one or more of the steps comprising monitoring, analyzing the introduction of new words and/or the frequency of new uses of known words or expressions, weighing and/or ranking (automatically by graph analysis and/or by manual selection or confirmation), etc. Experiments indicate that a reduced number of carefully chosen websites can provide a majority of such rising stars.

Language emerges from human minds interacting with one another. There are visible (and unstoppable) changes, as indicated by jargon, slang, dialect divergence, historical change of word meaning, formation of new languages, appearance of new words, increased uses of some new or existing words, etc. The disclosed methods can be used to leverage and/or amplify weak signals in inventions' disclosures, in the patent or scientific literature. Terminology in patents is more stable than every day English, a fortiori in claims for which a word is generally required to be “clear” and/or to be of “technical character”. In practice, the distribution of words in claims is rather specific (limited list of frequent words and very long tail). Yet technical words do evolve and new words appear (rather) “slowly” in patent descriptions claims, even more slowly in patent claims. Emerging trends or weak signals can correspond to the appearance of new words (e.g. “touch screen”) or to renewed uses of words (e.g. “holographic”, “high definition”, “touch”, “immersive”, “head-mounted display”). New words can encompass new technical realities, be they accepted in patent claims e.g. “tablet” or be they quite unclear “cloud computing” without an associated definition. Trends also can have grammatical correspondences, in terms of new schemes or patterns (e.g. feed-forward interface, use of captchas, use of independent communication channels to harden computer security, scraping techniques, augmented reality patterns, all have textual equivalents). The detection of trends (e.g. new words, new schemes or patterns) among other factors, can be based on the analysis of the frequency of words (or schemes) in specific sources, said specific and preferred sources being carefully chosen (some technology websites provide essential and early insights, which “memes” e.g. in particular new words are quickly captured, mimicked and propagated). The graph of citations also can be leveraged. The detection of weak signals advantageously is enlighten by the analysis of the growth rate of filings per IPC class (which to some extent constitute an indicator of increasing competition among firms and are likely to correspond to emerging or expanding markets). For example, G06K or H04L have had higher growth rates than other classes over the last past years (and more refined analysis can be performed). Once a new word is tentatively submitted in a patent claim and/or accepted during examination before patent offices, said new word can be leveraged (its use can be amplified in further patent claims for example, e.g. in lists of replacement words). With some more risks, new words and/or technical patterns can be injected in patent claims even before some players try to use these words in patent claims.

In a development, there is provided a method of varying the length of a text comprising the steps of receiving a text, creating variants of said text according to one or more of the presently disclosed embodiments, sorting out said variants by length, receiving one or more user input indicative of a desired text length, generating display of a variant associated with a corresponding text length. In a development, the method further comprises a threshold or length tolerance (for example plus or minus 10 words). In a development, the user input is provided via a movable cursor or by voice command or by touch command or by gesture indication (e.g. motion or position sensor analyzing the space between the hands of a user, including triggering incremental increases or decreases). In a development, the text is graphically stretched by the user on a touch screen, e.g. paraphrases or developments or details or new content is added upon stretching the text or paragraph). In a development, the variation of length is obtained by the provision of an expansion figure or number. In a development, the length is determined by the level of attention of the user, for example a duration defined by said user or derived from sensors (location, cognitive situation, etc). In a development, there are defined pivotal points (breaks in a given text) and/or portions of text which can be frozen (i.e. which will remain unmodified or invariant).

In a development, a text signature is associated with a modified text (a second text). A text signature acts to the opposite of a hash function, to simplify. In particular, a given signature can correspond to several different texts, it is thus feasible to modify a message without changing the signature, it is feasible to find two different messages with the same signature. The configuration of the different parameters used to generated a signature allows to assimilate different texts into one. For example, four texts can be considered as semantically equivalent. One or more thresholds can be defined (for example a “semantic threshold” can be defined; for example the replacement of “device” by “system” even with reordering of other words in some other parts of modified texts may not be sufficient to change the global meaning). Paraphrasing may thus be discretized. The ranking of results can leverage such signatures.

In a development, there is provided a method of defensive publishing comprising using machine translation in a combinatorial way. Meaning creation also inherently comes from the diversity of langagues. In one embodiment, text variations (or texts created according to one or more steps of the methods presently disclosed) are translated into one or more other languages (and optionally published). Such machine translations can be indeed performed on a massive scale. A translation of a text per se can be assessed as creating meaning, producing prior art documents (if rendered accessible to the public, such translated documents can be novelty destroying or serve as basis for inventive objections or attacks). Machine translation does create meaning too, at least locally if some parts are not correctly otherwise translated (meaningless, difficult to read, etc). For now, machine translation available on the European Patent Office website is only triggered on demand (translations are not pre-processed, published and associated with a reliable date of accessibility). Automatic translations can not always be distinguished from human translations and search engines re-indexing automatically translated contents can “pollute” themselves (circularity). In one embodiment, machine translation is triggered for all texts into all languages, and obtained translations are timestamped and published online, each with one permanent or reasonably persistent URL (or according to some other embodiments of the present disclosure). For example if a given original text is in French, the French text is automatically translated into English and the French text is also translated into Chinese. In addition, recursivity or iteration or circularity is introduced. With the preceding example, the translated English text is also used as a basis to get a translation in Chinese (i.e. not only the original text). By exhausting the combinatorics between language pairs, a maximum of (semantically “focused”) meaning creation is obtained.

There is disclosed a method of multilingual patent analysis and creation. The prevalence of parallel bilingual general texts, and in particular of aligned parallel bilingual patent texts, makes it possible to extend the abovementioned techniques to multilingual applications. In one embodiment, the computation of the lattices of word meanings can include links to terms and expressions in a second language. The system can then propose computer-aided creation of texts in the second language, even if it is not the mother tongue of the user. Equally the system can evaluate the novelty/inventiveness of a patent claim not only in relation to texts of the same language but also to texts in another language. In other words, the disclosed techniques can be applied simultaneously or successively or in parallel in one or more languages. Said application of techniques for example comprises the handling of comparisons (search of words and expressions, collocation computations, etc) as well as the handling of text creation processes (different gaps in different languages can trigger certain selections, etc)

In combination with some of the disclosed embodiments, there is disclosed a further step of translating a created text (or generally a patent claim) in a predefined language. A translation can be a manual translation and/or a machine translation. For example, “a method of baking a cake” can be translated into “un procédépour cuisiner un gateau” or “ein Verfahren zum Backen eines Kuchens” (human or machine translation) or “ein Verfahren von Kochen einen Kuchen” (machine translation, word by word). In one embodiment, the predefined language can be one of the PCT publication language: Arabic, Chinese, English, French, German, Japanese, Korean, Portuguese, Russian, and Spanish. Different standards exist for the qualification of “prior art” in the different jurisdictions in the world: a translated patent claim results in increased visibility (e.g. higher probability of being taken into account for example). In a specific embodiment, the patent claim or created text can be “multi-lingual”, i.e. be composed of words taken from any language. For example, the English text, “a method of baking a cake” can be translated into multi-lingual texts such as “A method zu Backen a gateau” or “eine Methode zu cuisiner ein gateau”.

The resulting translated text can be a combination of languages, containing only translations from the source language only if exact word-by-word translations are available. The skilled person or the man in the street can possibly read such <<multi-language>> texts or word-by-word translated phrases and the technical teaching can possibly be left unaffected (as well as a qualification as “prior art” if applicable). In particular, the translation can advantageously be performed on a word-by-word basis. The underlying grammar can be the one of English or of any other language (impact on the order of words). The grammar can even be the one of a “pivotal” language, i.e. a grammar presenting a compromise between a list of distinct languages (optimizing comprehension, for example assessed by statistical means). Grammar and vocabulary are intermingled but for novelty and inventive step patentability assessments, it may well be argued that vocabulary may matter more than grammar. For example “A because B with C without D while E” may be decreasingly (or at least differently, on a case by case basis) threatened by the earlier publications of (A, B, C, D, E) [full list of “ingredients”], then (A, E, C, D, B) [order may have an effect], then (A, while E with C without D) [missing feature B, lexicon and grammar somehow corresponding], then (A, E, C, D) [missing feature but no grammar], then (A, while E without C with D) [contradiction], etc. Word-by-word machine multi-lingual translation advantageously multiply words' meaning ambiguities and indefiniteness of respective languages (de-multiplying the creation of meaning). Vagueness of language is also advantageous for social interactions around patents. Current machine translation challenges like word order, ambiguities, segmentation and flexion can be circumvented to a certain extent. Availability of translated vocabularies also can be managed or optimized. Vocabularies of different languages can be mixed up. In other developments, “standard” machine translation can be applied or performed (e.g. by using beam search).

In a development, the creation of variants is interactive. For example, associated with a first displayed variant, a first button or icon is displayed (e.g. “next”), which upon triggering generates display of a 25 second variant. The entire text can changed or just a sub-part of it (in this case the “next” button affects the selected sub-part). A second button or icon (e.g. a positive feedback “like” and/or a negative feedback “dislike”) enables relevance feedback. In other words, the characteristics of the “liked” (or “disliked”) variant are taken into account to create the next variation to be displayed. Information optionally can be cumulatively leveraged (long term memory). The mode of creation(s) can be “interactive and automatic”, for example with machines continuously intervening in the background to present candidate words or phrases or patterns and timestamping contents continuously. It can be “interactive and not automatic”, for example with machines not continuously intervening or timestamping, for example in a “ping pong” mode.

In a development, there is provided a method of interactively creating a text, the method comprising: receiving a first text (e.g. a patent claim, a definition, etc), receiving a second text (one or more words or phrases or expressions, for example received by keyboard typing, by copy and paste operations, by automatic retrieval and listing of words candidates, etc), receiving indication to insert or modify the first text according to one or more parts of said second text (e.g. one or more words or phrases), (optionally) displaying one or more possible emplacements for insertion of said parts of said second text (e.g. words or phrases; the first text can be parsed and the structure of the phrase can indicate such possible destination locations), receiving user selection of one or more emplacements to insert said parts (e.g. words or phrases), rendering the modified first text (e.g. with appropriate declinations, substantivization, etc). In one embodiment, a user can drag and drop one word (e.g. “releasable”) on/into a text (e.g. a patent claim). Upon draging, different possible slots are indicated (for example with the word being inserted and greyed in the destination text and appropriately declined), and when the user drops the word, the final text is rendered (and an incremental version can be saved). A mouse pointer or gestures using a touchscreen can be used for user input (for example). The method allows and facilitates to quickly and interactively mix up one or more keywords or expression with a given text. In one embodiment, the one or more words or phrases are proposed as candidates by the system to the user (without intervention), for example in view of the content of the first text, and for example based on novelty or inventive step computations with reference to a patent literature corpus. The method is not limited to words insertion, but comprises modifying the first text: an expression (e.g. sequence of words, phrase) can modify one or more sentences structures of the first text (for example by a plurality of syntactic and grammar changes). For example, drag-and-drop of the expression “a watch with a screen” on a patent claim reciting “a display which is haptic” will lead to “a watch with a haptic display”. In this case, the method for example comprises the step of creating a first series of variants of the first text (for example according to the present disclosure), creating a second series of variants of the second text (words nouns/verbs, phrase, expression, etc), identifying correspondences between the two variants, selecting one or more correspondences (according to predefined criteria like collocations, grammar score, or randomly after predefined time limit, etc) and accordingly optionally displaying choices for insertion or modification (the display is optional because a series of variants of the combinations of the first and second text can be performed, possibly timestamped, without user prompt).

There is disclosed a method of taxonomy crowdsourcing and/or of text creation. Some of the abovementioned techniques can be crowdsourced on/at different levels ranging from small-scale crowdsourcing (for example on the intranet of a laboratory or of a corporation) to large-scale crowdsourcing (for example crowds of volunteers and/or paid workers, specialized technical user groups, technical mailing lists and communities, etc). In one embodiment, the human/machine created texts can be “crowd-evaluated” regarding their inventiveness. The most highly rated texts can then be analyzed, clustered, normalized and/or combined to automatically induce other (possibly inventive) texts that can be again proposed to the crowd (in a bootstrapping process). High quality contents (and some particular convergence properties) can thus be obtained. Similarity measures also can be applied on the different texts (published texts, low-rated texts, highly rated texts, etc). The social graph of reviewers also can be leveraged. For example, the identification of “super-nodes”, i.e. more active users, possibly by technical topic, can further allow a better percolation/diffusion of texts across some technical communities (human creativity exchanges). The detection of trends can also be facilitated by the appropriate analysis of the technical social graph, and the further “amplification” (massive reuse of rising stars in the creation of texts) can be facilitated, etc. Combined with the abovementioned trend detection technique, the legal criteria of novelty and inventive step in particular may be revisited (predictability, surprising effect, networking relationships, mimetic behaviors, etc).

In a development, new texts are continuously created according to one or more disclosed embodiments. Dictionaries, ontologies, vocabulary repositories associated with patent classification entries, and other words sources continuously evolve (terminology is not stable over time, new words appear and encompass new technical realities, like <<cloud computing>>) and such new words or phrases or definitions can be creation ingredients.

There is disclosed a method of normalization (and/or aggregation) of a technical text. In one embodiment, given a list of synonymous or near-synonymous texts or sentences, there is computed the shortest and the most common “normal” terminology in use in a given technical domain. For this, steps of the method can comprise computing the referring expressions occurring in the texts and regenerating the referring expressions (preferably consistently). From this analysis of the synonymous texts, in one embodiment, there is normalized (and/or) aggregated a new text (“representative” of the domain), stemming from a text database or being machine-created, in order to create an “optimal paraphrasing” of the meaning of the text. An optimally paraphrased text can be more easily readable and comparable to other similar texts (for example). In one embodiment of the invention, logical inference computations can be used to compute simpler (i.e. more simple) versions of some given texts holding (associated with) the same meaning.

There is disclosed a method of computer-aided (or guided) of text creation (or rewriting). In some embodiments, the text can be associated with the text of one or more patent documents. In one embodiment, the method is interactive. In some embodiments, one or more human interventions guide the invention process. For example, starting from a list of texts, keywords and/or expressions, the method can be realized through a, possibly Web-based, interactive agent which allows the human operator, for example a specialist of a precise technical domain, to select and rank the best candidate texts among a list of adaptively reranked texts. Said texts for example can be a combination of extracted texts from a database comprising pre-existing human-created texts (for example patent claims) and on-the-fly machine-created texts (which for example can be combinations based on previous choices of the user). At each step, the bootstrapping system can propose an improved list of texts based on an adaptive reranking of the possible output. The user can choose to rank simply on frequency of the terms and expressions or on the prevalence of “rising” terms of the given technical domain. The said pre-existing human-created texts can also comprise machine-aggregated versions of paraphrases of the original text using the abovementioned normalization/aggregation techniques, in order to make the texts more easily comparable. The user can choose different text styles (telegraphic style or full text) and aggregation levels (normalized or original texts). Equally, visual hints (for instance color coding of sentences and of text background) can allow for a faster comparison of the proposed list of texts.

There are disclosed various methods of simplifying patent claim sentences and/or paraphrasing patent claims sentences (comprising for multilingual paraphrasing). In an embodiment, there is disclosed a method of simplifying a patent claim sentence which can comprise the steps of part-of-speech (POS) tagging, chunking, and/or phrase structure or dependency parsing using appropriate taggers, chunkers, or parsers; segmenting of the claim sentence into clausal discourse units; establishing co-reference links between nominal phrases and pronouns denoting the same object; building a clause-discourse tree drawing upon co-reference links and other information such as tree configuration, discourse markers, and syntactic structure; reconstructing individual segments in order to obtain grammatically correct independent sentences. In combination or independently, the method advantageously can comprise using statistical data, in particular collocational information gathered on large domain or off-domain corpora such as lexical usage schemes and syntactic government patterns. In an embodiment, a patent claim simplification step can comprise a step of clause structure analysis (determining a tree with clauses as nodes, and specifications of subordination, coordination or juxtaposition), a step of clause tree flattening (handling of n-ary relations), and a step of projecting the clause structure onto a discourse structure (for example enriching nodes, labelling spans, determining relations according to rules using constructions and lexical information).

In a patent claim sentence, some specific parts can advantageously deserve specific treatments. In particular, some governed prepositions or clauses or phrasal verbs or expressions can be considerably simplified (advantageously before parsing). For example, the expression “a computer-implemented method performed by a computerized device comprising a processor, the processor being adapted to perform the steps comprising” can be reduced to “a method comprising”. System claims are often “mirrored” into method claims and vice versa (“ . . . a memory device storing instructions, which, when executed by a processor, cause said processor to . . . ” generally introduces method steps). Many other variants of such expressions exist (“a” is replaced by “at least one”, “instructions” is replaced by “program code configured to be executed by a processor”, etc). Such expressions are justified or legitimated by patent laws and case law (but in fine are at least detrimental to the readability of the claims). Similar considerations can be made for the handling of plurals (use of “a”, “one or more”, “a plurality of”, “several”, etc.) A whole class of such straightforward textual variations are required through explicit mentions by patent applicants, to the detriment of simplicity and/or readability and/or understandability of the claims. The application of the disclosed methods can help to some extent to mitigate the (probably excessive) rigor of patent offices and/or strict application of patent laws and/or case laws with respect to such aspects (support, antecedences etc.) For example (this also generally applicable to many embodiments of the present disclosure), the method of modifying a patent claim (optionally) can comprise a step of normalizing and/or simplifying a patent claim. Groups of predefined expressions can have respective “canonical” representatives (e.g. minimizing case law negative impact if any, possibly with associated quantified meta data). A received patent claim can be filtered out of such expressions, said expressions being replaced by their respective representatives. Some variations performed on said expressions themselves can help to enhance filters or corpus extraction.

In a development, the present methods can be implemented on a tablet (computing device with a touchscreen). In a particular embodiment, the user can input a base claim and is presented several choices or actions. Such choices comprise grammar and vocabulary options like “same length”, “synonyms”, “hyperonyms”, “hyponyms”, “antonyms”, “definitions”, “wordnet” “wikipedia” or free terms input, and each option can be activated or deactivated (for example “on/off”). For example, the user can select to enable (or allow or activate) “synonyms” and “same length” and to disable (or forbid or deactivate) and/or accept (or tolerate) other options. The user will get second or created texts presenting about the same text size and variations built from the first text with synonyms. The flat and simultaneous access to all options in search a control panel enables a flexible and user-friendly creation system. In a development, search results are displayed one by one and a button “next” allows to trigger the retrieval of another search result. Optionally the user is presented a counter (e.g. “198 paid results left”) and “save” or “immediate publication” options.

There is disclosed an API for modifying a text. In one embodiment, the initial text is uploaded with a set of optional parameters. The (optional) parameters for example comprise: one or more indications (or selections) of one or more parts to be varied (or to be preferably varied, for example according to an optional hierarchy or priority associated with each respective indicated part); one or more global indications of meaning creation (e.g. “focused”, “balanced” or “wide”, or “paraphrase it”, or a figure or a scoring between 1 and 10 for example; globally for the entire initial text and/or locally considering changes associated with the selected parts; a number of desired created texts or variants, for example 1 up to 100); one or more keywords (e.g. noun, verb, adjective e.g. “releasable”, an expression composed of a group of words e.g. “releasably connected to”, etc.); one or more indications of patent classification classes (e.g. A61M); one or more URLs e.g. comprising noticeable keywords; one or more indications about structure and/or vocabulary changes (desired or targeted intensity level for variations or accepted minimal and/or maximal modification levels, etc.); a request for time-stamping (e.g. yes or no; trusted mode or not, etc.); other parameters (identification numbers, date, time, author, tokens, security certificates, etc). As a response to said query is returned the corresponding created texts according to the parameters and selected options (e.g. full texts with appropriate number of sentences, with the corresponding choices of vocabulary and corresponding structures, time-stamping tokens if selected, etc.) Such parameters are entirely optional. The initial text can be as short as one single word. The initial text can be an independent patent claim or a claim tree (i.e. a full set of patent claims). The initial text can be an abstract, or any other kind of text or object comprising text.

There is disclosed an advanced method of content spinning. Existing content spinning methods heavily rely on prefabricated sentences and/or do present simple choices between words. They generally do not affect the structure of sentences. According to some embodiments, both the structure of phrases and the vocabulary being used can be impacted. The method comprises steps of twisting content, at different granularity levels (modifying an entire text, paragraph, phrase, portion of phrase, word). In some embodiments, the similarity measures can be used to circumvent duplicate-content filters. The method can include steps such as reordering of words, permutations, paraphrasing, measuring and adjusting similarity, etc. The method optionally can use trusted timestamping tokens. Optional publication methods include video publishing (e.g. on large video uploading and sharing platforms), for example by/with scrolling texts and/or slide-shows comprising the display of texts. Such publication methods can offer further dissemination of the contents among independent entities, reinforce redundancy. The methods optionally can receive and handle user interventions and guidance. Modifying operations (generally) can comprise editing or modifying or replacing or permuting one or more words, correcting errors, breaking or splitting or dis-joining a phrase or a clause or anaphora (“ . . . wherein said screen is . . . ” can become “ . . . wherein the mouse is . . . ”), merging or joining words or clauses or anaphora (“ . . . wherein said screen is . . . ” can become “ . . . wherein said screen and mouse are . . . ”), shortening or stretching a portion of text, indicating certain parts for further modifications, providing lexical directions, providing program scripts for further modifications, inputting creation or modification parameters or scores or similarity thresholds, etc. In a development, vocabulary sources are provided by RSS/Atom sources (or other web sources of any kind, like news or technology websites, blogs or forums).

There is disclosed a method of optimizing an advertisement, the advertisement comprising text. The text is varied according to one or more embodiments of the present disclosure. Resulting advertisements are distributed e.g. displayed to Internet users and click rates are measured. The distribution can be random or be sophisticated by profiling for example. Applications of one or more thresholds and/or criteria can determine better advertisements. The method can be advantageously applied to viral ad campaigns (some variations of the text can find amplifying echoes and be further amplified). Knowledge about the social graph can determine super-nodes, i.e. nodes associated with superior connectivity and/or activity than the average of other nodes or presenting specific characteristics in the topology of the social graph. A “biological”-like evolution of ads can be enabled. In an embodiment, texts are varied to circumvent adblockers (for example advertisement texts are varied up to the point where text-based adblockers do no longer block the content). Optionally, similarity measures and thresholds allow to perform compromises between the text of the initial advertisement and the one or more texts circumventing adblockers (the ad has to remain readable. Psychological and emotions measurements also can guide the creation or modifications of ads.

Knowing what users read can be of importance. Tracking the user reading of created texts can be coupled to the creation method itself. There is disclosed a computer implemented method of relevance feedback, according to which selected search results cumulatively change one or more steps of the creation method of texts. For example, list of vocabulary can be changed in view of specific user reactions (master nodes in the social graph) or general audiences (statistical perspective). The selection can be active (icon or button “I like”) or passive (for example by eye-tracking). In a development, there is disclosed an attention management system comprising eye tracking means coupled with machine content generation content means or according to the disclosed methods of text or patent claim creation. Some replacement words may then be restrictively varied, some rarely, some never, some with a limited couple of variants, some others may be enormously varied. The model of collocations of words can be modified by cumulative (and e.g. verified) user feedbacks.

In a development, a “text DNA” or signature of a text is defined and can be associated with a given initial text. Such a text DNA can encode “essential features” of the initial text. In particular, the signature can be associated with the “conceptual” representation corresponding to the initial text. In one embodiment, two initial texts having globally the same meaning or semantic will present the same text signature or at least similar ones. By design, such a text DNA can be well suited for fast comparisons of texts in large databases of texts (a text DNA can weigh a few kilobytes, or at most a fraction of the initial text). In one embodiment, a text DNA can be interpreted as the smallest common denominator for a “class” of texts. In a development, the text DNA is associated with a normalized version of the given standard text. Such developments allow a plurality of applications and use cases, for example and not limited to: corpus reduction, detection of reuse and modifications, optimized diffusion, counterfeiting-like operations, fusion/merge of contents, summarization of texts, filtering of texts, modulo one or more thesaurus transformations, text or news rewriting, paraphrasing detection, etc. In one particular embodiment, the text DNA can enable a robust detection of paraphrasing (same semantic structure, but different lexicalisation, different information structures or communicative structures, different order of words, etc) and/or of copy-and-paste operations. In some embodiments, the text DNA can be interpreted as, or associated with, a natural semantic/conceptual meta-language. There is concretely disclosed that, in a development, the signature can be a characteristic intervallic pattern that recurs throughout a text. In a development, the signature can comprise one or more “motifs”. In some developments, the signature can comprise a semantic or conceptual directional graph (with semantemes as nodes and semantic or discourse roles as edges). In some developments, a text DNA comprises one or more descriptors of the underlying sentence structures and phrases. In some other developments, a text DNA encodes structure, vocabulary, hierarchical rules and other parameters (cognitive primitives, closure, similarity, division, spatial distribution e.g. of characterizing part for a patent claim). The steps performed to get such a signature for a given text can also comprise one or more of: a) graph analysis techniques (isolation of the core sub-graph), b) filtering by specific words (for example removal of semantically “empty” words or function words or non-distinguishing words according to dynamically defined thresholds), c) removal of non-essential parts of the phrases, d) predictability analysis of lexical variations (according to the associated model), e) use of “semantic primes” or “semantic primitives” or “semantic concepts” or “semantic universals”, i.e. the use of techniques directed towards a “universal syntax of meaning”.

In some developments or aspects or embodiments, there are introduced thresholds. One or a plurality of thresholds can serve to control or to guide the creation of contents and/or to discriminate or to compare among or between created contents. Such a technical threshold can be numbers or a function of a plurality of parameters. Thresholds can correspond to parameters (and combinations thereof) such as durations, color zones or surfaces, spatial arrangements of image colors, shapes and textures, image similarity score, audio similarity score, underlying raw data correlations, quantitative and/or qualitative indicia of risks of confusion measured in user or consumer test groups. A threshold (or an associated parameter) can be influenced or partly defined by case law (e.g. duration). For example, a “psycho-visual threshold” can be used for (or be associated with) created visual contents (e.g. paintings, images, videos, 3d content). A “copyright threshold” can be defined. Copyright is a form of intellectual property right applicable to any expressible form of an idea or information that is substantive and discrete. A “copyright threshold” can be associated with copyrightable “works” which for example can comprise poems, theses, plays and other literary works, motion pictures, choreography, musical compositions, sound recordings, paintings, drawings, sculptures, photographs, computer software, radio and television broadcasts, as well as designs. For example, in the case of music or multimedia content, the threshold can be defined to a duration in time. For example, the duration can be of about seven seconds, in view the current case law for copyright infringement matters. Shorter than 7 seconds, associated risks may be lowered. A music or song can be further composed by assembly of melodies, each melody being under this 7 seconds threshold. Likewise, a threshold can be introduced (in terms of duration for music or in terms of visual resemblance for still images or videos), said copyright threshold being partly defined or influenced by copyright infringement case law and/or by psycho-auditive and/or psycho-visual (generally psycho-cognitive parameters). An initial movie can be modified into a modified movie, wherein each modified frame of the modified movie is “sufficiently” different from the corresponding initial frame of the initial movie (first class of parameters) and/or the movie architecture (scenario, sequences, order of sequences, etc) are “sufficiently” different between the modified and the initial movie (second class of parameters). For example, a re-encoded movie (mp4 to xvid) may not pass the test. A “remake” may not either (same or too similar scenario). But there may exist a computer generated movie created from an initial one which would pass the test, i.e. by respecting the plurality of copyright thresholds. Likewise, a modified song can be created or generated from an initial one, to the point where it can be considered as being a different work of authorship. One aspect of the invention is to associate an existing work of authorship with a plurality of copyright or infringement parameters and to create one or more original works therefrom (i.e. not under the “derivatives” condition, the association with the initial work being at least questionable). One application is for example to create patent claims which are sufficiently (versus thresholds, e.g. semantic, morpho-syntactic and the like) distinct from existing or given patent claims.

In one embodiment, some of the described methods and systems can be rendered widely available and distributed on the planet. A given individual can, to some extent, create as many variations of a first text as desired (limited by time and storage). In this case, distributed hash comparisons can be handled, so as to create and record one variation only once. To defeat a crypto-attack on these multiple exchanges on cryptographic data (discovery of keys, time to attack, etc), a method to propagate and replace keys is disclosed. There is disclosed a method of communicating securely with a network node creating or modifying one or more texts according to embodiments of the present invention, the method comprising: (a) generating a shared secret; (b) generating a first key and a second key, the first key and the second key being based at least in part on the shared secret; (c) encrypting one or more created texts using at least the first key; (d) replacing the shared secret, the step of replacing the shared secret including the step of encrypting one or more created texts using at least the second key; and (e) re-generating the first key and the second key based at least in part on the replaced shared secret. Such steps (c)-(e) are repeated a plurality of times. Step (a) can be performed at least in part using a password authenticated key exchange protocol. Step (d) can be performed at least in part using a Diffident-Hellman exchange protocol. The method can further comprises the step of sending the shared secret to another node after the step of the replacing the shared secret. The step of sending can include encrypting the shared secret with the second key. Step (b) can be performed at least in part by using one or more key-exchange protocols. One or more created texts sent during the one or more key-exchange protocols can be encrypted using the shared secret. In one embodiment, the method includes generating a shared secret known to a first node and a second node. The shared secret is used to generate a utilized key and a stored key. The utilized key is used to encrypt created texts between the first node and the second node. At some point, a new shared secret is generated and a new utilized key and a new stored key is derived from the new shared secret. The new utilized key is then used to encrypt further created texts.

There is disclosed a method of proving the existence of created texts. Virtual currency systems have disclosed systems using distributed hashing mechanisms (for example a network can timestamp transactions by including them in blocks that form an ongoing chain called the blockchain. Such blocks cannot be changed without redoing the work that was required to create each block since the modified block. The longest blockchain serves not only as proof of the sequence of events but also records that this sequence of events was verified by a majority of the network). Multiple copies of hashes of created texts, circulating around the planet, stored in independent places or nodes, and associated verification steps, can improve the robustness of the system. In one embodiment, volunteers can cache the collection of hash values (or parts thereof), and/or trusted timestamping tokens associated with the created texts, in order to help maintaining a “public domain” or established prior-art databases. Corresponding searches may be guided to the appropriate nodes storing the hash values proving the existence of the created texts.

There is disclosed a special-purpose hash function for large numbers of similar texts. In order to quickly compare a very large number of texts of a given technical domain that only vary at few positions, one embodiment of the system uses a function that computes a double-valued hash function that proposes a minimal uniqueness hash value with a second value that allows for a simple uni-dimensional proximity estimation of any group of texts. This second value is a numerical representation of the combination of words of the given text that can be computed for each text because the whole domain vocabulary is supposed to be enumerable, and even finite, extracted from the technical domain corpus. This hash-functions limits the search space and significantly reduces the number of full texts that actually have to be compared to one another.

In a development, there is provided a fractal compression method of texts. As some given textual transformations can be applied to a whole sentence or to sub-parts thereof, the recordings of the transformations applied in circular or recursive embodiments is optimized. Along with such optimal compression method, the different paths leading from one first given text to a second given text are determined, using known unitary transformation rules and stabilized. The shortest path is then determined in view of one or more multi-dimensional referentials which are predefined, each referential for example consisting of selected words and nouns, chunks of sentences and selected texts. A newly created text is positioned against these referentials and the shortest topological distance is defined.

As a horizon, the collocation of any pair of randomly chosen words shall converge to a stable value. Gaps in IP are filled-in given such horizon. There is kept traces of contributions be they of human origin or of machine origin; for example if the first text has been written by a human being, there is increased confidence in the semantic validity or significance of said text; following derived contents thereof benefit a higher degree of trust than contents derived initially from machine. “Shit in shit out”. In other words, first generations of a human text are associated with a first level of confidence. Contents of generation two, based on the contents of generation one are associated with a second level of confidence, which may be immediately inferior to the first level. The ranking of search results reflect these levels. For example, priority can be given to contents associated with the first level of confidence. In one embodiment, the origin of the first patent claim can be authenticated as human.

The present methods and systems handle programs (sequences of instructions, to implement operations like parsing, text transformations, to handle vocabulary choices for example) and lexical data (e.g. vocabulary repositories, such as verbs, modifiers, etc). Variations of data coupled with stable and defined programs may produce meaningful or meaningless results. But not only can data be varied, also programs can be varied (i.e. the very programs themselves, independently or not from the variations of the data). All finite bit strings are valid programs, but some may never produce any output (at all). A subset of all finite strings will be workable. Points of mutation applying to or affecting or impacting programs, or data, or both programs and data, are now discussed. A point mutation is: change, delete or insert something (a data or an instruction). Interchange can also be a point of mutation. Data can be added to data. Program can be modified into another program. But program instruction can be added to (or modify) data. And data can be added (or modify) a program instruction. Advantages associated to the principle of mutations affecting programs and/or data are those associated with evolving systems and natural evolution, at least in part. Different models of evolution of software and/or data controlling or influencing the creation of patent claims are now discussed. In a first embodiment (“random walk”), a mutation is picked at random. The result or output is eventually checked (meaningful or not and/or grammatical or not and/or assessed as “useful” by a human reviewer etc). Then another mutation is picked at random. To get such a random walk to cover the entire software/program/data space (i.e. be ergodic), it is possible, for example, to introduce for example bias and/or limitations. In one embodiment, a single point mutation is used with probability 1/2, two point mutations are used with probability 1/4, three with probability 1/8, etc. Also, a bias can be introduced to change the beginning of the program or the end of the patent claim (corresponding to the characterizing part). The point mutation for example will delete, flip or insert a bit at the first bit with probability 1/2, change at the second bit with probability 1/4, etc. In one embodiment, the patent claim can be changed preferentially at the end. Or instructions changing the text will be applied in a different order, a subroutine will become the main program governing text transformations or vice-versa. In a second embodiment (“evolution in parallel”), a population of N organisms (including programs/software and/or data, i.e. combinations programs/data, data and programs independent or dependent pairs) is considered. At stage N, the population includes all N(-bit) software organisms (or program/data combinations). A mutation is performed from each organism and new obtained organisms are created and added to the global population. Verified organisms have siblings. In one embodiment, these siblings can be (de)duplicated (for example by comparison of associated hash values), to favor entropy. In another embodiment, for example to mimic evolution, K additional copies of an organism are added to the global population, if associated programs correspond to a predefined criterion (or a plurality of criterion), for example if exactly matching existing patent claims or coming close modulo a predefined threshold. Other criteria can be used and/or thresholds can be used. Under these constraints, programs (re-)producing existing patent claims (for example), will quickly predominate. In fact, at stage N, the organism with the most siblings will be selected as a candidate to be further favoured. One or more candidates can be favoured. Compared to the first embodiment, the second embodiment can evolve faster (parallel evolution) and is still a deterministic model. In a third embodiment, at stage N, the organism producing the more results corresponding to one or more predefined criteria (for example producing the highest number of grammatical results for a set of M first distinct generations) is selected (and further muted). Taking the grammar as a constraint, the most grammatical texts will survive and lead to other texts. In an embodiment, there is disclosed a method of generating texts using a program, the method comprising textual transformation subroutines affecting grammar and/or lexicon of a text and recursively imbricating said subroutines in order to obtain said program.

In a development, there is provided a method to determine an archetype of a patent template depending on patent classification criteria. Different patent classification systems coexist in the world. A widely used system is the International Patent Classification (IPC). The IPC is a hierarchical system, comprising 129 classes, 639 subclasses, 7314 main groups, and 61397 subgroups (8th edition), which correspond to different levels of granularity. In one embodiment, according to a “bottom-up” approach, there is defined an “archetype” patent claim template for each level (a template can be a graph comprising slots for receiving variations of words or phrases and relationships between these slots). For example, 129 different archetype-templates are defined for the level “class”, 639 different archetype-templates are defined for the level “subclasses”. An archetype can be obtained by various ways. It can be manually created by a patent attorney for example. It also can represent the “mean” or “representative” or “average” or “model” patent claim template for the considered level. In one embodiment, all patent claims present at a considered level are taken into account, graphs are added and de-duplicated, optionally simplified and there is deduced such an “archetype”. At the “subgroup”, there are 31397 different templates. These patent claim templates can be used for the creation of texts (along with appropriate selections of lexicons). The templates can be one among many other templates to be used for creations. According to a “top-down” approach (opposite, yet complimentary), archetype templates are defined according to “control theory” (control systems engineering, system of systems), leveraging a cybernetics perspective. Likewise, these top-down defined patent claim templates can be used, among others, for the creation of contents. Different scientific fields have different regulation schemes (biology, gene regulatory networks, mechanics, etc). The corresponding graphs underlying the different templates are thus increasingly complex. For example, simple templates for example can present only one retro-action feedback loop (positive or negative), while more complex templates will present two loops, possibly dependent or interdependent from a third one. Feed-foward loop, positive and negative feedback loops, oscillators, and other regulation mechanisms can be associated with corresponding graphs. For a graph with 3 nodes, 13 motifs can be identified. Motifs comprise feed-foward loop, three chain, uplinked mutual dyad, fully connected triad, three node feedback loop bifans, bi-parallel, etc. For a directed graph with 4 nodes or edges (slots for words or phrases' variations), 16 motifs can be defined. Very complex graphs can be defined, each with particular metadata (scientific field, associated IPC classification, etc). Roughly, the concept of controllability, inherited from control theory, denotes the ability to move a system around in its entire configuration space using only certain admissible manipulations. The controllability concept (state, output, etc) applied to patent claims leads to define “master” nodes (features, if not essential features) which when modified substantially change the global semantic meaning of the considered patent claim. In some embodiments, these master words (or phrases or slots) can be considered as hubs i.e. nodes with much higher connectivity than the rest (the presence of hubs gives a long tail in the associated distribution).

In a development, for each granularity level of a patent classification (for example an IPC subgroup), (at least), one patent archetype template can be defined. Such an archetype is a graph defining semantic and/or functional relationships between nodes (which can be independently varied) including common word order rules. Such a graph can be interpreted as a “mean” or “average” or a “representative” graph of the entire class considered level. For example, there can be one “canonical” patent template (a phrase with slots to vary words) for G06F, another one for G06F17/00, another one for G06F17/11, etc. In more details, a plurality of such archetypes can be defined (each with associated properties, e.g. variance). For example G06F17/00 can correspond to a long tail of archetypes. In one embodiment, archetype templates are used (i.e. a selection of subset of templates are used to create variations). In one other (extreme) embodiment, all templates of all classes are used to create variations for all or any classes level(s). For example, in particular, a template extracted from A61M will be used for creations on G06F17/00. Likewise, vocabulary repositories can be cross-used. In one embodiment, vocabulary of G06F17/00 is used for creations on G06F17/00 and no other words taken from other classes (unless in common) are used. In one other embodiment, vocabulary of “adjacent” classes are used. For example G06F17/11 vocabulary is used for G06F17/12 (and for example vice-versa). A plurality of adjacent can be taken (symmetrically or asymmetrically). “Bridge” indications also can be leveraged. “Bridge” indications correspond to those residing in existing classifications (multiple classifications, in the classification itself) to those as indicated by classification of real existing applications (which can be classified according to 1, 2, 3 or more IPC classes in practice)

Further embodiments related to metrics are now disclosed.

The estimation of the “quality” of a patent claim is an endless—if not vain—debate (the purpose or context can be variable, a long and narrow claim can be as useful as a short and broad claim). Yet relative and absolute measurements of patent claims can be determined and leveraged to enable further services.

Mastering both the grammar (e.g. the structure of sentences) and the vocabulary (e.g. dictionaries of words) enables multiple quantifications or metrics. For example, it enables to setup a reference enabling to quantify similarities between texts, i.e. to define a metrics (relative positions of texts). It also enables to score a patent claim (e.g. with an absolute score, even if parameters are configurable).

In an embodiment, the metric is a mere word count. A word count is a simple—yet powerful—measure of a patent claim. In general, the shorter the claim, the broader. And vice-versa: the longer, the narrower.

The rule is not absolute: elegance and scope are largely independent factors. In truth-conditional semantics, a shorter assertion (e.g. sentence) can correspond to less restrictions and thus can apply to more hypothetical worlds (e.g. meanings). In linguistics, the “scope” of a claim can be envisioned as its generality, i.e. the average height of the used vocabulary in a hyponym tree, and thus as the amount of specialization possibilities.

A simple word count can constitute a metric on a patent claim and thus proposes a transitive distance measure. This metric can be further refined by crossing the word count with the frequency of the encountered words. Frequent words such as function words but also words that are commonly encountered in existing patent claims (possibly restricted by domain or publication date) can count less than rare (or less frequent) words. The use of predefined or configurable thresholds (for example by IPC symbol, i.e. by vocabulary silo) can enable relevant distance measures.

In some embodiments, a patent claim is associated with a score, i.e. an absolute value in view of a referential system. In a particular embodiment, the score is determined from the word count and the frequency of the words composing the patent claim. For example, a long claim with frequent words can get the same score as a short claim with rare words. A very short claim with very general words is likely to be broader in scope than a very long claim with very specific words.

In some other embodiments, a modified patent claim is associated with a “distance” (or a plurality of distances). A “distance” is or can be associated with a “quantification of the similarity between two texts” or a “similarity measure”. Distance can be relative or absolute (with a reference point). Equality—from a semantic standpoint and/or in absolute word forms—corresponds to a zero distance.

In some embodiments, an “editing distance” is used. An “editing distance” or “edit distance” is a (parameterizable) metric calculated with a specific set of allowed edit operations, and each operation being assignable a cost (possibly infinite; limited in practice). It is a way of quantifying how dissimilar two strings (e.g., words) or texts (i.e. sequences of words) are to one another by counting the minimum number of operations (e.g. insertion, deletion, substitution) required to transform one string or text into the other. Each operation can be associated to a cost (or ponderation or weight). The editing distance in some cases can be (or be combined with, or be similar to) a “Bilingual Evaluation Understudy” (B.L.E.U. or “BLEU”) distance. Such algorithms can be used in automatically evaluating machine translation systems (these types of measures corresponding well to human similarity appreciation).

In some embodiments, the cost is configurable per operation (for example, replacement of a given word by synonyms can have the same cost, while the replacement of a given word by an hyperonym can be associated with a different cost). A score per text can cumulate scores associated with each word and/or editing operation. The order or words and its contribution to the final score can be handled independently. Yet in other embodiments, the order of words composing the sentence can be taken into account in the computation of the individual scores (e.g. associated with each word)

In one embodiment, the Levenshtein distance can be used. In some other embodiments, other variants of edit distance are obtained by restricting the set of operations. For example, the “Longest common subsequence” (LCS) distance is an edit distance with insertion and deletion as the only two edit operations, both at unit cost. Similarly, by only allowing substitutions (again at unit cost), a Hamming distance is obtained; this must be restricted to equal-length strings. Jaro→Winkler distance also can be obtained from an edit distance where only transpositions are allowed. Sequence alignment algorithms such as the Smith→Waterman algorithm, which make an operation's cost depend on where it is applied. Proprietary distances also can be used. Distances of different nature can be combined (synthetic or aggregated scores, vector of scores, etc). These metrics can also be obtained by machine learning techniques on manually or otherwise obtained distances between texts.

Quantification steps in some instances can enable a discretization of the semantics. For example, if a plurality of texts are determined to be substantially similar (paraphrases e.g. exceeding—or not exceeding—predefined or configurable thresholds associated with scores and/or edit distances), only one “representant” can be kept in memory (a posteriori to the creation of texts), e.g. published if applicable, or alternatively the creation model can a priori avoid to create such near-duplicates (in such a case, the topology is intertwined with the creation model).

On top of quantification, trading systems can be developed. For example, if and when a patent claim (or more generally a text) is associated with a threshold or a distance, a buyer (or leaser or otherwise contractor) of a particular text can get certain rights on the text itself and some other rights (or the same rights) on the near-duplicate texts. The described methods and systems enable to “pave” the “space of ideas” with various forms and sizes of tiles. Associated “density measures” can enable the identification of “gaps” (density below a threshold).

Various services can be developed. For example, a morphing method between two texts can comprise receiving an initial patent claim and a final patent claim, optionally receiving a target number of intermediate patent claims, modifying the initial patent claim into a plurality of patent claims (e.g. more or less or exactly in the count of the target number), each said modified patent claim being associated with a metrics or a score exceeding a predefined threshold. In an embodiment, the distance between modified patent claims is driven (only) by the desired number of intermediate patent claims. In an embodiment, a predefined distance (e.g. “semantics” or according to a meaning creation intensity or the like) is used to create non “near-duplicates” (and a selection can be further performed to select the desired number of intermediate patent claims). Advantageously, the morphing method can allow to hybridize a patent claim, identify new inventions, find “better” versions of patent claims, etc. In an aspect, the meaning of a sentence can be decomposed (e.g. replacing a word by its definition).

Further embodiments related to search are now disclosed.

There is disclosed methods and systems of searching in a collection of texts, which texts in particular comprise a high number of “near-duplicate” texts (i.e. very close variants). Multiple advanced search options can be used, in combination, among which search options: search by length of text (total number of words or by ranges e.g. between 100 and 150 words), search refinements (“more specific” or “more generic”) on one or more selected words, search in 3D (e.g. with immersive virtual reality head-mounted displays and/or augmented reality glasses), options to force or favor the indicated order of words (e.g. “watch heart rate” to return texts directed to option to devices indicating time), “freeze” one or more options of a sentence while search is operative in non-frozen selected portions, options for “positive” and/or “negative” search. Negative search for example is performed when a word is selected and associated with a constraint (i.e. absence), by contrast to positive search (a term is the search query should be present in the returned search result). Negative search query enable to filter out unwanted results (or portions of phrases). Ultimately, there can be displayed one or more template structures associated with the initial patent claim along with replacement words for each “template slot” (drop down access or wildcard or other graphical display means). Template slots can be embedded into one another (hierarchical dependency or as a graph). Associated possibilities to select the different levels of embeddings can be displayed to the user. Replacement words can be selected by the user. Replacement words can be selected and/or changed one by one. A plurality of replacement words can also be selected and/or changed at a time (changing one word may imply further consequences e.g. better selections or suggestions for other words, for example because of meaning, etc). Co-references (e.g. anaphors, antecedences, etc) can be handled appropriately. Advantageously, such a data representation enables a user to explore efficiently the variations of the sentence (“satisfactory” portions of the sentence can be left unmodified while variations are explored at the regions of interest). In other words, such an embodiment provides a direct access to all parts of the sentence. Predictive suggestions, real-time search and other advanced search techniques can be used in combination to enhance the search experience.

Several different search scenarios in the field of patents can be envisioned (for example regarding novelty and/or inventive step attacks or objections, patent clearances, etc). With a few keywords (e.g. 2 to 4), databases can be explored for amusement or curiosity, but also to check a specific combination of words (e.g. “screen+mouse+holographic”). With more keywords (e.g. indicating the essential features), a patent claim can be tentatively anticipated. A search scenario can be two-steps. In a first step, the initial search query can be used as a first filter to select candidate “series” (collection of texts associated with a given initial patent claim), e.g. search results presenting a suitable sentence structure. In a second step, the closest variants can be searched within said identified suitable series (for example using negative search). An entire patent claim can also be submitted as a search query. For novelty destruction of for inventive step objections, an objective can be to find the “closest” matches in the databases. In such a case, symmetrical operations (as the ones performed to create variations) can be used to search databases (parsing, graph analysis, filters, lemmatization and other techniques to determine essential features—or a hierarchy thereof). In other words, the search query itself is analysed in a similar way than contents have been created. In an embodiment, there is distinguished between a “fast but superficial” search mode and a “deep but slow” search mode (for example an “exhaustive” search mode). For example, best or relevant results can be emailed to a user after a couple of days of batch processing (e.g. adding further conditional tests such as order of words, semantic tests as provided by external modules, etc).

In an embodiment, search in databases can be enhanced by suggestions (i.e. automated invisible queries can lead to suggest one or more keywords to a user who has typed one or more words as queries). Search can be oriented indeed: identify existing contents or—to the opposite—identify “gaps” in the prior art databases. For example, the user can try to identify existing pieces of prior art. In this case, search options can provide suggestion of further keywords which are already populated in databases. Concretely, the user can type a few keywords and it can be displayed (e.g. greyed out or otherwise highlighted) some further keywords as suggested by the system, indicating combinations which have been already explored. This mode is useful to identify prior art, for example to find novelty destroying documents. According to search mode directed to the identification of “gaps”, the suggested greyed words shall not be present in the databases (associated dictionaries can perform required comparisons and subtraction operations). This latter mode is advantageous for users trying to find unexplored prior art spots. According to this mode, there can be anticipated a further word input after some words have been entered by the user (for example at a “depth” of one word, i.e. one word is further suggested; “depth” can be set up to of a plurality of words, for example two or more additional word queries can be suggested), e.g. to take an additional word from a list and to check whether said additional word is already in the database or not, and to retain and suggest only the words which are not present in the databases. Predefined lists can be used, for example associated with a declared IPC class or universal predefined lists can be used (e.g. not knowing the technical field).

The invention can take form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer-readable can be any apparatus that can contain, store, communicate, propagate, or transport the program for use by or in connection with the instruction execution system, apparatus, or device.

1. A computer-implemented method of handling a patent claim comprising:
receiving an initial patent claim;
modifying said initial patent claim into a plurality of modified patent claims;
timestamping said modified patent claims.

2. The computer-implemented method of claim 1, wherein the timestamping step comprises a trusted timestamping step.

3. The computer-implemented method of claim 1 or 2, wherein the timestamping step comprises a decentralized timestamping step.

4. The computer-implemented method of claim 1, wherein one or more modified patent claims are made available to the public.

5. The computer-implemented method of claim 1, wherein a modified patent claim is associated with a unique electronic publication address.

6. The computer-implemented method of claim 1, further comprising receiving one or more words and/or patent classification indications and/or website or webpage addresses and/or a text.

7. The computer-implemented method of claim 1, further comprising receiving selection of a specific portion of the initial patent claim and receiving a parameter value associated with said selected specific portion.

8. The computer-implemented method of claim 1, further comprising parsing the initial patent claim into one or more parse trees, determining one or more template slots from said one or more parse trees, a template slot comprising a word or a group of adjacent words or a group of non-adjacent words.

9. The computer-implemented method of claim 8, further comprising deleting and/or inserting and/or reordering one or more template slots and/or replacing one or more template slots by one or more new words.

10. The computer-implemented method of claim 9, wherein the one or more new words are words of the initial patent claim, and/or synonym, hyponym, hyperonym, holonym, antonym or meronym thereof.

11. The computer-implemented method of claim 9, wherein the one or more new words are words of a patent claim tree associated with the initial patent claim, and/or synonym, hyponym, hyperonym, holonym, antonym or meronym thereof.

12. The computer-implemented method of claim 9, wherein the one or more new words are words of a patent specification or description associated with the initial patent claim.

13. The computer-implemented method of claim 1, further comprising associating a modified patent claim with at least one metric.

14. The computer-implemented method of claim 13, wherein a metric comprises an edit distance between said modified patent claim and the initial patent claim and/or a distance between said modified patent claim and another modified patent claim.

15. The computer-implemented method of claim 14, wherein the edit distance is a Levenshtein distance.

16. The computer-implemented method of claim 1, further comprising receiving indication of a meaning creation intensity.

17. The computer-implemented method of claim 16, wherein a patent claim is modified according to a threshold determined from said meaning creation intensity.

18. The computer-implemented method of claim 1, wherein one or more modified patent claims are grammatical.

19. A system comprising means to perform one or more steps of the method of claims 1 to 18.

20. A computer program comprising instructions for carrying out one or more of the steps of the method according to any one of claims 1 to 18 when said computer program is executed on a suitable computer device.
